(19) United States
(12) Patent Application Publication
(10) Pub. No.: US 2010/0012597 A1
(43) Pub. Date: Jan. 21, 2010

(54) Frigid-reactance grease/oil removal system

(76) Inventors: Magdiel S. David, Paso Robles, CA (US); Sarah H. Enriquez, Paso Robles, CA (US); Elmatanah A. David, Paso Robles, CA (US); Lemuel E. David, Paso Robles, CA (US); Daniel E. David, Paso Robles, CA (US)

Correspondence Address: Magdiel S. David, 15750 Natoma Pass Road, Paso Robles, CA, 93446, US

(21) Appl. No.: 12/455,484

(22) Filed: Jun. 1, 2009

Related U.S. Application Data
(60) Provisional application No. 61/130,603, filed on Jun. 2, 2008.

(51) Int. Cl. B01D 35/18

(52) U.S. Cl. 210/774; 210/177; 210/178

(57) ABSTRACT

In accordance with all embodiments; an organic/inorganic liquid grease and/or oil removal system that, upon contact with greases and/or oils in, on, or about liquid, gaseous, or upon solid media, instantaneously causes them to become more viscous and collected onto itself by the split-second elimination of heat bound within the greases and/or oils, comprising: A reservoir 40 accommodating a cold fluid cryogen 70. Reservoir 40 comprises a bifacial/multi-functioning, interior/exterior element/wall 69 whose interior side—internal cooling surface 32—contacts cryogen 70, thereby receiving cold, conducting it to its back-to-back, external grease/oil-contacting/extricating surface 10 positioned exterior of reservoir 40. Cooling surface 32 bears a greater overall surface area in direct proportional relationship to, and with, extricating surface 10 that contacts greases/oils adhering thereon. The greater-to-lesser surface-area configuration facilitates the frigid reaction of greases/oils in a manner suitable for either continual or continuous grease/oil extrications, commercially or domestically.

### CROSS-REFERENCE TO RELATED APPLICATIONS

This application claims the benefit of Provisional Patent Application Ser. No. 61/130,603, filed Jun. 2, 2008 by the present inventors, which are incorporated by reference.

### FEDERALLY SPONSORED RESEARCH

Not Applicable

### SEQUENCE LISTING OR PROGRAM

Not Applicable

### BACKGROUND

Field

This invention relates to the extrication of greases and/or oils from liquid, gaseous, and from off solid media via changing the viscosities of greases and/or oils by using “heat exchange,” otherwise known as, “the removal of heat,” or colloquially, “cooling,” to remove heat bound within the greases and/or oils, to facilitate immediate and thorough extrications as is necessary in domestic or commercial food-preparation and kitchenware applications, and wherever bulk greases and/or oils would demand removal, as in the petrochemical industry, and environmental and “hazardous materials clean-up.”

2. Prior Art

### Grease/Oil-Removal and Health

Consensuses of scientific and medical experts, to date, overtly dictate the deleteriousness or harmful practice of over-consuming certain ‘fats,’ hereinafter referred to as ‘grease’ and ‘oil.’ Related ‘Heart disease’ is currently, “the number one killer,” in the U.S. [U.S. Center for Disease Control], demanding America's consumption-cut-back. Hence, the extrication of grease from foods in school and military cafeterias, in industry, and domestically is immensely beneficial. Health-wise and economically, grease and oil extrication is oftentimes absolutely necessary. The fact is that, easy, quick, thorough, and efficient grease removal as a preventive-care necessity applied to America's diet would bountifully yield in helping to drive down the cost of healthcare.

A current problem, however, is that the market has not offered a quick and thorough removal device.

### Crude Oil Spills and Our Environment

Crude oil has been good to man, but has also marred planet earth while its threats yet loom. Oil tankers can still collide or otherwise leak oil by the millions of liters at a time. The reason oil spills are so loathed and feared is because ‘clean-up’ has always been unsatisfactory by using the available methods. Often chemicals are dumped in seas, bays, and oceans, dispersing the oil, making the spill less recognizable and an ugly blotch.

A device offering efficiency and thoroughness to remove ‘crude’ from life-teeming waters has been a dream. Interestingly, the very same concepts and principles that apply to extricating grease and oil from a domestic kitchen's saucepan containing a liter of beef broth, also apply to extricating oil from enormous oceans spanning continents. Therefore, applicants commence in the kitchen.

### History

### a.) Cold Soda Cans

Grease hardening on the surface of water is presumed to predate the invention of the wheel when colder climates caused earthen-potted, floating grease/oil in food stocks to solidify. In a day when soda and beer cans were iron-based, heavy, and tin-coated, cooks would semi-freeze them. When the cans' contents would turn to slush, their convex bottoms, tops, or cylindrical sides were skimmed over the tops of cooking stock. This action would very limitedly, solidify cooking grease, causing it to attach to the soda cans, making grease removal easier than liquid-liquid extraction, and more thorough. One of the applicant's witnessed this phenomenon is several settings.

Both the cold and grease were ‘reactants,’ and, for ease of explanation, this above grease-extrication method is named (by applicants), and hereinafter referred to as the “Slushy Soda Method.” Critically, for some then-unapparent, bizarre reason, these ‘slushy’ cans functioned far better than frozen-solid beer or soda. The reason was not understood, but was a wonder for decades. That reason is hereinafter detailed, and is a critical operational factor relating to embodiments herein and prior art (U.S. Pat. No. 4,024,057).

### b.) Cold Spoons

For smaller grease-removal operations, such as in the case of a bowl of soup, ice-cold spoons or ladles were used in a manner somewhat like slushy soda cans. Water-bearing spoons were frozen. The bottoms of the spoons would then be skimmed over bowls of soup, for example. With practice, the grease would harden onto the spoon, and then scraped. The trick, however, was performing the grease-extrication process fast enough so as not to allow the grease to re-melt back into the hot liquid. This method is still in use today for small amounts of grease; Applicants use the term, “the Greasy-Spoon Method.”

### c.) The Cold Towel Method: for Larger Jobs

Another grease/oil removal method, applicants refer to as, “the Cold Towel Method” is performed as follows: Wetted, common kitchen towels are formed into sack-like shapes. Ice cubes are placed in them, and the sacks are placed in a conventional freezer. For use, the bottom of the frozen, icy sack is skimmed over hot, floating grease/oil, as in the Slushy Soda Method; The cold-towels indeed accumulate significant hardened grease and, unlike the cold spoons, can be used for larger jobs such as removing grease and oil from restaurant pots. However, the towels used have to be laundered separately lest the grease destroy other fabrics.

### Hidden Phenomena

The applied sciences involved in these above three grease/oil-removal methods bear ultra-hidden attributes. Although the scientific principles at play may be somewhat rudimentary in general, what meets the eye offers hidden phenomena hereinafter described. Meanwhile, these above, and other domestic and restaurant modes yet function today to limitedly remove grease via cold/frigid qualities/agencies, despite various drawbacks discussed in further detail for reason of direct applicability.

### Solids-from-Liquids and Preferred Old Method

Removing grease via cold is preferred when thoroughness is in demand, because, removing solids from liquids is indeed easier and more thorough than removing liquids from liquids. This is a fundamental practice commonly employed in chemistry. Hence, some olde-school cooks prefer a frigid extrication over a liquid-liquid removal. The Cold Towel Method is preferred, because, cold spoons may function for a bowl of warm soup, and slushy cans for a small sauce pan bearing a small amount of grease, for example. But the cold towel that some refer to as a “cold mop,” is more effective for hotter, larger applications. It is quick, and efficient, but if every family were to employ this method, there is a price to pay in laundering, destroyed fabrics, and energy. Unfortunately, several cold towels may be demanded to remove grease from a single 3.76-liter (four-quart) pot. Likewise, several slushy soda cans or a dozen or so large cooking spoons, or ladles are needed to remove grease from a single one-to-two liter (one to two-quart) saucepan, usually. A significant amount of work is involved.

Grease Removers Via Cold; Not readily Available

There is not a readily-available device on the market that employs ‘cold,’ and that can outperform ye-olde Cold-Towel or Slushy Soda methods, applicants believe. No devices for grease/oil removal the applicants discovered employed ‘cold’ in the sense that the slushy cans and cold towel employ ‘cold.’

### Most Common and Energy-Consuming Method in use Today

Another common method employed is what applicant refer to as, “The Freezer Method,” whereby entire hot cooking vessels containing near-boiling cooking stock are placed in a freezer until grease hardens. This method is timely and inefficient because the liquid stock commences freezing when a solid must then be extricated from a solid, while some of the grease is bound together with the solid cooking stock. Much grease/oil is, therefore not extricated. Above all, this method is immensely energy-consumptive, though it is in most common use (for cold grease extrications).

### Prior Art: Portable Cold Grease Remover

Hereinafter, while applicants make specific reference to ‘prior art,’ they are referring to a 1977 U.S. Pat. No. 4,024,057 being called a, “Portable cold grease remover.” In design and function, the ‘Portable Cold Grease Remover’ is an antithesis to the principles and concepts embodied in, for example, the cold towels and slushy soda cans for reasons made known hereinafter. In short and generally, the specification of prior art (U.S. Pat. No. 4,024,057) calls for a ‘grease remover’ that employs cold, and may well be likened more to the ‘greasy spoons,’ albeit, not like the mentioned slushy cans or cold towels.

### Hidden Factors

With great respects to the inventor of prior art's Portable Cold Grease Remover (U.S. Pat. No. 4,024,057), and to the U.S. Patent Office, applicants here must express in a forthwith manner, and unreservedly, a few hard facts. Applicants find that the principles and concepts employed in the Portable Cold Grease Remover are somewhat puzzling, ‘peculiar,’ and even contradictory to scientific rule. This find is significant and applicable for several reasons. Applicants conclude that initially, several unseen critical factors were inadvertently and unintentionally overlooked as regards U.S. Pat. No. 402,407.

These factors are not readily distinguished except by testing and analyses, and pertain to grease/oil removal via cold qualities and metals, and related phenomena. Applicants, therefore, are predisposed to elucidate their discoveries that, for good reason, elusively evade ready notice, even of professionals.

Unfortunately, when tested, the Portable Cold Grease Remover (U.S. Pat. No. 4,024,057) could not outperform the aforementioned Slushy Soda, Freezer, or Cold Towel methods, but underperformed for reasons clearly detailed hereinafter. The bases of all embodiments were tested.

### Terminology, Sciences, and Industry

The methods of using frozen soda cans, frozen spoons, cold towels, the freezing of cooking stocks, or prior art's ‘Portable Cold Grease Remover’ (U.S. Pat. No. 402,407) all possess considerable drawbacks with regard to optimal grease-removal and science. The applicants' focus here, therefore, is science without whose understanding, those unseen factors in prior art (U.S. Pat. No. 4,024,057) and new concepts shall, no doubt, be misunderstood or overlooked, because, much of the unexpected is hidden and invisible. Therefore, clear, concise explanations of terms must be set forth and made clear. This application also contains a glossary on Page 32.

“Cold” does not Exist: the Term is but a Colloquialism: Controversy

Of extreme criticality, the common understandable terms “hot,” ‘cold,’ ‘frigid,’ and other temperature-related terms are extremely controversial in the scientific realm. Almost every branch of science deals with temperature, ‘cold,’ heat, and related reactions. However, ‘cold’ is an unmentionable term to many professionals dealing with temperature. Such professionals are found within corners of ‘the government’ and without. Yet, those same terms of controversy are commonly acceptable in vernaculars, and employed by many U.S. Governmental scientists, major industry, and the general public. Lest applicants mislead, we elucidate.

Applicants take no stand or sides of this scientific argument, but simply try to make themselves understood. They shall further clarify in some precise way what ‘cold’ means to them in order that this application's data may be clearly conveyed. Controversial terms are critical in this application, as is being understood.

‘Cold,’ ‘frigid,’ and other like terms are taboo to some, but to others, ‘cold’ is, “often thought of as an active force,” as stated in Webster's New World Dictionary (Third College Edition, Copyright 1994 Simon & Schuster, Inc). But, such a ‘thought’ is an inconceivable and detestable notion in the field of thermodynamics.

Moreover, in physics, according to the above-mentioned popular dictionary, ‘force’ is, “the cause or agent that puts an object at rest into motion or alters the motion of a moving object.” Thereby and hence, one may conclude (whether rightly or wrongly) that ‘force’ meets all the qualifications of ‘cold.’ Some physicists, chemists, metallurgists, and environmentalists, insist that cold actually behaves as, and is an energy or force as it purportedly slows molecules to a near grinding halt at ‘absolute zero’ (which is −459.67 degrees Fahrenheit).

We refuse to ignore that chief scientists, such as thermodynamic-related scientists, often cringe at hearing such a theory. To them, ‘cold,’ is no more than a mere ‘colloquialism,’ meaning, “the absence of heat.” The U.S. Department of Energy [2008 quote] insists so, and respect is duly warranted and fitting.

### The ‘Absence of Heat’ and the Average Person

To the average, reasonable person, thermodynamic-type scientists speak in but esoteric and abstruse terms identifying temperatures dropping near ‘absolute zero’ as yet having “extensive heat.” Therefore, to most reasonable people, altogether eliminating the term ‘cold’ from vocabulary is unreasonable, despite scientific correctness. In fact, thermodynamic theories happen to be extremely complex and complicated for the average person to comprehend, or digest, let alone believe.

Most people, applicants presume, can easily digest ‘gelare’ or ‘gelidus,’ the ancient Latin term for cold. And to most people, ‘warmth’ and ‘heat’ are far, far absent from, for example, a shivering 32 degrees Fahrenheit, let alone −460 degrees below zero. Applicants illustrate both sides to finalize a middle-ground definition.

The ancient ‘thermodynamic’ theory, although perhaps correct and viably true, without doubt, seems strange, near incomprehensible, and mysterious, even to some scientists. Applicants imagine a world without the term ‘cold.’ Thermodynamically-leaning scientists insist, in fact, that cold simply “does not exist,” only the ‘absence of heat,’ and it has zero force or energy while the idea is firmly based not only on 1800's ‘theory’ but upon “ancillary assumptions,” according to the renowned Van Nostrand's Scientific Encyclopedia (Copyright 1989 by Van Nostrand Reinhold).

Two opposing schools of thought are prevalent and immensely applicable here where applicants merely want to merely explain embodiments' descriptions, functions, and operations while not taking sides of theoretical polemics. Hence, in order to simply detail a device while not confusing readers with ultra-esoteric thermodynamic jargon, in this application, the applicants attempt to satisfy both schools of thought without being incomprehensible or taking sides of an argument that is not theirs'.

Applicants refuse to employ extreme terms such as ‘cold energy,’ or ‘cold force,’ that to some do not exist. Conversely, neither do applicants employ terms like ‘the Zeroth Law,’ ‘Principle of Caratheodory,’ or the ‘Helmholtz Function,’ that are of ‘thermodynamics’ and are also theoretical. Instead, the applicants explain this application in common terms.

While one may say, “The ice is cold,” the applicants cannot say, “The water has the absence of heat,” because, what on earth, does have, totally, ‘the absence of heat?’ [a rhetorical question] And if cold does not exist, how can it be the absence of heat?

Generally, therefore, instead of using the term, ‘cold’ standing alone, applicants generally try to employ the terms, “rigid qualities,” “cold qualities,” or “rigid agencies,” all meaning (to the average person and many scientists) ‘cold,’ or the absence of some heat in direct relation to a human being's normal temperature. This ‘meaning’ is key here. The human's temperature, therefore, is a basis, because, of the mega-trillions of objects on this planet, not one can be said as not having a total absence of heat. In other words, there is no relative basis.

Applicants, take no sides to theories, but highly respect those of the U.S. Department of Energy who helped formulate the above ‘meaning.’ Also, applicants attempt to rest, though timidly, somewhere between arguing scientists' theories, and semantics. Again, the term ‘cold’ hereinafter has an absolute basis of relativity to a human being's normal temperature.

Finally, the fact remains, despite polemics, that, liquefied grease/oil at approximately 100. Degrees Celsius (or +212. Fahrenheit) absolutely reacts with a temperature, 0. degrees Celsius (or +32. degrees Fahrenheit, or ‘cold,’ ‘frigid agencies,’ or the absence of some heat) to form solidified grease and more viscous oil. Therefore, applicants shall attempt to describe embodiments and variants, and provide scientific finds discovered.

### The Cold-Metal Effect Principle and Deception

The term, ‘deception,’ is not intended to even remotely imply malfeasance on any person's behalf, but to say, first appearances of U.S. Pat. No. 4,024,057 and other aforementioned grease-hardening methods can be misleading.

Originally, and recently, applicants set out to improve upon the cans of slushy soda seen used in the 1960s. Applicants had then not heard of the ‘Portable Cold Grease Remover’ (FIG. 1—Prior Art—U.S. Pat. No. 4,024,057). After significant testing with various metals and cold qualities as regards grease and oil accumulation/extraction, applicants eventually learned of U.S. Pat. No. 4,024,057.

Applicants discovered that the ‘Portable Cold Grease Remover,’ U.S. Pat. No. 4,024,057 specification revealed concepts and principles that, based on testing, were particularly unique on paper. They were immediately deemed by applicants as ‘peculiar.’ Applicants conclusively agreed, only after having performed rigorous qualitative and quantitative testing, that the U.S. Pat. No. 4,024,057 specification contained data that countered current basic scientific principles known and widely accepted: However, this countering was most likely due to what was, at the time of patenting, unseen, and unrecognized. In order to understand how underlying, not-readily discernable, and obscure principles were inadvertently overlooked, an often-deceptive natural law must be elucidated here.

Almost all ice-cold, sub-freezing, solid metal objects, whether brass doorknobs, bicycle sprockets, silver spoons, or skeleton keys can remove grease from cooking stock to some very limited degree. This is due to the latent ‘cold’ or limited absence of heat within them. This critically important phenomenon is hereinafter termed the “Cold-Metal Effect Principle,” named by applicants to detail this application.

The ‘Cold-Metal Effect Principle’ and un-augmented cold qualities latent within metal (imparted by a conventional freezer) is the primary scientific basis upon which the Portable Cold Grease Remover—U.S. Pat. No. 4,024,057 could fleetingly remove grease. It would do so quite similarly to any other ice-cold metal object of its same mass and material. But beyond that limited degree of its possessing latent cold in metal only, the ‘Portable Cold Grease Remover’ actually functioned as a bona fide heater, despite extraneous equipment or features as seen in FIG. 1—Prior Art Figures (FIGS. 2, 3, 4, and 5). It thusly performs to absorb masses of heat by intention, as seen in design and as so clearly stated in the U.S. Pat. No. 4,024,057 specification, which shall become further apparent.

The Portable Cold Grease Remover—U.S. Pat. No. 4,024,057 was used thusly: It would be placed in a conventional freezer or ‘on-ice.’ Frigid qualities would be accumulated (heat evacuated) thereby, to lay latent within its metallic structure and mass. Besides metal, extraneous elements such as ice, or cold water, were supposed to aid as coolants. Those elements' functions were grossly impeded by design apparently for not easily recognizable reasons detailed hereinafter. After coming down in temperature, in use, the ‘Portable Cold Grease Remover’ would be partially submerged into hot cooking stock, then skimmed as the hereinabove mentioned cold spoons. This action, no doubt, like most cold metallic structures, would aid to remove a given amount of grease. However, it would remove grease to a lesser degree than the slushy cans, whereas the ‘extraneous elements’ only limitedly and momentarily aided or augmented the ‘Cold-Metal Effect Principle’ at work.

An extremely important factor that may lead to deception is the presence of ‘extraneous elements.’ These may be seen in FIG. 1—Prior Art (U.S. Pat. No. 4,024,057). What is important in a grease removal process with a given cold metal is the readily-available amount of latent ‘frigid qualities’ (limited absence of heat), besides, above, and beyond that amount imparted to, and latently stored within, a given metal mass by the Cold-Metal Effect Principle. In other words, available ‘frigid qualities’ besides, or extraneous from, latent cold within metal alone are of extreme importance. Ready availability of cold agencies is key. Herein lays the absolute critical essence of grease removal via cold qualities.

Aside from available frigid qualities attributed to the Cold-Metal Effect Principle and latent cold alone, the primary focus here is what any given device, can do besides what its latent cold within metal alone has to offer. The effects of cold metal alone on grease are minimal without truly augmenting factors. A simple law of nature bestows cold metal solids with the ability to remove grease; But what a metallic device can do beyond the Cold-Metal Effect Principle is at issue here. Therefore, this ‘beyond’ factor is a primary focus of this entire application. Prior art (U.S. Pat. No. 4,024,057) primarily employs but, minimally-augmented, stored and latent Cold-Metal Effect Principle agencies, despite appearances and extraneous equipment. Its appearances are deceiving because, it can remove some grease while the Portable Cold Grease Remover-U.S. Pat. No. 4,024,057, despite its attributed ability to posses the Cold-Metal Effect Principle, is actually a heater in disguise, and not a steady cooler of grease/oil. This fact shall become more evident.

### Principles and Concepts Embodied: Underlying Factors

Applicants believe that a few underlying factors were likely and inadvertently overlooked and demand attention as concerns U.S. Pat. No. 4,024,057.

In prior art's Detailed Description of the Invention (U.S. Pat. No. 4,024,057), we analyze how the ‘Portable Cold Grease Remover’ works. The reader may want to recall that the ‘slushy soda cans,’ ‘towels’ bearing ice, or ‘cold spoons,’ all have a bi-face of two opposing surfaces of a, technically-speaking, ‘reactor.’ The applicants view such a bi-facial reactor as the greasy spoons. One surface accumulates cold qualities, and the other contacts hot grease, reacts it, and accumulates it thereon. In essence, we are speaking of one part, two functions. The surfaces combined are dual-acting.

Referring to FIG. 1—Prior Art—U.S. Pat. No. 4,024,057, ‘plate 11,’ despite first appearances, is a chief element that destroys demanded cold qualities, not augments them. It is the paramount part actually causing all embodiments illustrated (FIG. 1—Prior Art) and claimed, to voraciously devour necessary and elemental cold qualities demanded for desired grease reaction. Figuratively, ‘plate 11’ is a culprit of several, as applicants shall elucidate.

Yes, the Cold-Metal Effect Principle and latent cold causes ‘plate 11’ (FIG. 1—Prior Art) in use, to but temporarily act dually, as the abovementioned cold spoons. Albeit, after that fleeting, temporary moment, all embodiments seen in FIG. 1—Prior Art quickly commence absorbing immense and augmented masses of heat. The ‘Portable Cold Grease Remover’ is not based on principles and concepts of the slushy soda can, with the exception of the Cold-Metal Effect Principle combined with exhausting latent cold qualities. Applicants shall elucidate further, explaining detail.

“Maximum Heat” does not cause Grease to Solidify or Adhere: the Configuration that could not become Efficient or useful

The Portable Cold Grease Remover's specification (U.S. Pat. No. 4,024,057) reads: “The heat of the grease is then conducted into Plate 11, causing the grease to solidify and adhere to the undersurface of the plate.”

Scientifically, the conduction of high-temperature heat (the term used in context) does not cause ‘grease to solidify and adhere to the undersurface of the plate.’ Applicants find this concept and others within the specification somewhat bizarre. Applicants repeatedly considered the possibilities of typographical errors or the ‘absence of heat’ theory applicability. The specification repeatedly confirms, absolutely, that maximized heat is to be conducted into Plate 11 (U.S. Pat. No. 4,024,057) FIG. 1—Prior Art. But ‘heat,’ in the sense the term is employed throughout the specification (U.S. Pat. No. 4,024,057), neither causes grease to solidify nor adhere in a hardened state to metal. This idea defies science. Interestingly, the design of U.S. Pat. No. 4,024,057 was based upon this very principle and concept, applicants reveal.

Applicants hold that the limited absence of heat, or ‘cold,’ is what factually causes the phenomenon of grease and/or oil adhering to cold metal, hardening, and/or changing viscosities.

The lower, bottom surface of plate 11 (U.S. Pat. No. 4,024,057—FIG. 1—Prior Art) is augmented in surface area and actually contacts the grease that is scalding hot. Meanwhile, the upper portion of bi-faced plate 11 is of a minimal area (in relation to its lower, grease-contacting area) and contacts but mere cold water or briefly semi-contacts ice (as later explained). Said differently, the absolute critical cold-contacting surface area is significantly minimized in relation to the hot grease-contacting surface area referred to as the ‘bottom’ in the specification. Scientifically, an augmented area contacting augmented heat to increase heat, as specified, combined with a converse bi-face, minimized area that contacts minimal or marginal cold at best is a configuration or recipe automatically slated for malfunction, given the desired reaction is to remove grease/oil. This configuration demands exhaustive elaboration in several contexts. Elaboration may demand some redundancy.

Based on the Portable Cold Grease Remover's specification (U.S. Pat. No. 4,024,057) and design, ‘heat’ coming from a source of hot grease atop, and mingled with, near-boiling water, somehow, was imagined as a principal and key elemental reactant in the grease-removing process. In fact, the ‘Portable Cold Grease Remover’ is factually designed and based upon this somewhat unusual theory, concept, and principle that surrounds the imagined premise of high-temperature heat actually ‘causing’ the extrication and adherence of grease.

Hence, unquestionably and conclusively, according to the Portable Cold Grease Remover's specification (U.S. Pat. No. 4,024,057), ‘conduction’ of high-temperature ‘heat,’ is an intentional, necessary element and factor of employed concepts and principles. This is true, even to the degree that the very surface element, plate 11 (FIG. 1—Prior Art), that contacts hot grease and hot liquids, contains a, “multiplicity of projections,” “the purpose being, to increase the surface area on the underside of Plate 11 for maximum heat conduction.”

Further, throughout the entire ‘Portable Cold Grease Remover’ specification (U.S. Pat. No. 4,024,057) one can clearly see that high-temperature supposedly is to perform as a ‘reactant,’ actually ‘causing the grease to solidify and adhere to the undersurface of the plate.’ The ‘Portable Cold Grease Remover’ specification (U.S. Pat. No. 4,024,057) makes clear distinction between cold and hot, whereby there seems ought no mistaking one for the other.

On the extreme contrary, applicants hold that that high-thermal temperatures react with grease to cause it to be less viscous, to smoke, burn, then vaporize. Moreover, reactant, cold/frigid qualities, or frigid agencies (heat's limited absence), combine with hot liquefied grease, and react to form hardened grease. The Portable Cold Grease Remover's specification (U.S. Pat. No. 4,024,057), its concepts, and principles employed are diametrically opposed to the science with which applicants are familiar, excepting the fact that the Cold-Metal Effect Principle of nature is employed.

### Prior Art's Claims

The Portable Cold Grease Remover's claims (U.S. Pat. No. 4,024,057) were found by applicants here to be slightly misleading. Applicants are convinced that the specification and claims of U.S. Pat. No. 4,024,057 (as illustrated in FIG. 1—Prior Art), conveying the idea that the invention could remove grease, was a gross technical oversight. Importantly, this oversight may have been due to the inventor's and others' likely misunderstanding of the several unnoticeable and unseen factors involved with the applied sciences that can very easily escape notice. These unseen factors, the applicants shall further elucidate.

U.S. Pat. No. 4,024,057 would momentarily collect some grease inherently due to its Cold-Metal Effect qualities (and latent cold in its metal), before commencing to function as a literal heater, due to design. In other words, the claim, based on the entire specification, indicates that extraneous parts, besides pre-cooled metal, would significantly aid in grease removal. These were obviously simple mistakes or oversights, applicants here believe.

Calls in all Embodiments: “Heater Configuration” versus “Cooler Configuration”

By studying other details in the Portable Cold Grease Remover's specification (U.S. Pat. No. 4,024,057), applicants here must concretely hold to statements and drawings within the reference and claims. Applicants here conclude that the specification is claiming that high-temperature heat conduction from hot grease is actually considered a reactant towards ‘causing’ grease to solidify and adhere to metal. Also, repeat calls for ‘maximum’ heat conduction are overtly plain and concise, and thereby concede and conform to the actual design itself by incorporation as illustrated (FIG. 1—Prior Art). Augmented, intense heat is provided special welcome via a specially-designed, always-augmented heat-absorbing surface called for in all embodiments. This augmented area contacts intensely hot food stocks, greases, oils. Meanwhile, cooling is shunned and denied by providing it with but a minimized (always-planar) cooling surface area, and meager cooling sources. Importantly, the above unique configuration, that demands further explanatory elaboration, is herein (throughout this application) referred to by applicants as the ‘Grease/Oil Heater Configuration.’

A diametrically opposed configuration whereby an area contacting grease/oil is minimized and generally smooth and minimized relative to its bi-facial, back-to-back cooling surface that is augmented in surface area is herein (throughout this application) referred to as the “Grease/Oil Cooler Configuration.”

With all respects to those who dealt with U.S. Pat. No. 402,457, applicants hold that the Grease/Oil Heater Configuration employed by U.S. Pat. No. 402,457 could not promote the desired reaction of grease removal beyond what latent cold and the Cold Metal Effect offered. Applicants further elucidate on hidden factors.

In Hot Water—A Configuration always Required

The ‘Portable Cold Grease Remover’ (U.S. Pat. No. 4,024,057) is basically a heater designed to absorb as much heat as it can, because, its specification clearly conveys that high temperature is a key, vital reacting constituent for a desired end result.

FIG. 1—Prior Art illustrates that the ‘Portable Cold Grease Remover’ (U.S. Pat. No. 4,024,057) is, basically, a two-sided metal plate, ‘plate 11.’ The lower, ‘bottom’ side is engineered to absorb as much heat as possible by its area augmentations. Plate 11 has various container-type apparatuses or accessories above it, intended for cooling which seem and appear appropriate. However, the grease-collecting lower or bottom surface that contacts high-heat is “having” a multiplicity of projections. These projections create demanded, increased area, ergo increased high-heat. Said in simplest terms, due to the massive area, the amount of high-heat may be double, triple, quadruple, or more than the amount of cooling area. Hence, it possesses the ‘Grease/Oil Heater Configuration,’ not allowing for a ‘Grease/Oil Cooler Configuration.’ The Portable Cold Grease Remover, therefore, operates (or fails to operate) based on the assumed principle that ‘heat’ causes grease to solidify and adhere to plate 11''s bottom surface.

Moreover, the Portable Cold Grease Remover's (U.S. Pat. No. 4,024,057) plate 11 seen in FIG. 1—Prior Art bearing maximized surface area at its lower, bottom side, is claimed, seen, and called for in all embodiments represented and mentioned. This characteristic exists in order to accept and conduct more high-temperature heat as clearly specified, while absolutely no implicit or explicit suggestion of an otherwise configuration exists throughout the entire specification. To be emphatic, the physical characteristics of a multiplicity of projections, creating maximized surface area (ergo, maximum heat), and contacting high temperatures for maximum conduction of heat, are absolutely inherent in all embodiments of the ‘Portable Cold Grease Remover.’

To compound matters, conversely, an upper, opposing area of plate 11 seen in FIG. 1—Prior Art (U.S. Pat. No. 4,024,057) that is supposed to be cold for some unclear reason, always bears within the Portable Cold Grease Remover's specification but a minimized surface area. It is minimal or lesser than its immense converse bi-facial side to absorb heat. Hence, a planar surface form, while absolutely no implied or explicit suggestion of an otherwise configuration exists within the entire specification, given the Portable Cold Grease Remover's principles and concepts.

Therefore, the idea of having a larger or greater surface area for massive heat conduction that is conversely positioned to a smaller, minimized surface for cooling (the Grease/Oil Heater Configuration), was patented. Further considerations are of note, and discussed herein.

Physically, therefore, this above-described device (U.S. Pat. No. 4,024,057), unquestionably, is enabled, by inherency, to acquire as much heat as its maximized lower surface can possibly or potentially accept. The device demands minimization of cold agencies necessary for a desired reaction, thereby absorbing magnifications of high-temperature heat. The heat is conducted upward, naturally. The grossly-augmented heat is then directed to the marginalized, minimal, planar surface area that is cooler.

Further compounding matters, the specification's called-for cooling facilitation, described later, is absolutely minimal, at best. The demanded heat, therefore, is guided upwards to overwhelm or devour any minimally available cooler qualities, thereby negating, quashing, or neutralizing any necessary potency of reactant frigid agencies truly necessary for intended reaction. Though not a perfect design, in practicality, the above-mentioned slushy soda cans or cold towels do not possess the heating capacity discrepancy seen in Prior Art (U.S. Pat. No. 4,024,057).

### Not As Cold As Ice

Moreover, in consideration of the above-mentioned serious unseen drawbacks, the Portable Cold Grease Remover's specification (U.S. Pat. No. 4,024,057) calls for ‘ice’ and ‘cold water’ as coolants, for the most part. Ice is extremely limited in terms of availing or transferring its frigid qualities as a mass, even if a massive bulk is employed, especially in the case of prior art (U.S. Pat. No. 4,024,057) bearing devastating amounts of heat. Applicants explain.

A given metallic surface area is to be cooled by ice. The ice is directly frozen to that metal, contacting it. This contact is key, scientifically speaking. Ice directly frozen to a given metal surface minus the presence of liquid water on the metal's surface is of importance and significance towards ice imparting or transferring its cold qualities to that metal surface. An ice-to-metal transference of cold qualities is fleeting and momentary: As soon as ice-frozen-to-metal commences melting at its metal-contacting surface, the temperature at the contacting ice/metal surface is elevated. This means that solidified water has heated and liquefied, and may be, at its coldest, approximately less that 0. degrees Celsius (approximately 35. degrees Fahrenheit) at best. Meanwhile, at normal room temperatures, this temperature continues to elevate and warm. The heat in kitchens are usually higher.

In the case of the Portable Cold Grease Remover (U.S. Pat. No. 4,024,057), being configured as a heater, the temperature elevation factor occurs within seconds before water temperature is skyrocketing, the water, acting as an insular buffer, or insulator, and an actual transferor and conductor of unwanted heat.

Therefore, while we normally think of ice as ‘cold’ in relation to human beings' normal body temperatures, as far as grease removal, there must be considerations. Melted ice not only creates a heat buffer and insulator disallowing cold qualities to travel where cold needs to go, but melted ice, even a thin layer, allows for rising heat to be transferred or conducted where it should not be. This is but one aspect as relates to the solid coolant, ice. Ice, in the case of prior art (U.S. Pat. No. 4,024,057) is a significant, unseen drawback. Another drawback follows.

### Igloo Effect: Fighting an Invisible Enemy

Moreover, because ice is typically employed with the ‘Portable Cold Grease Remover’ (U.S. Pat. No. 4,024,057) that is a heater, what is called the “Igloo Effect” commences to function. Meaning: When ice, at its contacting surface with metal, melts, an immediate accumulation of warmer-than-ice water forms, as explained above. This formation creates an cavity or actual igloo whereby warm water and ambient air displacing melted ice volume becomes trapped and sandwiched between a ceiling of ice and a warmer metal surface such as, plate 11 seen in FIG. 1—Prior Art (U.S. Pat. No. 4,024,057). Warmer water temperatures are captured, imprisoned, and increase in temperature, thereby increasing the igloo's temperature. Hence, when ice melts, displacement with ambient, warm kitchen air forms an invisible igloo. This Igloo Effect is but one of several causes of systemic overheating.

The igloo, in other words, continues to warm and elevate in temperature and, despite the amount of ice above, absolutely cannot allow cold qualities to permeate downward through the igloo, through warming water, then, to a rapidly warming metal plate that is the igloo floor. In the case of U.S. Pat. No. 4,024,057, that floor is a near inferno of intentionally augmented heat. The ‘Portable Cold Grease Remover’ (U.S. Pat. No. 4,024,057) characteristically faces consequences of the Igloo Effect compounded with it being a heater.

Therefore, the Portable Cold Grease Remover's (U.S. Pat. No. 4,024,057) primary so-called coolants employed are but mere water and/or ice. What actually happens beneath the minimized area of an igloo floor is quite severe. The igloo floor is an un-augmented surface area contacting but rapidly warming water, at best. The igloo floor's temperature, significantly warmer than ice, is in face-to-face combat. We must conceptualize a cauldron of 100. degrees Celsius (210-degrees Fahrenheit), highly active, fast-moving, kinetic heat energies. These energies are contacting an allied, massive, augmented heat-absorbing element with a ‘multiplicity of projections' (plate 11—FIG. 1—Prior Art) to intensify and aid the enemy, namely, heat (figuratively speaking).

Analogously, we imagine a battle between hot and cold where the ‘Portable Cold Grease Remover’ (U.S. Pat. No. 4,024,057) inherently is a ‘traitor’ to cold (so to speak) abetting the enemy. On a platter, it offers an accommodating and inherently maximized heat-contacting surface configured with its converse-sided, minimized, planar cooler surface: It bears the ‘Grease/Oil Heater Configuration.’ These combine with rapidly warming water under ice and an igloo, only to grossly impede cold, and assist the already-disproportionately larger enemy, high-temperature scalding heat. Together, these combine to destroy possibilities of steadily reacting liquefied grease beyond the Cold-Metal Effect Principle and latent cold agencies initially held within the metal. In other words, this is an immensely disproportionate, proverbial ‘losing battle’ while the multi-compounded problems are unseen, not apparent, and, indeed invisible.

Major Insulating Factor: another Invisible Enemy: Grease-Scraping Prohibited

Hardened grease on metal, being an absolute insulator of cold agencies, grossly impedes or prohibits cold agencies from conducting through it to further react grease. Given the compounded heat-promoting elements battling cold, which are inherent with the Portable Cold Grease Remover (U.S. Pat. No. 4,024,057), yet further various interconnected unseen factors exist.

Applicants impress that U.S. Pat. No. 4,024,057 does indeed accumulate some grease due to the Cold-Metal Effect Principle and latent cold in metal. However, when the ‘Portable Cold Grease Remover’ (U.S. Pat. No. 4,024,057) bears even a thin layer of hardened grease barrier at its bottom, always-augmented surface, there are not sufficient cold qualities or frigid agencies available to penetrate the grease let alone, its plate 11 (FIG. 1—Prior Art), to long sustain adherence of grease. This inability is due to the above and hereinafter specified, unseen, inherent, systemic drawbacks. These include the aforementioned heater configuration, the igloo effect, and others mentioned. In addition is grease being an insulator to cold. A ‘meltdown,’ therefore, occurs, meaning a melting of the grease that is adhered via the Cold-Metal Effect Principle and latent cold.

Moreover, when insular grease is briefly adhered, and the Portable Cold Grease Remover (U.S. Pat. No. 4,024,057) is quickly removed from a hot liquid, the insular hardened grease absolutely cannot be easily scraped. This is due to the, ‘multiplicity of projections’ that ‘may be in the form of serrations, knobs, or otherwise, the purpose being to increase surface area on the underside of Plate 11 for maximum heat conduction.’

Meanwhile, even with the hereinabove slushy soda in a can, a quick and intermittent scrape-off of hardened grease is necessary during the process of grease removal from a single pot, for example, to quickly rid the impeding insular properties of hardened grease. Therefore, a necessary, quick and ready ‘scrape-off’ is not feasible with the ‘Portable Cold Grease Remover’ (U.S. Pat. No. 4,024,057) and near impossible, especially being that the ‘Portable Cold Grease Remover’ cannot be turned upside-down or inverted lest contents are spilled.

The Portable Cold Grease Remover's reference (U.S. Pat. No. 4,024,057) calls for either scraping or “heating” in order to remove hardened grease. But because the grease cannot be readily scraped, or the device inverted, called-for ‘heating’ is the only alternative. Therefore, having to repeat this entire process of re-cooling the ‘Portable Cold Grease Remover’ in a freezer over and over repetitively is neither practicable nor doable in any kitchen. Normally, the amount of insular grease produced during normal cooking is such that several repeat skimmings of grease are necessary. Moreover importantly, critical time spent ridding the Portable Cold Grease Remover's always-augmented surface of grease, is crucial. It is time in which frigid agencies (however minimal) are being rapidly lost, while those agencies are necessary for a second skim of grease.

### A Cryogen or Antifreeze-Disabled: Direct Contact Critical

The ‘Portable Cold Grease Remover’ (U.S. Pat. No. 4,024,057) does not allow for a conventional anti-freeze agent (that may be referred to as a cryogen) to impinge directly onto its plate 11 (FIG. 1—Prior Art), having minimized surface area that is to normally contact ice or cold water. Instead, it calls for a, “means of cooling plate 11.” That ‘means’ is a “container 40” (FIG. 1—Prior Art) which is a sealed, pill-box-shaped capsule that is to hold, “ordinary tap water” or other conventional coolant liquids.

This ‘means’ disallows and prohibits direct contact of coolant with Plate 11. Importantly, container 40 (FIG. 1—Prior Art) is absolutely independent and dissociated from plate 11 and may simply rest, unconstrained, or unrestrained atop plate 11 that is of minimized surface area. Importantly, this configuration forbids direct contact of a conventional coolant with the already-meager-sized, minimized area of the upper surface of plate 11. Direct cooling is disallowed thereby. The criticality of this configuration is detailed hereinafter.

### The Baffle of a Miracle Cold Versus a Docile Heat: A Figurative Analogy

In operation, any available cooling qualities within ‘container 40’ (FIG. 1—Prior Art—U.S. Pat. No. 4,024,057) would first have to 1.), penetrate into its sealed barrier floor to be conducted clean through to proceed out from it into 2.), a gap of heat-insulating atmospheric, ambient conditions of, for example, a kitchen, through which it must traverse. This cold must then 3.), penetrate into the top of rapidly warming plate 11 that is a recipient of ‘maximum heat conduction’ at its immediate converse bi-faced side. Then, 4.), this assumed cold, as a miraculous phantom, must be transmitted clean through Plate 11 while performing the major feat of combating and dodging maximally allowed, high-temperature heat. Then, 5.), this cold is to penetrate out from plate 11's lower/bottom, augmented surface that may be numerous times the area of that area from which the ‘cold’ originated, only to find 6.), an insular barrier of Cold-Metal-Effect-acquired grease through which this cold must penetrate.

Once this cold phenomenally penetrates through the insular grease, then, it must 7.), proceed farther, braving a direct-dive directly into a cauldron of intensely infernal heat, warring and combating an immense army of heat as it swims. It must navigate itself to capture or extricate grease and oil while cooling it off. But its mission is not yet accomplished. It must then, 8.), prove itself by keeping grease adhered to the massive area designed to accumulate masses of heat. The cold cannot allow the grease to be recaptured by enemy heat (its melting back to its former state). This cold must phenomenally juggle, because, it must maintain secured its rescued, extricated grease while yet gathering more.

Therefore, scientifically, we must realize, that this above referenced miracle-type cold has originated from a mini-minimized area that is but marginally cool, only to be dissipated to and through a hugely maximized area several times its size, and extremely hot. We must bear in mind that, according to the specification (U.S. Pat. No. 4,024,057) this cold originated from an area not merely smaller than the hugely maximized area. It originated from a small interior floor of ‘container 40’ that is significantly smaller than plate 11's upper surface (FIG. 1—Prior Art). In fact, the walls of container 50 (FIG. 1—Prior Art) occupy much of the upper space of plate 11, peripherally. Container 40, having its own walls, is placed within the wall of container 50 per specifications (U.S. Pat. No. 4,024,057). Meaning, the area of cold's origin is miniscule in comparison to the converse area that contacts high-heat. Moreover, the potential or probability for the Igloo Effect inside of container 40 is real.

This immediately above-described configuration whereby the coolant in container 40 (FIG. 1—Prior Art) cannot be a ‘means of cooling plate 11,’ as the specification (U.S. Pat. No. 4,024,057) states. This dissociated non-contact of coolant to plate 11 is a supposed “advantage,” “to prevent accidental spills of a coolant into the soup or broth.” Applicants conclude that if ice or water contacting plate 11 is grossly compromising of and by itself (not expounding on the Igloo Effect), then, the concept of a far-distant, dissociated coolant in a capsule not in contact with Plate 11, is reduced to a miscalculation, despite well, respectable, and honorable intentions.

Regarding grease removal via cold metal, there are several invisible actions that take place that most people would easily overlook or not foresee. Nevertheless, the fact stands that cold qualities, while using container 40 ((U.S. Pat. No. 4,024,057—FIG. 1—Prior Art), would have to phenomenally and miraculously defy intense heat, overcoming several immense and formidable barriers in order to actually react grease. This is factually a non-scientific misconception. To conclude this segment, factually, the Portable Cold Grease Remover's specification (U.S. Pat. No. 4,024,057) provides absolutely no suggestion of employing such ‘conventional coolant liquids’ impinging directly upon plate 11, but it distinctly specifies the ‘advantage’ of coolant notcontacting Plate 11.

Listed Downside of Portable Cold Grease Remover (U.S. Pat. No. 4,024,057—FIG 1—Prior Art)

Beyond the Cold-Metal Effect Principle, the ‘Portable Cold Grease Remover’ (U.S. Pat. No. 4,024,057) is simply not a remover of grease, and the following points highlight some of its problems;
a.) It constitutes a bona fide heater,
b.) It employs primarily but Cold-Metal Effect Principle's frigid qualities,
c.) It, in all embodiments, demands and calls for maximum heat absorption for operation,
d.) Its related reference (U.S. Pat. No. 4,024,057) provides no direct or indirect suggestion for employing anything but a maximized heat absorbing and conducting surface area to acquire grease, hence, it uses maximized heat, as so intended and specified,
e.) All embodiments discussed in U.S. Pat. No. 4,024,057 employ a minimal, planar area where cold or frigid qualities may be applied, thereby inherently relegating and marginalizing but minimal cooler agencies to perform the task of combating immense, high-temperature and grossly disproportionate amounts of heat that are disproportionate to cooling surface (see FIG. 1—Prior Art),
f.) It uses the Grease/Oil Heater Configuration (see glossary on Page 32) whereby above items d.), and e.), are employed in combination, disallowing for a Grease/Oil Cooler Configuration (see glossary on Page 32) which is the diametrically opposite configuration,
g.) It does not compensate for the Igloo Effect while it employs primarily solid coolants,
h.) It calls for use of cold water as a ‘coolant,’ which is insufficient for common kitchen grease removal,
i.) Coolants coming in contact with plate 11 (FIG. 1—Prior Art) are not sealed,
j.) It absolutely cannot employ a cryogen refrigerant in direct contact with its plate 11 upper surface, towards preventing “accidental spills of a coolant into the soup or broth,”
k.) It calls for a totally dissociated and independent cell filled with coolant such as water or ice as a ‘means of cooling plate 11’ (see FIG. 1—Prior Art), that cannot possibly impart sufficient cooling frigid qualities through several formidable barriers to cause various necessary reactions of hardening grease, keeping grease adhered to plate 11,
l.) Its concepts and principles are concretely based on maximum high-temperature heat absorption, and therefore, so functions accordingly, to absorb heat, thereby being an excellent grease melting apparatus,
m.) It is not quickly-scrapeable of its grease accumulated by Cold Metal Effect Principle,
n.) In use, it cannot be inverted upside-down or ‘bottom-up’ in order to scrape the multiplicity of projections without dumping its contents,
o.) It does not supply enough cold or frigid agencies to combat even a thin, insular hardened grease barrier, because it is designed to absorb masses of heat,
p.) It calls for heating to remove hardened grease on its contacting surface, prohibiting it from being wiped of grease for immediate re-use,
q.) It does not possess adequate cooling for continual-use especially necessary under hot kitchen conditions,
r.) Insufficient cold qualities, by way of the types and kinds of coolants used in combination with other compounded factors, restrict the Portable Cold Grease Remover to use on but, for example, a bowl or two of soup, as opposed to pots of boiled beef ribs,
s.) Its prime detriment is a configuration which has a lower or bottom, maximum heat-absorbing grease contacting plate 11 (see FIG. 1—Prior Art) whose area may be multiples that of the converse cooling side of the bi-facial plate 11. This Grease/Oil Heater Configuration (see glossary on Page 32) is a deficit, and detrimental towards practical grease removal via cold metal.

### SUMMARY

In accordance with all embodiments, a frigid-reactance grease/oil removal system comprises a reservoir accommodating a generally sub-freezing, cold-permeating fluid cryogen to directly impinge on an internal cooling surface inside the reservoir. The internal cooling surface is conversely-situated directly back-to-back with, and contiguous to an external grease/oil-contacting extricating surface whose face is situated exterior to the reservoir. Both internal and external surfaces comprise a bifacial/multi-functioning, interior/exterior element/wall of the reservoir. The cooling surface area is greater in surface area measurement than the area of the contacting/extricating surface, to facilitate adequate cooling for use.

In use, the reservoir is manipulated whereby the contacting/extricating surface contacts grease/oil that reacts and instantly accumulates and hardens onto the contacting/extricating surface from which it is scraped or otherwise removed. The above greater-to-smaller area configuration enables continual or continuous grease/oil extrication, commercially or domestically.

### DRAWINGS—FIGURES

FIG. 1 Shows Prior Art (U.S. Pat. No. 4,024,057) reflecting distinct oppositions in design, function, concepts, and principles in relation to embodiments herein

FIG. 2 Shows an exploded perspective view of first embodiment's internal and external portions, and a dashed line to indicate sectional cut of embodiment seen in FIG. 3

FIG. 2a Shows a partial sectional view of first embodiment's variation of copper/silver/stainless steel

FIG. 2b Shows first embodiment in use

FIG. 3 Shows a sectional view of FIG. 2, revealing first embodiment's internal functions

FIG. 3a Shows a partial sectional view of the first embodiment wholly and entirely cast as one, single part

FIG. 3b shows a grease/oil spatula

FIG. 4 Shows an exploded perspective and partial section view of second embodiment's general assembly

FIG. 4a Shows an exploded perspective and partial sectional view of second embodiment's general assembly when internally cooled

FIG. 5 Shows the second embodiment in-use and using a scraper blade

FIG. 5a Shows the second embodiment in-use and using a pressurized fluid nozzle

FIG. 5b Shows the second embodiment in-use and using a vacuum nozzle

FIG. 6 Shows a perspective, partial sectional view of hollow axle

FIG. 7 Shows a partial sectional view of hollow axle when in reservoir

FIG. 7b Shows a partial sectional view of hollow spindle

FIG. 8 Shows a floating vessel when second embodiment is employed

FIG. 8a Shows an exploded perspective and partial sectional view of second embodiment when reservoir is wholly cast

FIG. 9 Show schematic of internal cooling and embodiment

FIG. 9a Shows schematic of internal cooling of second embodiment when whole refrigeration unit is in embodiment

FIG. 10 Shows a partial sectional view of third embodiment's hollow spindle

FIG. 11 Shows a partial sectional view of third embodiment when cast with copper sheathe, using two bearings per end-wall, and using hollow spindle

FIG. 11a Shows a partial sectional view of third embodiment with scraper blade, motor and force ring

FIG. 12 Shows a partial sectional view of the third embodiment's reservoir with axle

FIG. 12a Shows a perspective partial sectional view of third embodiment's end, shell wall workings and hollow spindle

FIG. 12b Shows a vacuum nozzle for the expulsion of greases and/or oils from off embodiment

FIG. 12c Shows a pressurized fluid nozzle for the expulsion of greases and/or oils from off embodiment

FIG. 14 Shows the embodiment being used as a ‘scrubber’ to remove greases/oils (as defined) from fluid, gaseous media.

### GLOSSARY—ALPHABETIZED

Cold: The limited absence of Heat in relation to human beings' normal body temperatures: Also, a common colloquialism understood by many, including some scientists, to be an active force. However, some sciences predominantly insist cold is not a force whatsoever, but is, blatantly and rather, ‘the absence of heat,’ and/or that ‘cold’ does not exist. Herein, the critical term, ‘cold’ or ‘frigid agencies/qualities,’ although seeming to behave as a force that can drive away ‘heat,’ means the limited absence of heat in relation to a human being's normal body temperature. Temperatures above that relative point are warm to hot; Temperatures below that relative point are cool to cold. Applicants, preferring to speak in terms comprehensible to most, can neither substitute nor sustain the term, ‘the absence of heat,’ in lieu of ‘cold,’ as there is not a known single thing on Earth that possesses complete ‘absence of heat’ with which to relatively compare temperatures for human understanding. To claim, for example, that ‘the absence of heat drives away heat,’ to many, is vague and incomprehensible; Hence, while Webster's New World Dictionary (Third College Edition, Copyright 1994 Simon & Schuster, Inc) defines cold as, “1 . . . often thought of as an active force,” applicants take no side of theoretical scientific argument, but attempt to convey thought and reactions in a manner most comprehensible to cooks or oil workers. Applicants use ‘cold’ colloquially and as herein described to best convey the workings of various embodiments.

Cold Metal Effect: A term referring to a natural law that causes solid metal objects to accumulate and bear ‘cold’ or ‘frigid qualities’ that is/are [respectively] active reactants to grease or oil (also reactants), causing greases' and oils' viscosities to change radically by becoming hard or more viscous

Continual: Happening over and over again interruptedly, repeated in succession

Continuous: Going on without interruption, without break Cryogen: From kryos [Greek] meaning cold or frost: Herein, generally, a fluid coolant or refrigerant (something that reduces heat) that may be in the form of a gas or a liquid, including, for example, non-toxic antifreeze, that can receive cold, frigid qualities that can be exchanged for warmer qualities; Nitrogen, for example, may also be considered a cryogen, or rapidly expanded air, or ice slush

Igloo Effect: A term referring to a phenomenon whereby, a given mass of ice attached to a metallic surface that is warming, thereby forming warm liquefied water or gas (such as ambient air) sandwiched between that ice and metal; Though the ice is colder than the water (melted and warming ice) contacting the metal, the metal can become no colder than the sandwiched, insular water and gas that may be, at best, from approximately 35 degrees Fahrenheit upwards to warm. Notwithstanding latent cold of an ice mass (despite size) above the metallic mass that has warmed, cannot effectively penetrate air and warmed water beneath it to the metal

Frigid Agency: Another term for ‘frigid’ or ‘cold,’ both being colloquialisms according to some scientists and applicants; Also employed herein are the terms ‘cold agencies’ and ‘frigid qualities’ which mean, ‘cold’ that denotes or connotes that a limited absence of heat is an acting agent actually causing a physical, chemical reaction

Grease: Refers primarily to animal fats and oils, though loosely also applies and pertains to petrochemical or hydrocarbon crude oils and derivatives, including, but not limited to burned hydrocarbons or burned coal residues mingled with

Grease/Oil Cooler Configuration: A physical arrangement of a bifacial, thermal-conducting object (such as a plate), used to cold-extricate grease/oil, whereby one surface is enhanced in proportional relationship to the other surface: The surface that is to receive and provide cool qualities is larger than its opposing, back-to-back surface-companion that is smaller and that contacts grease/oil to collect it. This configuration serves to cold-extricate grease

Grease/Oil Heater Configuration: A physical arrangement of a bifacial, thermal-conducting object (such as a plate), used to cold-extricate grease/oil, whereby one surface is enhanced in proportional relationship to the other surface: The surface that is to provide cooling is smaller than its opposing, back-to-back surface companion that is larger and that contacts grease/oil to collect it. This configuration cannot serve to efficiently and effectively cold-extricate grease due to heat augmentation and massive intake of heat. Greases typically become less viscous when heated

Harden: The increasing of viscosity of oil or grease (making thicker)

Heat: A theoretical term meaning; form of energy due to random motion of molecules, this energy being transferable

Melt-down: When grease is hardened and attached upon a frigid metallic substance due to frigid qualities within that metal, and when that metal substance is submerged in liquefied grease, a point of ‘melt-down’ eventually occurs when there is not sufficient ‘cold agencies’ available to maintain the attached (to metal) grease as a solid while the grease itself is a insulator. Excessive heat causes melt-down

Oil: Any various kinds of greasy, combustible substances obtained from animal, vegetable, and mineral sources, including hydrocarbons, though loosely applies to grease and some synthetic oils, further including; burned hydrocarbon and burned coal residues

Reaction: The mutual or interactive action of substances undergoing change; a process that involves changes; the state resulting from such changes

### Drawing—Reference Numerals—First Embodiment

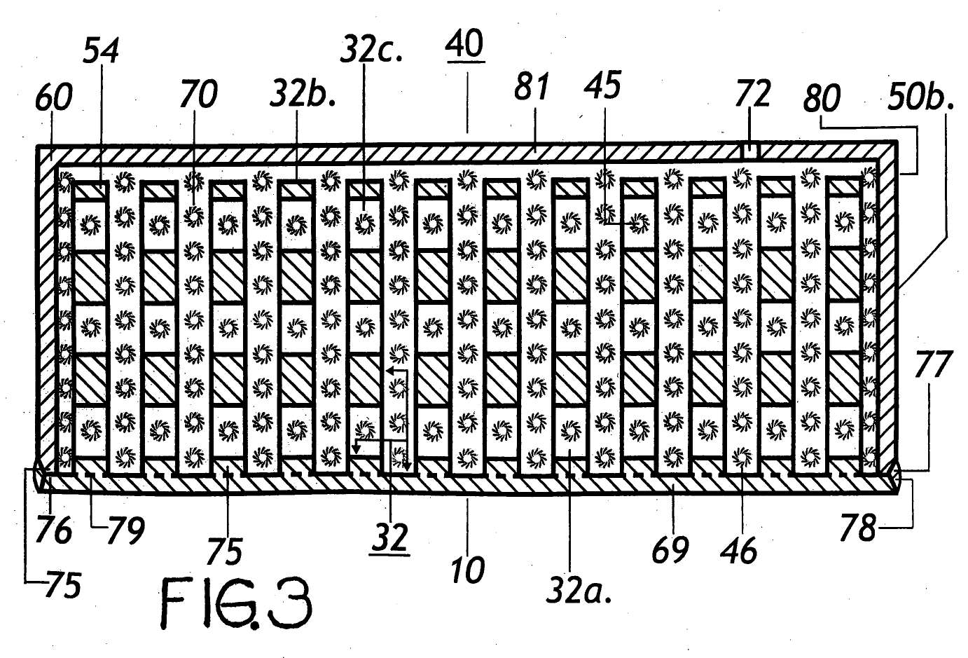

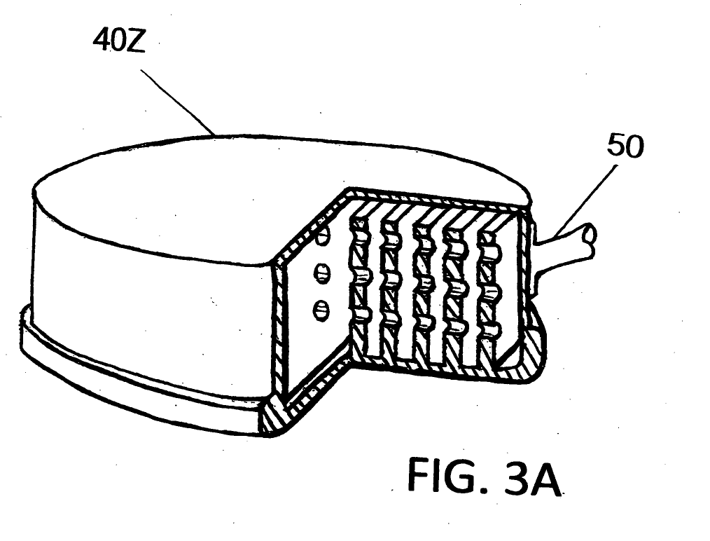

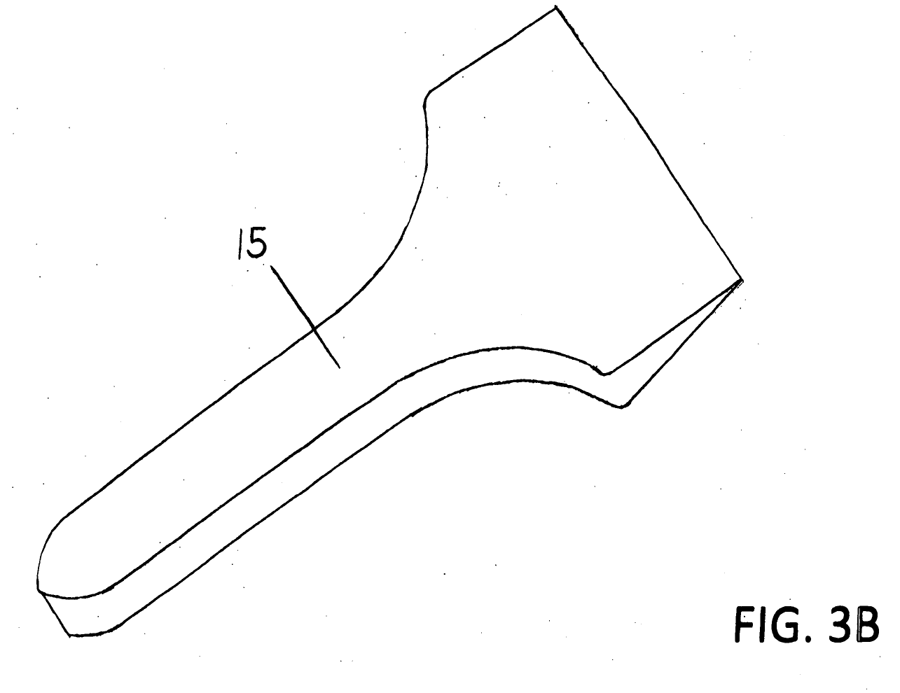

10 external grease/oil-contacting/extricating surface
10X external grease/oil-contacting/extricating surface
15 spatula
32 internal cooling surface
32a. frigid-agency receptor surface floor
32b. frigid-agency receptor fin surfaces
32c. frigid-agency receptor void surfaces
32X internal cooling surface
40 reservoir
40X reservoir
40Z cast reservoir (FIG. 3a only)
45 horizontal collector voids
46 vertical collector voids
50 handle arm
50b. handle arm attachment point (FIG. 3 only)
54 cooling fins
54X cooling fins
60 reservoir shell
60X shell
65X inner wall
66X perimeter wall
67X gutter
69 bifacial/multi-functioning interior/exterior element/wall
69X wall
70 fluid cryogen (identified by dashed circles)
72 injector hole
75 upper attachment flange perimeter (FIG. 3 only)
76 lower attachment flange perimeter
77 upper weld-bead bevel
78 lower weld-bead bevel
79 perimeter weld (FIG. 3 only)
80 reservoir shell wall
81 reservoir shell ceiling

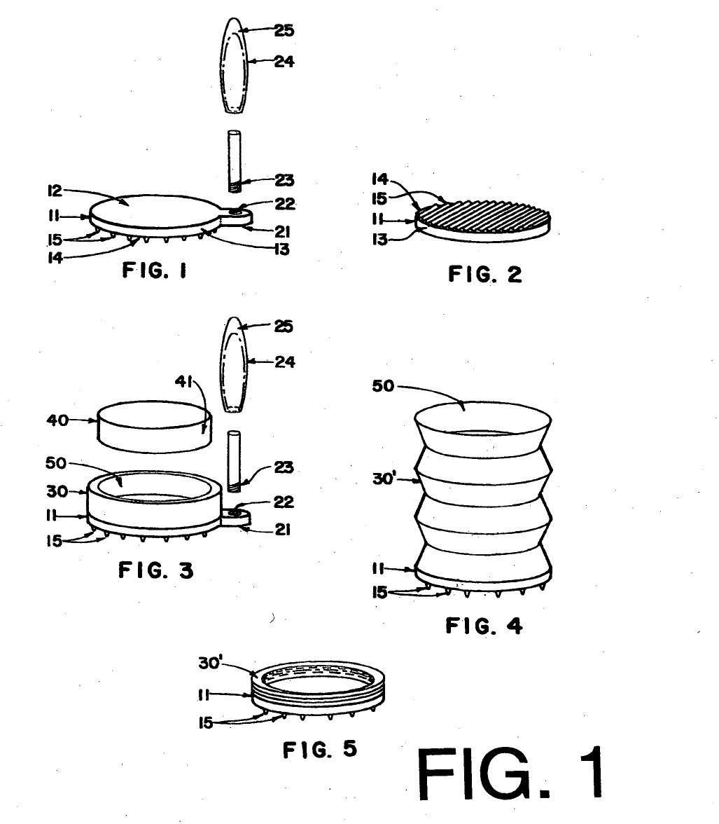

### Detailed Description—First Embodiment—FIGS. 1, 2, 2a, 2b, 3, 3a and 3b

### Critical Definitions

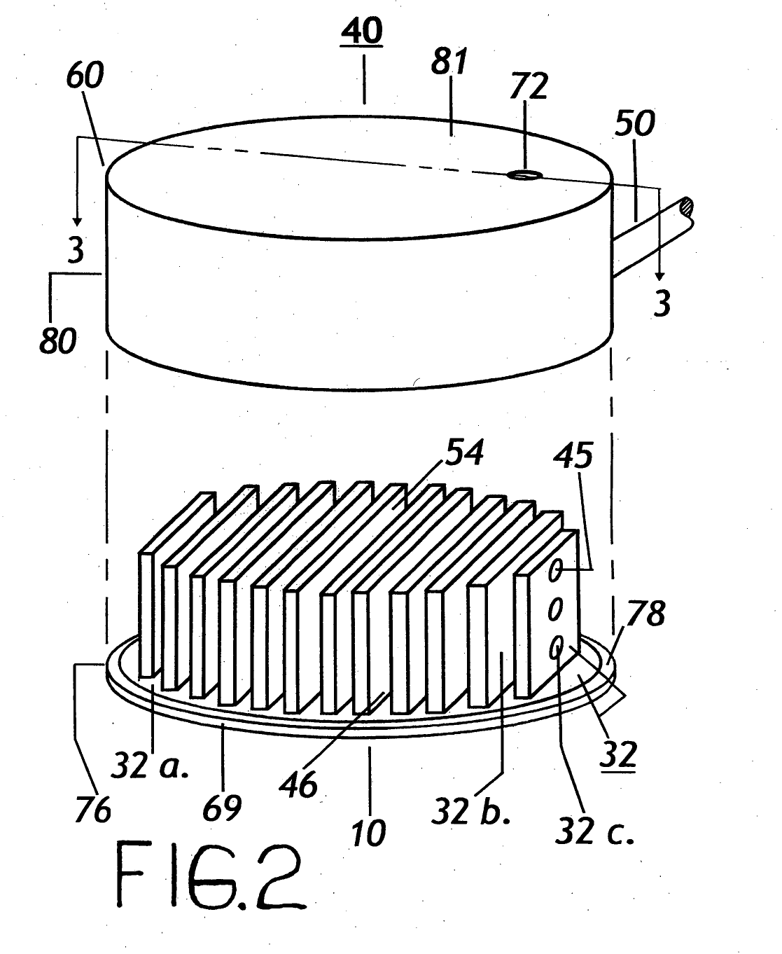

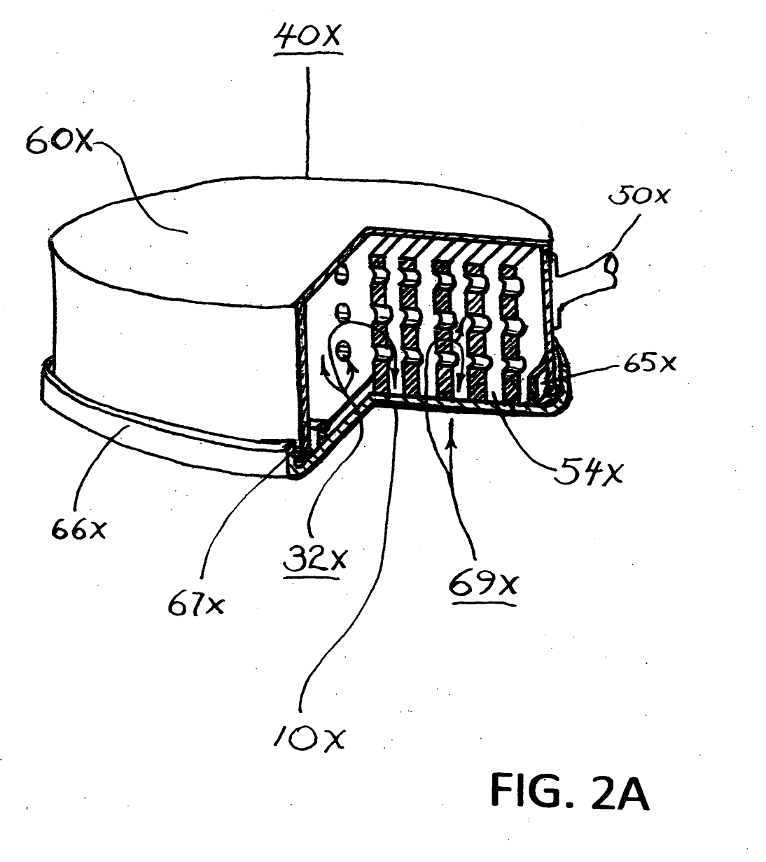

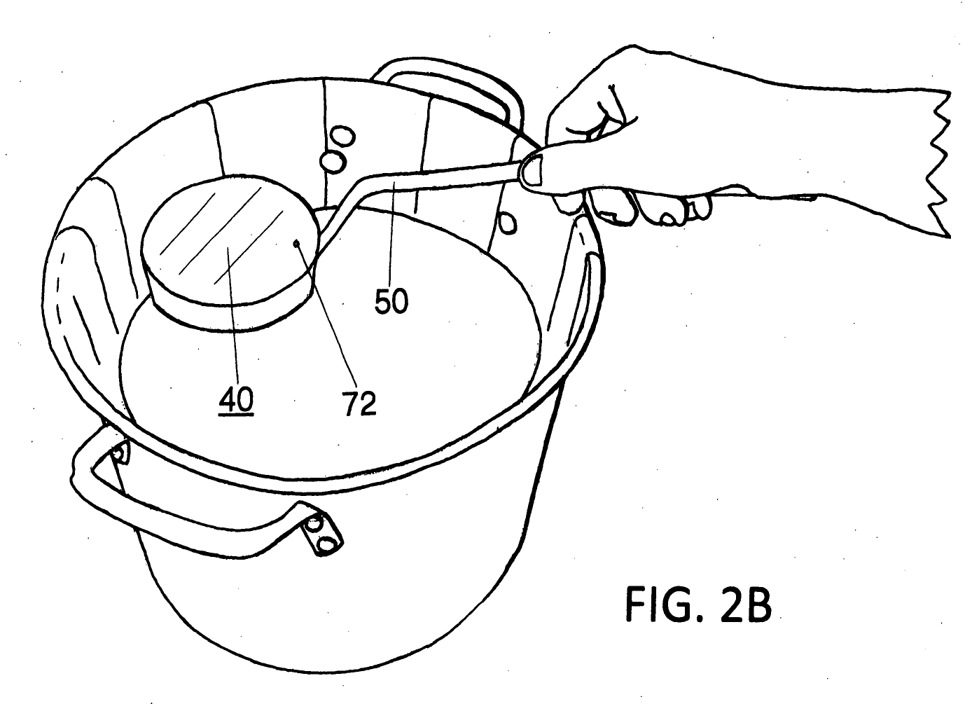

The first embodiment as seen in FIGS. 2, 2a, 2b, 3, 3a and 3b are continual-acting for continual-use grease and oil extrication as specified herein. The terms, ‘continual’ and ‘continuous’ herein are not interchangeable, and must be carefully regarded in this application:

‘Continual’ means: Happening over and over again, repeated in succession, ‘Continuous’ means: Going on without interruption or break.
These terms are critical because, the first embodiment and related contemplated variants of it are continual-acting, while the second embodiment and its variants are continuous-acting.

### Truly a One-Part Embodiment Broken Down for Sake of Understanding

The first embodiment description focuses primarily on the construction shown in FIG. 2—Exploded Perspective View, Continual-Action, Process, and FIG. 3—Cut-Away View, Continual-Action which is a sectional view taken on line 3-3 of FIG. 2. However, to apprise the reader, other Figs of contemplated variants are mentioned (some illustrated) for sake of clarity.

The first embodiment may easily be comprised and therefore, constructed or “cast” of but one, single part as illustrated in FIG. 3a—Cut-Away View of Single-Part Cast Variant. However, to better describe the embodiment, applicants first illustrate and demonstrate that the embodiment illustrated in FIG. 3a—Partial Sectional View of Single-Part Cast Variant can also be constructed modularly by segmenting features into varying elements or parts as in FIGS. 2, 2a, and 3. Joining segmented elements or parts is primarily dependent upon types of materials employed [for example, welded, soldered, mechanical-attachment by thread-fastening, casting, glues/mastics]. Thusly breaking down the single-part embodiment better apprises the reader, methodically, of structure, function and operation, despite the one-part formulation. Therefore, contemplated variations of the first embodiment are so exactly similar (excepting materials, sizes, and how elements join [solder, welding, mastic, for example]), for sake of ease to the reader, applicants refer to these as the same embodiment.

Moreover, instead of the reader trying to comprehend one single cast part that multi-functions in several ways, breaking down the various angles of that ‘one part’ illustrated in FIG. 3a facilitates understanding: For example; better understanding top, sides, internals, and bottom. To be clear, if the reader first understands the variation illustrated broken down in FIG. 2 and FIG. 3 (that are identical and the main topic here), the reader shall then better understand the one, ‘single part.’ Applicants, therefore, commence discussing the embodiment broken-down.

### Broken-Down, Two-Part Main Parts

Illustrated in FIGS. 2, 2a, and 3, is the basic first embodiment that is shown segmented, modularly in a sense, and not as one, single cast part as in FIG. 3a.

Because FIG. 2a—Perspective Partial Sectional View, Copper/Silver/Stainless Steel Variant merely illustrates different materials than those in. FIGS. 2 and 3 (aluminum), FIG. 2a shall be discussed in further detail elsewhere.

Despite numerous reference numerals, we contemplate that the first embodiment (in FIGS. 2, 3), modularly, consists of two main parts, namely, a bifacial/multi-functioning interior/exterior element/wall 69 (FIGS. 2, and 3), and a reservoir shell 60 (FIGS. 2, and 3), when these two parts are not cast into a single part as in FIG. 3a. These ‘two main parts,’ joined by welding (FIGS. 2 and 3), form a single, contiguously-connected, reservoir 40. When these two parts are cast together, they form a single cast reservoir 40Z seen in FIG. 3a.

For explanation of bifacial/multi-functioning interior/ exterior element/wall 69 (hereinafter, wall 69), being one part in FIGS. 2, and 3, we use a common frying pan. A pan is ‘bifacial,’ and whose upper surface and portions, including walls, have specific functions. The upper surface is contiguous and back-to-back with, and converse positioned to the pan's lower, bottom. The bottom's surface has its various functions that are unlike those of the upper surface. Wall 69 is, basically, the same in a sense: It is one bifacial part having two sides converse and back-to-back of each other, reverse-faced of each other, each having its own functions and shapes. One side of wall 69 is internal of reservoir 40, and the opposing side is situated exterior of reservoir 40.

Making Connections of the Broken-Down, not-Wholly-Cast Version: Heat-Conducting Metals

FIGS. 2 and 3 both illustrate a combination, part-cast/part-stamp-formed aluminum embodiment, whereby wall 69 is cast, reservoir shell 60 is press-formed, and the two of these welded together. Wall 69 and shell 60 contiguously join (by welding), forming reservoir 40.

While FIGS. 2 and 3 illustrate wall 69 welded to shell 60 (aluminum-to-aluminum), leak-proof-sealing wall 69 to shell 60 is necessary lest contents of reservoir 40 leak. A further contemplation is that; wall 69 and reservoir shell 60 (FIGS. 2 and 3) be fused together by chemical-attachment (with conventional temperature-resistant glues, mastics, or epoxies). Another contemplated option is conventional male-to-female thread-fastening whereby wall 69 is screwed (by thread) into shell 60, or vise-versa (not illustrated). Conventional bolt or screw-fastening, or riveting is also a contemplation (not illustrated). Applicants have concluded that weld-fusing wall 69 to shell 60 would less likely produce a leak of the contents of reservoir 40, and is therefore, preferred when employing an aluminum shell 60 and aluminum wall 69 modularly.

Applicants contemplate that the embodiment shown in FIGS. 2, 2a, 2b, 3, and 3a be primarily and generally of all metal construction, but other materials are in consideration, as further herein detailed. Hot/cold conductibility is always to be a consideration as regards choices of metals. Also contemplated is that the embodiment have no moving metallic parts, being one, single, contiguously-fused or wholly cast embodiment.

A fixed handle arm 50 (FIGS. 2 and 2b) is of consideration for manual manipulation of reservoir 40. Reservoir 40 can be seen in use in FIG. 2b. Also contemplated is a detachable handle (not illustrated) with or without an insulating, non-metallic sheath (not illustrated) for handle arm 50.

FIG. 3b shows a spatula 15 that is used for scraping greases and/or oils that are extricated and accumulated onto wall 69. Also of consideration are various embodiment sizes that can accommodate either commercial or domestic uses (further detailed hereinafter).

Temperature in relation to part connections is a critical factor because, some materials effectively conduct heat where heat conduction would not be desired. For example, materials such as certain solders (when applicable with certain metals), would not amply conduct heat where necessary when a predominantly silver solder (conventional) would be exceptional due to its conductibility. When joining elements or parts, therefore, temperatures and thermal conductibility must always be of critical consideration, such as in the employment of mastics or glues, and any joining medium. In some cases, a poorly-conductive stainless part steel may be inserted into molten aluminum (a better conductor) to join the two as desired. Thermal conductance is of concern throughout this application.

### Focusing on Bifacial/Multi-Functioning Interior/Exterior Element/Wall 69

FIGS. 2 and 3 illustrate wall 69 (best seen in FIG. 2) as a cast aluminum part comprising cooling fins 54 that are situated internal of reservoir 40. Cooling fins 54 (FIGS. 2 and 3) are part of an internal cooling surface 32 and are grossly-sized surface-augmentations that are aluminum-cast together with external grease/oil-contacting/extricating surface 10 (otherwise known as extricating surface 10), forming wall 69. Cooling fins 54 in FIGS. 2 and 3 are, therefore, are integral to wall 69, forming one, single cast aluminum part.

Other materials besides aluminum (explained later), are in consideration for wall 69. Also of consideration is that cooling fins 54 be supplemented or substituted with other surface augmentations such as various-shaped pins, rods, cones, valleys, ridges, or other protruding shapes that shall grossly enhance area for ultra-cooling, some of which are further explained hereinafter. Moreover, copper fins 54 (not illustrated) or other protruding shapes of various metals (such as silver), instead of cast aluminum, can be substituted as fins 54. The bases of fins 54 of copper or other shapes can be partly encapsulated into molten aluminum during casting for reasons detailed hereinafter.

In the case of a contemplated wall 69 made of copper, cooling fins 54 can be soldered with predominately silver solder, or silver pins, for example employed.

For mass production ease and budget considerations, reservoir shell 60 (FIGS. 2 and 3) can be cast together with wall 69 as seen in FIG. 3a. Thereby, reservoir 40 seen in FIGS. 2 and 3 would otherwise be a wholly cast reservoir 40Z seen in FIG. 3a. An alternative contemplation is that of reservoir shell ceiling 81 (of FIG. 3a): Instead of ceiling 81 being an element of reservoir 40Z, it would be a peripherally-welded aluminum plate added after casting the remainder of reservoir 40Z (not illustrated), for further manufacturing ease.

The embodiment as illustrated in FIGS. 2 and 3 allows for combining various metals as parts. For example, instead of a shell 60 made of aluminum, shell 60 may be made of beneficial stainless steel, and imbedded into molten aluminum during the casting of wall 69 as further discussed later.

In FIGS. 2 and 3, inside of reservoir 40, the internally-exposed area of wall 69 (that is, internal cooling surface 32) is grossly and significantly enhanced in relation to its bottom or lower, exterior surface, namely, external grease/oil-contacting/extricating surface 10. This large-area-to-small-area configuration is a Grease/Oil Cooler Configuration (see glossary on Page 32) and a notable feature demanding elaboration and consideration. This exact configuration cannot be reversed, otherwise, a Grease/Oil Heater Configuration (see glossary on Page 32) would be arranged.

Therefore, FIGS. 2, 2a, 2b, 3, and 3a all reflect that cooling surface 32 (part of wall 69) is substantially greater in area than extricating surface 10 that is planar, generally smooth (not porous), bearing no surface augmentations. This significant and remarkable difference over prior art (FIG. 1—Prior Art—U.S. Pat. No. 4,024,057) as illustrated in all prior art (U.S. Pat. No. 4,024,057) embodiments, is clearly notable.

That FIGS. 2 and 3 illustrate a flat extricating surface 10 is inconsequential, however, it may take various shapes such as cylindrical, concave, box, or numerous others, so long as a Grease/Oil Cooler Configuration (see glossary on Page 32) is arranged. Other variations and shapes of extricating surface 10 that actually contacts oil and grease, reacting them, are considered and discussed later.

All embodiments of applicants demand function by way of Grease/Oil Cooler Configuration (see glossary on Page 32), and not a Grease/Oil Heater Configuration (see glossary on Page 32) employed by prior art (U.S. Pat. No. 4,024,057). The Portable Cold Grease Remover (U.S. Pat. No. 4,024,057) demands and claims a plate 11 whose area that contacts grease is of maximized area proportions in relation to its cooling area, to absorb maximum heat.

Internal cooling surface 32 seen in FIGS. 2 and 3 comprises a frigid-agency receptor surface floor 32a, frigid-agency receptor fin surfaces 32b, and frigid-agency receptor void surfaces 32c: All three of these comprisals, as seen in FIGS. 2 and 3, combine with extrication surface 10 to form one contiguous, wall 69, part of which is housed inside of reservoir 40, and part is external to reservoir 40.

In FIGS. 2 and 3, the overall shape of wall 69 is round from a top view. However, a round shape is neither critical nor necessary; square, rectangular, “U-shaped,” oval, octagonal, and other shapes to accommodate various cooking vessels and applications are of consideration and contemplation. Typically, a domestic cooking vessel is round, hence, a round wall 69 is illustrated in FIGS. 2, 2a, 2b, 3, and 3a. Applicants consider and contemplate various sizes of the embodiment. The approximate size depicted in this specification's drawings are specified hereinafter.

### The 2^{nd} Element of the Broken-Down, Two-Part, Not-Wholly Cast Version

FIGS. 2 and 3 illustrate reservoir shell 60 that is a simple, aluminum, press-formed shape resembling an inverted or upside-down aluminum cooking pot. Reservoir shell 60 (FIG. 3) has an upper weld-bead bevel 77 that entirely and completely circumvents an upper attachment flange perimeter 75, to neatly accommodate a perimeter weld 79 (FIG. 3 only) that leaves a weld bead formed during assembly. Reservoir shell 60 rests squarely upon, and is attached to, wall 69. Upper weld-bead bevel 77 and a lower weld-bead bevel 78 (FIGS. 2 and 3) that surround a lower attachment flange perimeter 76 (FIGS. 2 and 3) of wall 69 are externally exposed to accommodate sufficient fusion bead. Shell 60 in FIGS. 2 and 3 is constructed of 0.333 CM (0.125 inches) aluminum.

However, shell 60 can be formed in numerous ways and of various materials, some more advantageous than others. Also of consideration is employing a type 304 stainless steel reservoir shell 60 for this steel's highly desirable, severely poor thermal conduction capacity, that being approximately 9.4 times less than aluminum. This means that, when reservoir 40 is sealed with a stainless steel shell 60, escape of contained frigid-agencies through a reservoir shell wall 80 and shell ceiling 81 in FIGS. 2 and 3 (together constituting shell 60), would be impeded and diminished in comparison with an aluminum reservoir shell 60. Being that a goal is to optimize cooling, stainless steel would be advantageous for this purpose.

Contemplated is that shell 60 made of stainless steel can also be set into wall 69 while being cast and aluminum is molten. In like manner, a “ceramic” shell 60 may also be thusly employed, as contemplated.

Either stainless steel, ceramics, or other versions of reservoir shell 60 can be attached to wall 69 by various modes, we contemplate. For example: including epoxies or mastics, or molten softer metals (providing the molten metal may attach to either of the elements as in FIG. 2a where stainless steel shell 60 is embedded and encapsulated by silver contacting a copper wall 69).

### Keeping Cool

After reservoir shell 60 and wall 69 have been welded and fused together as detailed above (or wholly cast as one part as in FIG. 3a), a fluid cryogen 70 (illustrated by a multitude of circular dashed shapes [FIG. 3 only]), is filled through an injector hole 72 (FIGS. 2 and 3) to about ¾ (three-quarter) full capacity of reservoir 40. Atmospheric air is also evacuated through hole 72 to impede internal heat conductance, however, the embodiment functions satisfactorily without evacuation of ambient air: Evacuation improves efficiency. Fluid cryogen 70 used in this case, as is contemplated, is a common, and conventional non-toxic propylene glycol/water compound although other considerations are that various liquid or gas components such as conventional nitrogen or other cold gas (or liquid-to-gas) can be employed [in given cases detailed later]. Fluid cryogen 70 in this application will not freeze solid at normal freezing temperatures of H²O (pure water). Fluid cryogen 70 can be as cold as ice yet is able to freely impinge upon internal cooling surface 32 that is augmented in area size (relative to extricating surface 10). Reservoir 40 (FIGS. 2 and 3) or wholly cast reservoir 40Z (FIG. 3a) is generally a sealed, quasi-permanent reservoir housing fluid cryogen 70 (fluid cryogen 70 only seen in FIG. 3) until fresh fluid cryogen 70 becomes necessary due to shelf-life maximums.

Careful note should be given that whenever reservoir 40 is ever mentioned in this specification for use (besides in explanations concerning its construction), it is always presumed to be filled to some degree with fluid cryogen 70, integrally. When FIGS. 2, 2a, 2b, 3, and 3a are viewed, they are to be viewed with the understanding that fluid cryogen 70 (whether in the form of propylene-glycol/water, and/or other cold liquid or gas), is present.

Understanding operation is helpful: Reservoir 40 of FIGS. 2 and 3 is normally stored in a conventional freezer. In a sense, reservoir 40 is as a self-winding watch. In use, immediately after a given layer of grease or oil is extricated from hot cooking stock, extricating surface 10 is quickly scraped of its accumulated grease that acts as a thermal insulator, impeding desired reactions (grease/oil extrication). Then, reservoir 40 is given a few shakes (to cause fluid cryogen 70 to swoosh around, thereby freezing cooling fins 54, to recharge cooling surface 32 and extricating surface 10 [wall 69] with cold frigid qualities), before re-applying reservoir 40 for further, continual grease/oil-removal. Another necessity, therefore, for a quasi-smooth (not porous), minimized surface that contacts grease and oil is revealed: When comparing Prior Art (FIG. 1—Prior Art—U.S. Pat. No. 4,024,057), a quick, necessary scrape is impossible, while heating is recommended to remove accumulated grease from ‘plate 11.’ Moreover, prior art—U.S. Pat. No. 4,024,057 disallowed for a quick ‘recharge.’

### Further Considerations

Also considered is a construction employing wall 69 as seen in FIGS. 2 and 3: However, in lieu of reservoir shell 60 being of press-shaped aluminum resembling an inverted pot, cylindrical-shaped aluminum tubing would be used as shell wall 80. Plate aluminum would form reservoir shell ceiling 81. This consideration and others mentioned above demonstrate that there are several ways to construct the embodiment that can be, as stated, cast entirely into one single part.

In any case, reservoir 40, when its construction is complete, is a leak-proof encasement or cell, in essence (FIGS. 2, 2a, 2b, 3, and 3a). After filling with fluid cryogen 70, injector hole 72 (FIGS. 2, 2b, and 3) is sealed shut; other considerations are the uses of various types of valves or a “set-screw” to seal injector hole 72, yet making it refillable, as necessary, and allowing for atmospheric evacuation simpler: Air is evacuated by use of a conventional vacuum pump (not illustrated). The wholly cast, one-part embodiment (FIG. 3a) is also permanently sealed.

Also contemplated is that, prior to filling reservoir 40, handle arm 50 seen in FIG. 2 is weld-attached to reservoir shell wall 80 at handle arm attachment point 50b. seen in FIG. 3. A detachable handle is also contemplated. Moreover, of consideration is a hoist or lift attachment/accommodation to dip or skim wall 69 onto a basin demanding grease or oil removal when reservoir 40 can be extremely large and heavy, for commercial and industrial use, for example, where only a continual-use application applies (not illustrated). Handle arm 50 is welded to reservoir shell wall 80 as seen in FIG. 2, 2a, 2b, and 3a.

Further contemplated is that; In construction, instead of casting wall 69 it can start as a solid, round stock of aluminum or other metal such as copper whose thermal conductivity capacity is nearly three times that of cast aluminum. Silver's thermal conductivity capacity is 2.94 times that of cast aluminum. Therefore, silver is of contemplation as being an ideal material for any/all individual comprisals of wall 69 in some cases when construction may permit.

### Subtle Facts

A mentionable subtle fact, however, is that despite rate of thermal conductivity, cold must overcome heat, not vice-versa as overtly intended and specified with prior art—U.S. Pat. No. 4,024,057 illustrated in FIG. 1—Prior Art. On the extreme contrary, with the herein embodiments of applicants', the opposite of ‘prior art’—U.S. Pat. No. 4,024,057 stands true. Cold must always overcome heat, never vice-versa. Therefore, whether aluminum, copper, silver, or other materials are employed, there exists a battle of cold versus hot, and cold must always win, conductivity rate mostly being relative to speed of grease accumulation, generally. For this reason, use of proper metals compounded with the Grease/Oil Cooler Configuration facilitates cold frigid agencies to serve as a reactant via extricating surface 10.

Sizes and more Details

Contemplated embodiment dimensions: Referring to reservoir 40 seen in FIGS. 2 or 3 is approximately 12.5 CM otherwise, 5. inches in diameter, and approximately 2.7 times as wide as is high (width/height ratio). Consideration must be given to embodiment sizes, shapes, and other contemplations: Sizes and shapes for domestic/home use, restaurant use, school cafeteria or military food preparation, or those sizes and/or shapes for larger industry, would vary according to application and demand.

Also contemplated is that in FIGS. 2 and 3, cooling fins 54 possess vertical collector voids 46 and horizontal collector voids 45 through which fluid cryogen 70 can freely move about reservoir 40 at ultra-freezing temperatures and not solidify in any conventional freezer where reservoir 40 is normally stored. We bear in mind the above-mentioned self-winding watch-type effect.

Moreover contemplated for wall 69, while viewing FIGS. 2 and 3: Instead of casting aluminum, an alternative method of construction for wall 69 is as follows: Lower attachment flange perimeter 76 and lower weld-bead bevel 78 are first machined from stock aluminum (copper can also be employed) to squarely accommodate reservoir shell 60. Thereafter, sawing or milling creates twelve or more each, tall surface-augmenting, perpendicular, fin-shaped, cold-absorbing structures called cooling fins 54 that include vertical collector voids 46 and horizontal collector voids 45 that sandwich frigid, fluid cryogen 70, we contemplate. Moreover, upper weld-bead bevel 77 (FIG. 3 only) and its lower attachment flange perimeter 76 (FIGS. 2 and 3) at the base of reservoir shell wall 80 (FIGS. 2 and 3) are also machined for square fit as seen in FIG. 3 atop wall 69 and its lower attachment flange perimeter 76.

Insofar as the number of fins, valleys, peaks, or other protrusions that enhance area upon wall 69, the related augmented area is predetermined. Albeit, any surface augmentation to increase, even slightly, cooling over heat that is potentially absorbed by hot grease/oil contact at extricating surface 10 is at issue. Also considered with a copper wall 69 is that it be machine-threaded about its lower attachment flange perimeter 76 to accommodate a stainless-steel, aluminum, or other [material] reservoir shell 60. Note that copper slightly speeds up grease removal operations over aluminum, though overall, operation and effectiveness is not significantly improved.

Further contemplated: The bottom surface of bifacial/multi-functioning interior/exterior element/wall 69 in the embodiment reflected in FIGS. 2 and 3, namely external grease/oil-contacting/extricating surface 10, actually contacts, reacts, and transforms hot grease or oil, and is planar and quasi or generally smooth (not porous), hence, minimally-surfaced in area. The thickness of metal from the minimized, planar face of external grease/oil-contacting/extricating surface 10 upwards to frigid-agency receptor surface floor 32a. is approximately 0.333 CM otherwise, 0.125 inches thick; meaning, an area located between the reaction area that contacts grease and its upper, converse, and opposing frigid-agency receptor surface floor 32a. Other various measurements are in consideration.

Moreover, besides measurements and materials, other considerations exist whereby wall 69 and its extricating surface 10 could be bent, curved, such as convex, tubular-shaped, or otherwise shaped. To be clear, so long as the surface area of extricating surface 10 is less than the surface area of internal cooling surface 32 to any extent, degree, or measurement (FIGS. 2 and 3), then the surface of extricating surface 10 can be curved, hill, or convex, planar, or take on other shapes, whether pyramidal, cone, box, or otherwise. Extricating surface 10 is generally non-porous, allowing for ready-scraping. Prior art illustrated in FIG. 1—Prior Art (U.S. Pat. No. 4,024,057) is an antithesis to the embodiments illustrated in this application as U.S. Pat. No. 4,024,057 demands and employs the exact opposite configuration in all embodiments, employing different principles and concepts altogether.

### Industrial-use Contemplations

Also contemplated, though not illustrated, are industrial-type, continual-use variations. Although built similarly to the embodiment described above, excepting size, one variation of the embodiment would have fluid cryogen 70 pumped into and out from reservoir 40 upon thermal demand (not illustrated). Fluid cryogen 70 would be exteriorly-refrigerated prior to pumping (not illustrated).

Another contemplated version of the embodiment (though not illustrated) would maintain its fluid cryogen 70 housed, excepting, reservoir 40 would house a conventional freezer's evaporator unit to maintain refrigeration of fluid cryogen 70 (if not a liquefied gas, for example, not needing such refrigeration). The ‘evaporator’ is that part of a freezer or refrigerator that emits cold (as in home air conditioners, freezers, and refrigerators). Other elements of the conventional freezer would be maintained exteriorly to reservoir 40 that would be conventionally thermostatically-controlled, much like larger home air conditioners having their evaporator separate from the other workings of conventional cooling systems.

All industrial versions could be hoisted or otherwise conventionally-manipulated into a bath or vat necessitating grease/oil extrication.

Insofar as scraping of grease, this can be performed manually or by way of a windshield-wiper-type or doctor blade (not illustrated), scraping in any direction, including vertically, or horizontally, when reservoir 40 is hoisted perpendicular to its normal-use position. Reservoir 40 can also be flipped upside down for scraping, and can be flipped over by way of simply planting two conventional spindles on reservoir 40 that can be its lifting points.

### Copper/Silver Element/Wall 69 and Joining a Stainless Steel Shell 60

Also contemplated and mentioned in passing is wall 69 being comprised of copper/silver (FIG. 2a). This feature would be employed in combination with reservoir shell 60 being comprised of stainless steel (preferably Type 304). Despite currently-popular marginalizations and relegations attributed to joining stainless steel to copper due to unweldability of these two dissimilar materials, applicants successfully join these two as seen in FIG. 2a. They can be effectively soldered or otherwise joined as explained hereinafter (no lead-containing solder). Moreover, where otherwise reservoir shell 60 would have to be either threaded (screwed onto) or bolt-fastened (with fasteners) to join these dissimilar metals [stainless with copper], applicants contemplate joining stainless steel to copper or silver without screwing or bolt fastening which are costly methods of joining. We must bear in mind that reservoir 40 cannot ever be allowed to leak either liquid or vacuum if applied (internally).

In FIG. 2a shell 60X was morphed from reservoir shell 60 in FIGS. 2 and 3. Herein, we explain how to join shell 60X (FIG. 2a) made of a stainless steel to a wall 69X made of copper/silver, bearing in mind, we desire that cold be impeded from radiating out externally from shell 60X. Hence, stainless steel (an ultra-poor thermal conductor) is used for shell 60X. Meanwhile, we desire maximum conductance of cold, hence, a copper/silver wall 69X.

There are several ways to configure this marriage of metals that are normally not seen used together due to a popularly-believed inability to join them, applicants believe. Applicants illustrate one method in FIG. 2a, albeit, there are a few successful methods. We illustrate a version that demands no machining of parts (hence, less expensive). Machining, although a viable and effective option to fabricate the embodiment, on a wide-scale basis, is prohibitively costly. The immediately-hereinafter described method is, by far, less expensive.

Referring to FIG. 2a: To construct the copper/silver/stainless-steel embodiment, a round sheet/plate of copper about 15 centimeters in diameter (six inches) and about 0.25 centimeter thick (about 0.125 inch thick) is fabricated. Our immediate construction goal is to construct a type of perimeter channel or gutter 67X with copper that circumvents the round plate, to accommodate the rim of an inverted, conventional stainless steel small pot. Gutter 67X is thusly formed: Gutter 67X is to very loosely accommodate the pot's rim. Then, crudely stated, gutter 67X is to be filled with a molten metal such as silver (illustrated FIG. 2a), or with a conventional epoxy, glue, or mastic (not illustrated) that can withstand the rigors of radical temperature. The pot's rim fits inside the channel bearing molten metal (silver is illustrated FIG. 2a) or adhesive.

To construct the outer-perimeter wall called perimeter wall 66X (FIG. 2a) that accommodates the inverted conventional pot's rim, the aforementioned flat plate of copper (approximately 0.25 CM thick) is crimped or press-formed whereby the plate's outer perimeter is bent upward 90 degrees (or perpendicular to the flat plate) to resemble a pan whose wall is about one centimeter high. A short length (about 1.0 CM) of copper tube about 13. CM wide (Outside Diameter) is cut. This tubing length shall form an inner wall 65X (FIG. 2a) of gutter 67X. inner wall 65X is, eventually, to be silver-soldered (conventional solder) to the top of the plate as illustrated in FIG. 2a. The press-formed plate, in other words, will be able to hold a full level of solder within gutter 67X.

Cooling fins 54X (FIG. 2a) (made of copper or silver or silver-coated copper as illustrated in FIG. 2a) are placed perpendicularly to the plate within the inner area. Gravity holds them in place while they are joined together, and are gravity-pressured against the plate's top while their bases absolutely contact the top of the plate. Inner wall 65X is also inserted. The plate, inner wall 65X, and the stainless-steel rim areas are heated to a temperature able to accommodate soldering (conventional tin/silver solder is acceptable). Any oxide layer must be removed with a conventional flux. The inverted pot is quickly inserted, silver is then melted into gutter 67X. Solder flows to attach inner wall 65X and fins 54X to the copper plate, thereby securing fins 54X that may also be constructed of other thermal-conducting materials, we contemplate. Fins 54X, we contemplate, can be pins, rods, cones, or any other shape to augment surface area of internal cooling surface 32X. Internal cooling surface 32X in FIG. 2a has morphed from internal cooling surface 32 in FIGS. 2 and 3. Inner cooling surface 32 in FIGS. 2 and 3 has external grease/oil-contacting/extricating surface 10 as its converse side; Internal cooling surface 32X in FIG. 2a has external grease/oil-contacting/extricating surface 1OX as its converse side. Illustrated (FIG. 2a) are plates of copper-plated silver.

Eventually, gutter 67X commences filling with silver. Another contemplation is that fins 54X and inner wall 65X may be soldered to the plate (in the shape of a pan), then, a conventional adhesive can be employed to secure the inverted pot.

Handle arm 50 is spot-welded onto shell 60X, injector hole 72 (not shown in Fig) is bored into shell 60X prior to assembly mentioned above. The silver, adhering to the copper, thereby firmly and permanently secures shell 60X, and creates reservoir 40X. That is vacuum and liquid-tight when complete. The internal area of reservoir 40X is injected with a conventional solvent to thoroughly rinse out excess flux. Reservoir 40X is then partially filled with fluid cryogen 70, a slight vacuum is pulled internally via injector hole 72 (using a conventional vacuum pump), then sealed, and this version of the first embodiment is complete, and ready for use.

We further contemplate that shell 60X be made of a ceramic or other materials such as heat-resistant plastics that can be attached with conventional adhesives after fins 54X are soldered into place. In any case, we contemplate that there are numerous ways to machine, or fabricate this embodiment. Various gutters may be formed, designs, shapes, and materials employed, however, the Grease/Oil Cooling Configuration (see glossary on Page 32) must be employed. Also contemplated is silver-plating all copper parts, internal and external.

Also contemplated is that certain conventional “aircraft-quality” mastics or sealants may be employed, such as MIL-SPEC-83430 that is a typical fuel cell sealant that can function in extreme temperatures, even well below (−40) sub-zero (Centigrade) temperatures and up to 182. degrees Celsius.

The benefits of using copper, silver, and stainless steel combined exceed those of mere cast aluminum, as far as efficiency rating goes. Nevertheless, these factors do not diminish the fact that the wholly-cast reservoir 40Z in FIG. 3a also functions to remove grease/oil.

### Operation—First Embodiment—FIGS. 1, 2, 2a, 2b, 3, 3a, and 3b

### Fundamentals: Critical Operational Facts

Applicants re-emphasize operational fundamentals lest some may hold credence to the notion that heat, not cold, causes grease to harden and adhere to a cold metal as prior art reference holds (U.S. Pat. No. 4,024,057).

For generations, cooks and chefs have employed cold qualities to react greases and oils to form solidified grease or viscous (thicker) oils for their removals from foods. But the terms, ‘react,’ ‘reaction,’ and ‘reactor’ demand considerable attention. Cold itself is a bona fide ’reactant,’ causing a ‘reaction.’ ‘Reaction’ connotes ‘change.’ A change takes place when grease is hardened. Baking soda, for example, is a ‘reactant’ that ‘reacts’ with vinegar (organic acetic acid and water) to form salt and gas. Acids (reactants) combine with bases (non-acids that are reactants [such as an egg white]), ‘reacting’ to form salts. This is a common scientific principle. Likewise, the reactants, liquefied grease/oil, ‘react’ with cold agencies (also a reactant) to form solidified grease or thick, viscous oil. This is the context in which applicants employ these terms

The main intention of the applicants' embodiments in operation is to react as much grease and oil as possible with as much cold as can be made available. However, when grease thusly reacts with cold to become hard, it can quickly revert back to a liquid if substantial cold is not made available to that grease.

Several operational misconceptions regarding grease removal with cold metal are hereinafter clarified: Most common ice-cold metals can momentarily harden grease to some limited degree. However, the idea of simply cooling off metal in a freezer in order to functionally remove grease and oil from common cooking stocks under normal kitchen conditions is one of but wishful-thinking. Such a notion is not feasible for mostly hidden scientific reasons detailed here. While cold spoons, for example, can remove a small amount of grease from a bowl of soup, removing grease from near-seething, hot meat stock calls for an altogether different set of scientific principles that go unseen. Understanding operations of this embodiment demands understanding a bit of science.

Even a thin layer of grease attached to cold metal dipped into a hot soup, for instance, is a thermal insulator. This means that cold cannot well penetrate through that insulator to further react more grease. Conversely, it also means that insufficient cold causes an immediate melting of the hardened grease back to its liquid state. In other words, accumulated insular grease, in the operation, must be immediately and continually removed from the metal contacting hot grease or oil. Moreover, the metal must bear a constant, ample and ready-supply of cold applied directly to the metal that removes grease to maintain its attachment to metal. Ice is insufficient for reason of what is called the Igloo Effect and other reasons detailed here.

Normally, while the embodiment featured in FIGS. 2, 2a, 2b, 3, and 3a, is not in use, it is stored in a conventional freezer. While in use and operating, to remove grease and/or oil, the embodiment is swathed over the grease or oil and hot liquids, contacting them. This allows the desired ‘reaction’ to take place (combining reactants, cold with grease or oil). The desired reaction is to harden grease while it is being adhered to cold metal that has augmented cooling aid aside from latent cold initially within the metal (due to refrigeration). Albeit, the ‘desired reaction’ must occur continually, successively, and repetitively. Cold metal alone, without special aid and support cannot accomplish this repeat activity. The metal, otherwise, demands re-cooling. Grease extrication operations must be ‘continual’ (going on in rapid succession, happening over and over again) for normal kitchen use.

Cold metal alone, despite implications of the specification of former art (U.S Pat. No. 4,024,057) cannot function in the rigors demanded in any setting or kitchen proverbially known for ‘heat.’ The sciences affecting cold's battle against heat must be incorporated into grease-extrication via cold metal to effectively combat, not welcome, heat.

### The Embodiment in use: FIGS. 2 and 3 of Primary Topic

Applicants discuss in this Operation section FIGS. 2 and 3, primarily, FIG. 2a simply illustrates a copper, silver, stainless steel version of the embodiment, and FIG. 3a illustrates a single-part cast version. Although all FIGS. 2, 2a, 2b, 3, and 3a operate the same, one from the other, applicants' focus is on FIGS. 2 and 3 because, the embodiment is segmented (modular in essence), and elemental functions are better clarified, therefore better understood.

The first embodiment can be used for domestic/restaurant use, and performs the immediately-following operational functions. Upon demand,.the embodiment is 1.), removed from a conventional freezer where it is normally kept. After its removal, it is 2.), successively skimmed over hot, near-boiling liquid, for example, beef or lamb stock having boiled in a twelve liter, or three gallon stock pot and bearing a pronounced and significant fat/oil layer (approximately 1 CM thick) floating atop. Then, 3.), the embodiment reacts grease/oil causing it to adhere to reservoir 40 as seen in FIGS. 2 and 3, more accurately, to extricating surface 10 that contacts the grease/oil and whose cold qualities harden grease and cause oils to become more viscous.

Moreover, the available cold continuously applied by fluid cryogen 70 to the upper, converse portion of extricating surface 10 (with a minimized surface area), namely, to the internal cooling surface 32 (with an augmented area), causes the grease/oil to remain adhered and hardened onto extricating surface 10 until, 4.), extricating surface 10 is scraped of its insular grease/oil.

Moreover, after a first “dip” or ‘skimming’ and scraping, reservoir 40 then, 5.), retains significant cold or frigid qualities that remain in order to repeat this operation continually, starting from item ‘2.).’

The built-up grease, acting as a potent insulator can grossly impede or prohibit further grease/oil extrication, demands intermiftent scraping. For a duration long enough to remove grease from a few cooking vessels, the embodiment operates successively, without needing re-cooling in a freezer, or without losing its cold, frigid agencies. Frigid agencies are stored in the sub-freezing fluid cryogen 70 (seen in FIG. 3 only) within reservoir 40. Following a grease-scraping, the embodiment is slightly shaken, to recharge it with cold. This causes freshly cold fluid cryogen 70 to impinge on all parts of internal cooling surface 32 to transfer latent cold stored in cryogen 70 to its conversely-positioned extricating surface 10.

The embodiment, designed for continual use, is able to function and operate, removing from common cooking vessels amounts of grease that would normally be yielded in common cooking facilities such as restaurants or cafeterias. That to say, the embodiment operates well beyond what its meager, latent Cold-Metal Effect Principle qualities in metal mass alone have to offer.

### Functioning Elements

In operation, there are two, sometimes three, reactants that react, namely, oil, grease, and cold-frigid qualities (the absence or removal of limited heat). With the embodiment seen in FIGS. 2 and 3, frigid qualities are continuously made readily available at extricating surface 10 to effect reaction. This ready-availability is not offered by prior art's Portable Cold Grease Remover seen in FIG. 1—Prior Art (U.S. Pat. No. 4,024,057).

### Scraping Grease Easily

With the embodiment seen in FIGS. 2 and 3, extricating surface 10 contacts oil or grease in or on a liquid that can be normally hot to near boiling. The desired reaction is that hardened grease and/or a higher viscosity oil is not only formed onto extricating surface 10, but maintained and made available for collection from off (normally by scraping) extricating surface 10. When reservoir 40 is removed from the grease-bearing liquid, hardened grease and/or oil are then, easily scraped from off extricating surface 10. Prior art (FIG. 1—Prior Art—U.S. Pat. No. 4,024,057) cannot be easily scraped due to its multiplicity of projections 15 of a plate 11 that cannot be easily cleaned, but calls for ‘heating’ to remove grease. Albeit, with this first embodiment, the grease-removing operation is repeatable, continually, without having to re-cool reservoir 40 in a freezer (unlike prior art-U.S. Pat. No. 4,024,057), for normal kitchen requirements. Naturally and eventually, reservoir 40 will lose its cold charge, but not without sufficing the thorough removal of grease from several cooking vessels.

FIG. 2b. shows the first embodiment in use. Reservoir 40 does not necessarily have to be dunked or skimmed into a body of liquid, but untreated liquids bearing grease/oil can be poured onto the embodiment (primarily extricating surface 10) to cause grease/oil to adhere. For example, a given, excess amount of butter has been warmed in a sauce-pan. All the melted butter is not necessary for a given recipe (for example). The butter, therefore, poured onto extricating surface 10, immediately hardens upon contact, for its quick packaging and later use.

### Latent Cold in Metal Not Chief

In operation, the Cold-Metal Effect Principle's latent cold within metal would be meager, disallowing an effective first skimming of grease and repeat or continual operations. Cooling-aids or boosters to fight cold are necessary for normal operation.

Reservoir 40 in essence is a reservoir of cold stored latently within fluid cryogen 70. This storehouse of cold is to conduct its cold qualities to extrication surface 10. Heat, in scientific fact, is a virtual enemy in the operation of grease removal with a cold metal. Insufficient cold causes attached grease to quickly begin to slough and melt off metal bearing attached grease. Unlike prior art (U.S. Pat. No. 4,024,057), that welcomes heat and offers very little beyond what that Cold-Metal Effect Principle and latent cold within metal offers, despite appearances, the embodiment as illustrated in FIG. 2 and 3 operates in quite a reverse manner.

Reservoir 40 (FIGS. 2, and 3) operates dependently upon frigid agencies imparted to its internal fluid cryogen 70 and, but quite limitedly, to its initial cold stored within its metal parts and the Cold-Metal Effect Principle. Reservoir 40 would normally have some frigid agencies stored by metal situated within and about reservoir 40 that is metallic, having been stored in a freezer. However, those particular agencies are, for the most part, considered extraneous from operation and of lesser significance. Instead, the important operational factor is the internal, sub-freezing-cold, fluid cryogen 70 impinging on the ultra-augmented area, internal cooling surface 32. Cold is then directed directly to the opposing, converse-situated extricating surface 10.

A Critical Configuration

Another operational consideration is what is actually taking place with the embodiment. The embodiment's configuration of a larger internal cooling surface 32 area to a smaller extricating surface 10 area is a feature absolutely neither offered nor suggested in the reference or specification of prior art (FIG. 1—Prior Art—U.S. Pat. No. 4,024,057). This unique feature (Grease/Oil Cooler Configuration see glossary on Page 32) combines with the unique reservoir 40 in FIGS. 2 and 3, thereby compounding cold.

U.S. Pat. No. 4,024,057 prior art specification calls specifically for, “heat of the grease” to be “conducted,” the ‘heat’ “causing the grease to solidify and adhere.” U.S. Pat. No. 4,024,057 calls for the Grease/Oil Heater Configuration (see glossary on Page 32), the exact opposite of the embodiment presented in this application by applicants.

### Active, Fluid Cold—not Stagnant, Solid Cold

Operationally, a mass of freezing-cold metal by itself can remove grease momentarily before that grease commences melting off the metal, referred to as, “melt-down.” However, with this first embodiment illustrated in FIGS. 2 and 3, a vast, wide, and broad area-mass of internal cooling surface 32 is impinged upon by readily available frigid qualities stored within fluid cryogen 70. Fluid cryogen 70 is sub-freezing, can be sub-zero, and colder than mere cold water called for by the utilization of ice in prior art (U.S Pat. No. 4,024,057—FIG. 1—Prior Art).

In operation, fluid cryogen 70 slushes about within reservoir 40 seen in FIGS. 2 and 3, fluidly providing continuous frigid qualities that are not easily abated, for continual operation of the embodiment. Fluid cryogen 70, generally, is an antifreeze agent in this embodiment, applicants contemplate, being a conventional, non-toxic propylene glycol combined with distilled water that freely moves about at sub-freezing temperatures, though other conventional coolants may be employed. Use of a solid coolant such as ice in this application would be a serious drawback for reasons described herein. Cryogen 70 occupies only about 750% of space in reservoir 40.

### Potential Industrial Operations

Applicants also contemplate: In operational function, in the case of industrial-type, non-domestic embodiments (not illustrated): Reservoir 40 seen in FIGS. 2 and 3 would likely be too massively large and heavy to practically manipulate and cool in a freezer and would demand conventional lifting modes. Fluid cryogen 70 would be pumped into and out from (re-circulated upon demand) the industrialized-type embodiment to maintain a cold temperature for continual usage. The cold qualities of fluid cryogen 70 are spent within the embodiment, then “recharged,” or re-refrigerated, external of the embodiment, to sub-freezing temperatures prior to re-entering the embodiment (not illustrated). The contemplated embodiment (not illustrated) would appear as what is viewed in FIG. 2 and 3, only massive and without a handle. Due to bulk, the embodiment could be lifted by any conventional lifting mode such as hoist, hydraulic motor, electrically, or other conventional mode.

Another industrial-type embodiment contemplated, has an internal cooling element such as the evaporator portion of a freezer internal to reservoir 40.

These industrial embodiments would yet be considered for continual use (not continuous), but would be operated similarly to the embodiment in FIGS. 2, 2a, 2b, 3, and 3a for domestic, restaurant, or school cafeteria kitchen use.

### Three Objectives

In operation, the embodiment has a primary operating function to employ as much of the cold, frigid, invisible reactant as is permitted by design to acquire as much grease oil as is allowed by design. More cold yields more grease. Reactant cold is to be diffused into grease and or oil, creating the desired reaction.

The operational reaction is basically of three parts: Liquefied grease must be expelled of sufficient heat. A heat-for-cold exchange must take place with the reactants. Secondly, grease or oil has to solidify, harden, or thicken, adhering onto extricating surface 10. And thirdly; reacted, hardened grease must remain attached onto extricating surface 10 long enough for scraping and further re-applications/skimmings into any remaining grease found in normal cooking operations. Therefore, the primary overall operational objective is to quickly, efficiently, and thoroughly attach liquefied grease while hardening it, then, easily remove unwanted grease/oil from extricating surface 10, this operational process being continual/repeatable.

Another unseen Operational Technicality

The operator of the embodiment must be well apprised: Hardened grease and oil are excellent insulators of cold and these should be periodically scraped from extricating surface 10 during larger grease-removal operations for efficiency and better success. At a certain point during the grease collecting operational procedure, hardened, attached grease impedes cold from penetrating through it to effect further reaction. Operation halts because of insular grease build-up on extricating surface 10. The point of grease freezing is called the ‘eutectic point,’ ‘eutectic,’ originating from Greek, originally meaning, ‘to melt.’ Today it means, easily fused, or ‘fusing at the lowest possible temperature.’

To clarify, if cold is blocked from penetrating through a significant grease insulator barrier, desired reaction actually ceases. While reacting grease with the first embodiment, a normal build-up of grease/oil causes a point at which cold, being dissipated from extricating surface 10, is blocked from reacting additional grease. Albeit the problem is not due to an insufficient amount of cold charge remaining within reservoir 40.

At that point, heat from hot liquid maintains a steady melting of the hardened grease's surface while, at the same time, grease is steadily maintained in an ongoing hardening due to ample amounts of cold within reservoir 40 (or wholly-cast reservoir 40Z). In other words, a sort of war or battle of temperatures enrages stabilizing at a temperature saturation point. A stalemate occurs whereby the eutectic point causes no further gathering of grease, only a maintaining of grease whose thickness is highly dependent upon the cold qualities available within reservoir 40 and other factors stated here. Figuratively, its as though two opposing armies are nose-to-nose, each side having an equal amount of casualties that continue on, unless a barrier (insular grease) is removed altogether. Therefore, intermittent scraping of the grease barrier is necessary in order to effectively allow the cold qualities to continue to reach out to the grease/oil to conquer and capture it, in essence, during operation.

### Speed-Scraping of Grease/Oil

The first embodiment seen in FIGS. 2, 2a, 2b, 3, and 3a, unlike prior art (FIG. 1—Prior Art—U.S. Pat. No. 4,024,057), takes the insular grease factor into serious consideration, allowing for an immediate, instant, and quick removal of the insulating grease. Extricating surface 10 is generally non-porous and can be easily scraped. Prior art (U.S. Pat. No. 4,024,057) could not be easily scraped (due to surface augmentations and it could not be turned upside-down), and specified heating to remove what limited grease it could extricate.

Turning the first embodiment (seen in FIGS. 2, and 3 [contemplated variants in FIGS. 2a and 3a]) upside down during ‘one-fell-swoop’ speed-scraping facilitates the operation (spatula 15 for scraping seen in FIG. 3b). The fact that speed is of the operational essence is because, time lost spent scraping means a loss of cold demanded for further operation and further grease-extricating endeavors. Prior art (U.S. Pat. No. 4,024,057) could not be turned upside down while containing added cooling contents as they would be dumped.

Another Unseen Factor: the Plate with a Meter of Ice . . . An Operational Prohibition; no Igloos allowed

Unlike prior art seen in FIG. 1—Prior Art (U.S. Pat. No. 4,024,057), the first embodiment seen in FIGS. 2 and 3 (and contemplated variants in FIGS. 2a and 3a) does not operate or function with ice being an integral cooling source. Ice is extremely limited insofar as the amount of available cold qualities it can afford, expend, or impart to metal in the application of cooling hot grease with a given cold metal.

To provide a revealing example, the reader is asked to imagine the following: A simple aluminum plate approximately 15 CM wide (6 inches), and having a peripheral wall on its upper surface. This plate is stored in a conventional deep-freezer. A mass of ice one meter high (approximately three feet) is firmly frozen and fixed to the top portion of the plate that is smooth and flat on top (excepting its peripheral wall). The reader may now envision that the plate's lower surface area is maximized with numerous protrusions, serrations, and knobs (a multiplicity of projections) to absorb as much heat as is possible, somewhat similar to prior art (U.S. Pat. No. 4,024,057).

The applied configuration (Grease/Oil Heater Configuration [see glossary on Page 32]), therefore, consists of a plate whose upper side is minimized in surface area, in relation to it's bottom side that is maximized. The plate is removed from the freezer and its lower surface is manipulated into a large pot containing near-boiling soup with grease. What happens next is unexpected and unseen. Numerous experiments have proven the effects herein noted.

The augmented lower area receives and conducts masses of heat upwards, some grease is quickly adhered to the plate due to the Cold Metal Effect and latent cold within metal. But the grease soon incurs ‘melt-down.’ Due to the massive lower surface area, ice quickly commences melting above the plate as the plate rapidly warms, taking on heat. Critically, the plate's upper surface, therefore, can get no colder than the rapidly warming water trapped in between the ice-mass and plate.

As ice melts, the ice's volume is displaced with ambient air. And the ice face that once met metal has melted, and a concave ice form develops. This condition is called the ‘igloo effect’ and is as though there were an igloo, between ice and metal. The deceptive near-meter of ice remains. The rapidly-warming water and air, therefore, trapped immediately between rapidly warming metal and ice may be analogically or Figuratively compared to an invisible Eskimo enjoying a warm igloo fire atop the metal plate. The warmed water and air, therefore, serve as an insular barrier to the ice, absolutely blocking cold from the mass of ice to effectively cool the plate while the invisible Eskimo gets warmer.

Moreover, nothing exists about the igloo to effectively combat masses of rising heat that is immensely disproportionate in force and energy. This means that any additional ice, even a kilometer high, and situated above that insular barrier of water/air igloo would offer near-impotent cooling agencies towards the desired reaction. Although this additional unseen problem is systemic with prior art's ‘Portable Cold Grease Remover,’ (U.S. Pat. No. 4,024,057) seen in FIG. 1—Prior Art, the embodiment seen in FIGS. 2, 2a, 2b, 3, and 3a completely alleviates this problem, and other unseen difficulties as regards the actual operation of removing grease and/or oil with cold frigid agencies and metal.

### Vacuum

Though formation of a vacuum within the embodiment is not necessary, a void, from where ambient air has been evacuated, disallows heat passage (traveling through that void). Therefore, evacuation of air prior to sealing is an added aid towards keeping cryogen 70 and the overall embodiment cold. A conventional vacuum pump (not shown) is used to achieve the evacuation via injector hole 72.

### Drawings—Reference Numerals—Second Embodiment

10T external grease/oil-contacting/extricating surface
10aT special-use sleeve
18T grease/oil scraper blade
18aT pressure nozzle
18bT vacuum nozzle
16T grease/oil scraper trough
20T hollow axle
20aT axle flange
20bT axle retainer nut/flange
20dT plumbing connect
21T discharge ports
22T suction ports
24T shaft hole
25T hollow spindle
26T spindle/axle trunnion
26aT trunnion pinhole
26bT spindle bolting flange
27T rotational force ring
28T trunnion cross member
32T internal cooling surface
40T reservoir body
54T cooling fins
55T evaporator coil
69T bifacial/multi-functioning interior/exterior element/wall
80aT reservoir shell wall
80bT reservoir shell wall
80eT inspection hatch
82T bleed valve
82aT valve
83T wall hole
88T wall end flange
91T bearing recess
91aT conventional sealed bearing
100T liquid levels or spray streams
101T sprayer

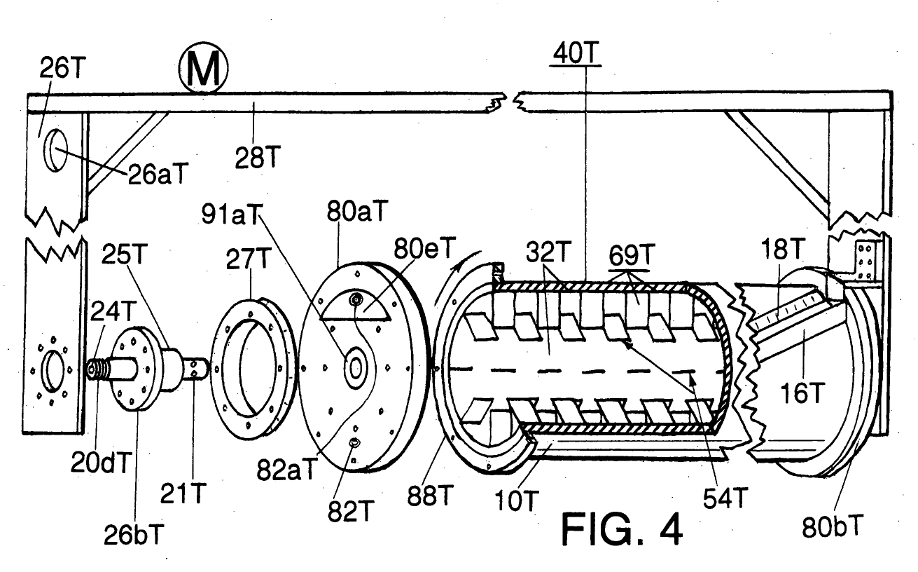

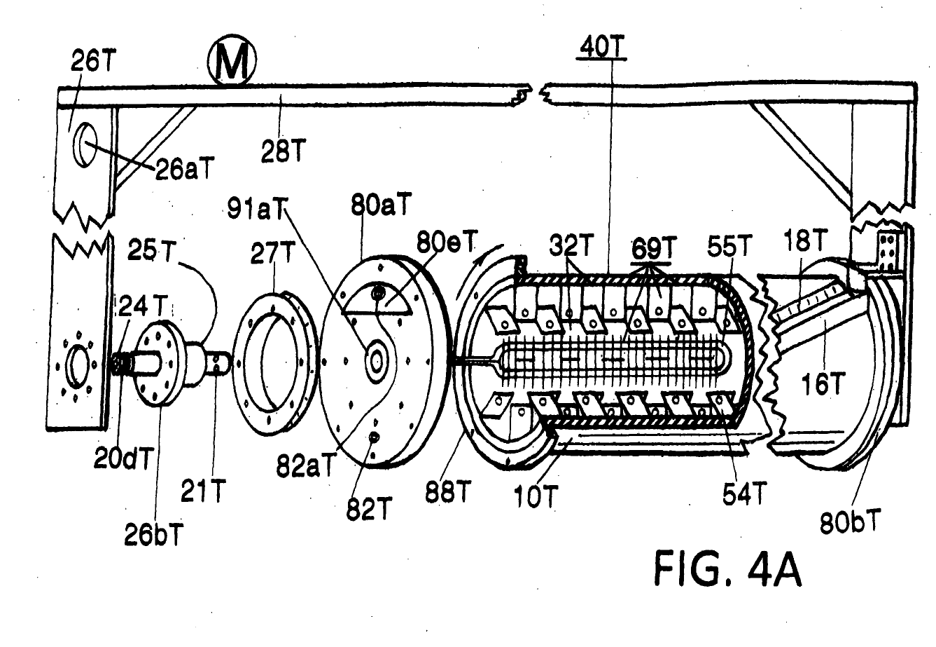

### Detailed Description—Second Embodiment—FIGS. 4, 4a, 5, 5a, 5b, 6, 7, 7b, 8, 8a, 9, and 9a

### Continuous-use Versus Continual-use: Metamorphosed Part Shapes, Principles/Concepts Unchanged

To emphasize clarity on potentially confusing words, the first embodiment in this application is a ‘continual-use’ embodiment. The second embodiment is a ‘continuous-use’ embodiment, yet the embodied principles and concepts of all continual or continuous-use embodiments are identical, as the reader shall see.

May the reader also see that various parts' features, shapes, materials, and sizes of the first embodiment have metamorphosed in the second and other continuous-use embodiments. Meanwhile, those “morphed” parts and features perform the same basic operational function and maintain a single, integral configuration unseen in prior art (U.S. Pat. No. 4,024,057), specifically, the Grease/Oil Cooler Configuration (see glossary on Page 32). The reason for parts and features being ‘morphed’ is that parts must conform to specific functional and operational grease/oil extrication demands while yet employing embodied principles and concepts of the first embodiment.

Circumstantially, ‘continual’ grease/oil extrication is of critical demand. In other cases, ‘continuous’ oil/grease extrication is necessary, when a ‘continual-type’ embodiment would not be suitable. That to say, the principles and concepts are truly what is demanded in both cases. A domestic kitchen's pots of stews and gravies, for instance, demand ‘continual’ grease-removal. Meanwhile, a meat-processing plant that must remove fat and oil from seethed meats has no use for a small, hand-held embodiment designed for ‘continual-use.’ Such a plant may process tons of fat and grease per day, demanding a ‘continuous-use’ embodiment of those uniquely-applied ‘principles and concepts.’ At the same time, a crude oil spill in a harbor due to colliding ships also demands a ‘continuous-use’ embodiment to extricate the crude oil. In such cases, needed are those exact successful ‘principles and concepts’ embodied in a simple, domestic-type, continual-use embodiment.

Therefore, when demand changes, the embodiments expressed in this application conform to the meet the specific demand or application. Therefore, parts' shapes and features must be ‘morphed’ accordingly from embodiment to embodiment while maintaining the same principles and concepts for each.

Applicants contemplate that features and parts illustrated in all Figs of the second embodiment are of predetermined sizes, shapes, and materials, and whose variables or variants depend primarily on operational applications. The reader shall better see this fact as she or he further progresses here.

### Back-up, Primary, or Individual-use

Because this embodiment can be employed at sea to extricate oil slicks, critical instant ‘back-up’ [auxiliary] and/or conversion thereto is commonly (commercially) expected to be an integral feature as is seen with aircraft systems. In this case, not only are we discussing an embodiment that is sea-going, but one that functions about hydrocarbons (crude oil).

Therefore, easily-interchangeable back-up modification choices are desirable and offered with all continuous-use embodiments. Whether for use on land or at sea, the continuous-use embodiments, by way of a single or other simple part changes, are quickly modified for back-up or primary use.

Therefore, the second embodiment in FIGS. 4 and 4a can be quickly fitted, for example, for either exterior refrigeration (exterior of embodiment) or interior refrigeration (interior of embodiment). Moreover, it can be changed from axle to spindle rotation, and the modes of conveying power (such as V-belt, chain/sprocket, or gear) can also be changed. These are further discussed hereinafter.

Moreover, whether the embodiment is interiorly or exteriorly refrigerated, or rated via axle or spindle, any of these can be employed primarily or as back-up/auxiliary while either/or extricates grease/oil: Either/or can be used individually, and without back-up. Moreover, other back-up/auxiliary features are clarified herein.

### Parts'/Features' Metamorphoses

First focusing on FIGS. 4 and 4a, illustrated is the second embodiment contemplated for continuous-use (not continual use). Please note that the capital letter “T” after part numbers indicates a second-embodiment feature or part (excepting in the case with fluid cryogen 70 employed in the first embodiment). Readers should be ever-apprised that the term, ‘continuous,’ here connotes, denotes, and actually means, without interruption, or perpetual.

For reason of continuous grease and oil extrication, reservoir body 40T in FIGS. 4 and 4a was ‘morphed’ from reservoir 40 in FIGS. 2 and 3 and cast reservoir 40Z in FIG. 3a (first embodiment-for continual-use). Note that applicants have slightly changed the name of the morphed part or feature in the second embodiment, for ease of understanding.

Reservoir body 40T (FIGS. 4 and 4a) is as a cylindrical drum shape that rotates on its longitudinal axis. We contemplate that other shapes may be employed besides a cylinder, such as hexagonal, box, ball, or others.

### One Single Part

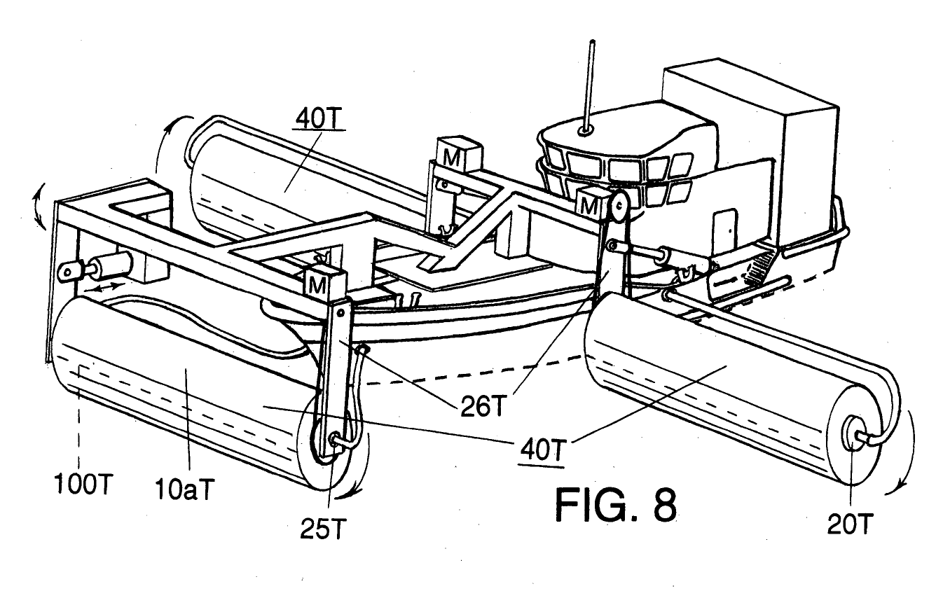

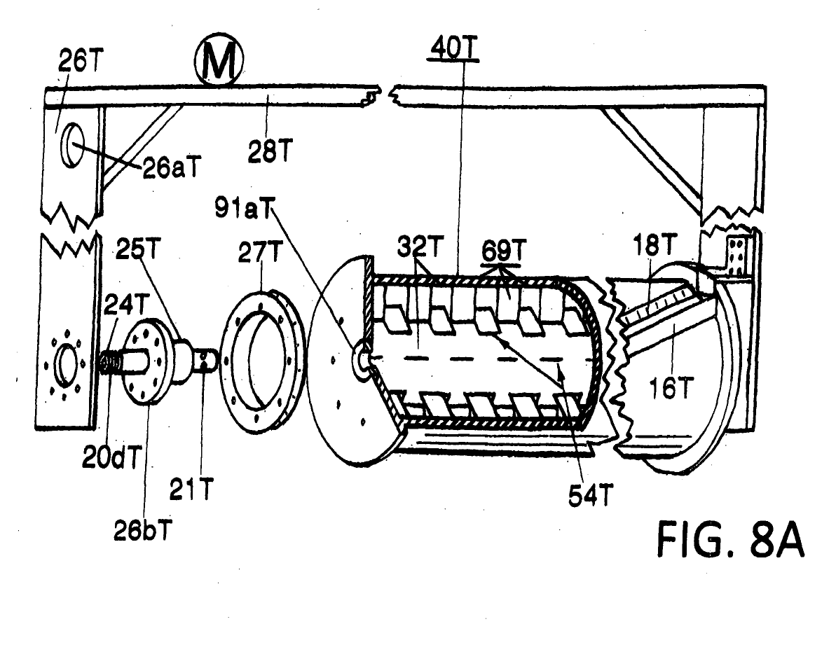

Referring to FIG. 8a, the viewer can see that the element/wall 69T and shell wall 80aT and shell wall 80bT are cast together comprising 40T. As the first embodiment can be wholly cast of one main part as seen in FIG. 3a (reservoir 40Z), the second embodiment's main part is reservoir body 40T and can also be wholly cast as one part: Albeit, reservoir body 40T, as illustrated, calls for movement (in this case, rotational), for continuous usage. Such rotation simulates a person manually skimming the first embodiment of grease and oil. Applicants contemplate that a variety of movements can create a continuous-use embodiment, discussed later.

The Frying Pan: Two Sides, each Side having its own Functions

FIGS. 4 and 4a illustrate a bifacial/multi-functioning interior/exterior element/wall 69T that is a part comprised of two sides that are contiguous to each other. More clearly, the two sides are conversely and back-to-back-positioned, and reverse-situated, each side having its own functions as specified here. Internally situated to reservoir body 40T, one of the two mentioned sides is internal cooling surface 32T (FIGS. 4 and 4a). The converse side of cooling surface 32T is positioned exteriorly of reservoir body 40T and is named, external grease/oil-contacting/extricating surface 10T seen in FIGS. 4 and 4a (extricating surface 10T may be seen on other Figs). Combined, internal cooling surface 32T and external grease/oil-contacting/extricating surface 10T serve as a single wall of reservoir body 40T. Together, cooling surface 32T and extricating surface 10T, form bifacial/multi-functioning interior/exterior element/wall 69T [herein, element/wall 69T]. Individually, each one (extricating surface 10T and cooling surface 32T) has its own functions, though these function together, similar to a frying pan. A frying pan has two (upper and lower) surfaces that are contiguous, back-to-back, reverse-situated, each side having its own functions.

A primary objective of internal cooling surface 32T (FIGS. 4, and 4a) is to, in an augmentable fashion, accumulate as much cold frigid agencies as is possible, then transfer that cold to its Siamese-joined, back-to-back, extricating surface 10T. Contrary to prior art (U.S. Pat. No. 4,024,057) that is designed to, in augmentable fashion, collect as much destructive heat as is made possible, the second embodiment of this specification, as in all embodiments, is designed to combat and dispel as much heat as can be made possible. Heat is destructive to the grease and oil extrication process, applicants firmly hold.

Internal cooling surface 32T (FIGS. 4, 4a) therefore, is greater in surface area than its conversely positioned external grease/oil-contacting/extricating surface 10T. Extricating surface 10T contacts, reacts, and accumulates grease and oil in or on liquids. Therefore, extricating surface 10T also serves to maintain adherence of that grease/oil onto itself (to be easily scraped off), and must be constructed of materials that can withstand the rigors of oil/grease and heat, and be able to conduct cold temperatures while dispelling heat. Extricating surface 10T is always smaller in surface area, compared with, or in proportional relation to, internal cooling surface 32T. This particular configuration of note called, Grease/Oil Cooling Configuration (see glossary on Page 32), is an antithesis of prior art (U.S. Pat. No. 4,025,057) that employs Grease/Oil Heater Configuration (see glossary on Page 32).

Element/wall 69T seen in FIGS. 4 and 4a (and other Figs), comprising internal cooling surface 32T, and extricating surface 10T, have been shape-modified, and are metamorphosed variants of the first embodiment's wall 69 (FIGS. 2 and 3). Though basic operating principles envisaged in the first embodiment are seen invariably unchanged in the second embodiment, internal cooling surface 32T and extricating surface 10T, namely, element/wall 69T are of a cylindrical shape seen in all Figs that show the second embodiment. The first embodiment's FIGS. 2 and 3 reflect wall 69 as being flat, not cylindrical shaped.

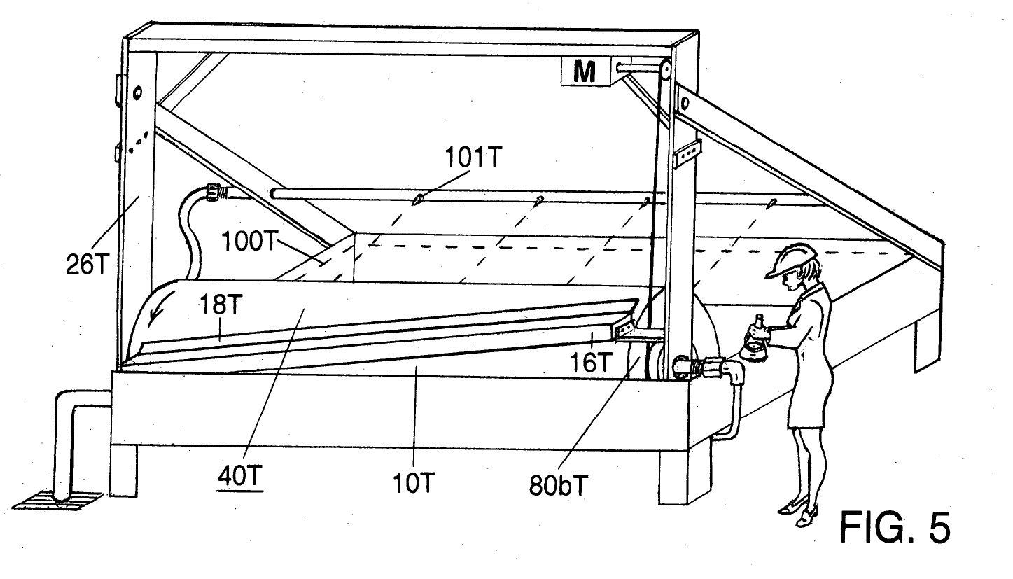

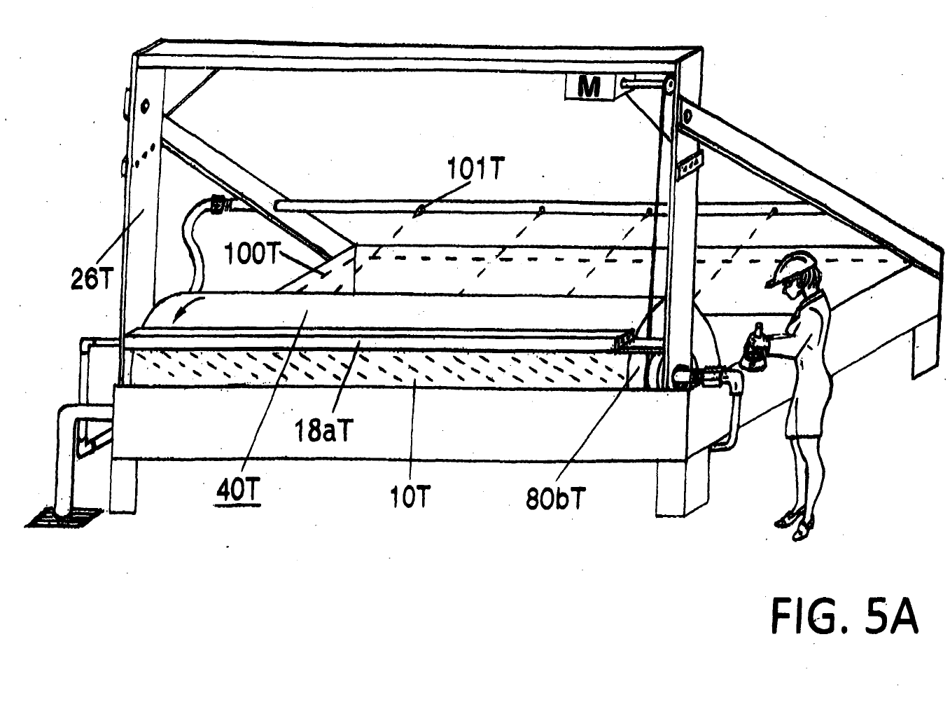

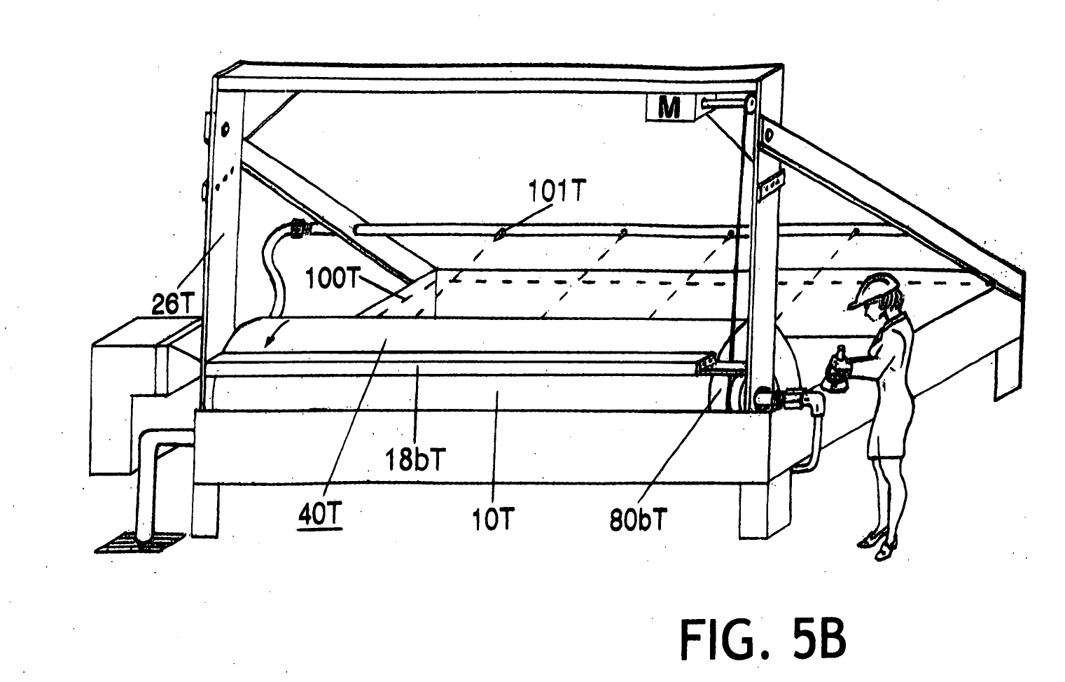

Other features from FIGS. 2 and 3 are ‘morphed.’ For example, reservoir shell wall 80 of FIGS. 2 and 3 is cylindrical. In the second embodiment, reservoir shell wall 80aT (FIGS. 4 and 4a) and reservoir shell wall 80bT (FIG. 5) take on generally flat shapes to form the ends of the cylindrical drum-shape that is reservoir body 40T. Moreover, where the first embodiment is reflected as a vertical cylinder, and is used accordingly, the second embodiment is comprised of a horizontal cylinder, and used horizontally. The second embodiment can be employed vertically, however, but more grease/oil extrication is more likely to occur if the embodiment were horizontal as seen in FIGS. 5 and 8.

### Assemblages, Desirable Materials, and More

To be clear, reservoir body 40T (in its general entirety) can be wholly cast as one single part besides a few rotational-related parts detailed hereinafter. Albeit, for reason of better conveying elements, functions potentials, and variations of the embodiment, applicants draw focus away from a wholly cast version. They attempt to apprise the reader of a basic element-by-element, part-by-part construction of elements and parts as though they are modular, in a sense. This format is likely to be better grasped or comprehended.

Choices of materials vary depending on immediate budget, application, amounts and kinds of grease/oil to be extricated, and other various factors such as power factors and possible weight constraints. Optimally, there are certain metals that conduct cold far befter than others. However, to fabricate the bulk of the entire embodiment of hundreds of pounds of near-pure silver with stainless steel end, shell walls seems far-fetched, for example. And although this combination would be quite desirable for efficiency, applicants try to be reasonable, and incorporate benefits of one metal or material over another, for example, while trying to focus on fabrication of a functional embodiment of lower, reasonable-cost, though with amply effective, materials.

In general, reservoir body 40T, in seen in FIGS. 5 and 8 (and other Figs) is generally comprised of element/wall 69T, shell wall 80aT, and shell wall 80bT. Approximate size of reservoir body 40T would certainly depend on operational requirement. For this explanation, reservoir body 40T is approximately three (3.048) meters (approximately 10 feet) long and whose inside diameter is approximately 1 meters (approximately 3 feet), we contemplate.

### Augmenting Surface Area and Construction

We contemplate that: Internal cooling surface 32T, seen exposed in FIGS. 4 and 4a, serve as an inner cylindrical wall of element/wall 69T. Although applicants contemplate that internal cooling surface 32T be modestly constructed of cast aluminum, any other contemplated material demands an ability to conduct thermal temperatures, such as copper, silver, or other such metals or amalgams. Materials, sizes, and shapes can vary, applicants further contemplate. Internal cooling surface 32T comprises a plurality of cooling fins 54T seen in FIGS. 4 and 4a. Contemplated is that various protrusions and voids that can be fins, pins, cones, recesses such as valleys, voids, and corrugations, or other various shapes commonly employed to increase or maximize surface area for cooling, are suitable.

Moreover, consideration of flow of fluid cryogen 70 about reservoir body 40T is paramount for maximum cooling transfer (discussed later). A long, single ribbon fin can also be used to enhance and augment surface area of internal cooling surface 32T to cause its surface area to exceed that of its converse-positioned, back-to-back extricating surface 10T. For the purpose of increasing area, in this embodiment, applicants illustrate a multiplicity or plurality of cooling fins 54T (FIGS. 4 and 4a) positioned so as to amplify cooling capacity. Pins also function excellently (not illustrated in second embodiment's Figs).

Applicants contemplate that cast aluminum may be the easiest and quickest of materials for construction of element/wall 69T (FIGS. 4 and 4a). Material costs and weight factors are always of concern. While silver and copper are superior metals over aluminum for thermal conductivity rates, these, or other good conductors of cold, can be employed, we contemplate (discussed further herein). Like the above-mentioned frying pan's two sides, internal cooling surface 32T (including cooling fins 54T) and extricating surface 10T are not individual, separate, or separable parts, but are integral features together, forming element/wall 69T: Element/wall 69T can be a single cast part (including fins 54T as seen in FIGS. 4 and 4a), however, other contemplations are mentioned hereinafter.

We also contemplate that: Cooling fins 54T (best seen in FIGS. 4 and 4a) and extricating surface 10T be made of copper while incorporating cast aluminum. Copper parts can be plated with silver, though not necessary. Use of copper and/or silver would aid in efficiency. Applicants further contemplate that during the casting process, while element/wall 69T is being cast of aluminum; the molten aluminum can be cast internal of a cylindrical copper sheathe or jacket to form a copper extricating surface 10T whose immediate back would be of aluminum. When cooled, the aluminum would hold or bind the copper jacket securely (thereby forming extricating surface 10T).

Albeit, while the aluminum is yet molten, the bases of cooling fins 54T made of copper, silver-plated copper, or other metals or thermal transmitting materials, can be attached into the molten aluminum whereby the molten aluminum would encapsulate individual cooling fins 54T at their bases. Thereby-secured fins 54T with their surrounding area would form internal cooling surface 32T. This type of immediate contact of the bases of cooling fins 54T insures transmission of cold qualities from fins 54T to extricating surface 10T. Other discussions of copper-use come later. Albeit, for general purposes, a single-cast, all-aluminum element/wall 69T is functionally satisfactory. Also contemplated is element/wall 69T be made of copper/silver and discussed hereinafter.

### Bifacial/Multi-Functioning Interior/Exterior Element/Wall 69T

Contemplated is that casting element/wall 69T as one single part could be more feasible mostly for consideration of construction costs/labor only. This contemplation is omitting consideration of overall operational cost in the ‘long-run.’ Welding a plurality of cooling fins 54T, for example onto the interior of aluminum tubing is labor intensive. Riveting fins 54T is also not feasible because, even a minute amount of corrosion build-up at the bases and under fins 54T (where bases meet remainder of cooling surface 32T) would markedly impede transfer of cool qualities, therefore, also impeding performance and cooling abilities. And operational costs would be higher. If the portion of such a surface-area-enhancing protrusion (such as cooling fins 54T) that is to contact cooling surface 32T is not wholly attached at its base (as attachment is provided by aforementioned casting), an efficiency loss would occur. The entire base is to contact cooling surface 32T. Hence, pins may be a better option over fins for their ease of attachment.

We contemplate yet another method of construction whereby aluminum tubing would form the basic cylinder shape of element/wall 69T. Surface-area-enhancing protrusions such as cooling fins 54T, if of thin enough (though weldable) material, can be welded to the inner wall of the tubing to form internal cooling surface 32T. ‘Thin enough,’ for example means: If the bases of cooling fins 54T that are to contact cooling surface 32T are too wide or broad, individually, whereby the entire fin base cannot be joined by molten metal (not merely the fin bases' perimeters), efficiency would be grossly impeded. Moreover, when employing aluminum tubing the welding work-space-confines would be limiting unless the entire cylinder were cut or divided in two (longitudinally), when fins 54T could easily be welded. The two tubing halves would then be welded together. This method seems less costly than casting. However, casting, for reason of manufacture expense, seems a better approach when highly reactive greases and oils are to be extricated,.though, a conventional thermal-conductive epoxy can be viable for attaching cooling fins 54T or protrusion attachment.

We also contemplate use of copper tube to form bifacial/multi-functioning interior/exterior element/wall 69T. For efficiency, copper is a more suitable material than cast aluminum. A complication applicants encountered was that soldered cooling fins 54T would loose significant efficiency unless attached by way of a predominately silver solder. Therefore, silver solder can attach cooling fins 54T to element/wall 69T of copper construction.

However, with this copper tube configuration, overall weight and load-bearing stress points become a significant consideration. The copper tube would likely have to be split, longitudinally, in order to allow for silver soldering, the two halves then re-joined thereafter. Use of copper and silver is desirable over cast aluminum or aluminum tubing, for reason of efficiency, however, the actual application may not demand copper, where aluminum would be quite suitable. All copper parts can be silver plated or coated with silver solder. Moreover, we contemplate that fins 54T, pins, cones, rods, or other surface area augmentations can be made, exclusively, of silver. Expense of this variant is a significant consideration, but use of an all-silver or silver/copper element/wall 69T with reservoir shell wall 80aT (FIG. 4) and reservoir shell wall 80bT (FIG. 5) made of stainless steel (having poor thermal conductivity) would be desirable as regards efficiency.

Moreover, although extricating surface 10T is generally non-porous and cylindrical in shape, shape is inconsequential in the sense that reservoir body 40T could otherwise be cylindrically hexagonal, octagonal, or other shapes, including, ball, box, trapezoidal, star, or any other. However, the Grease/Oil Cooler Configuration (see glossary on Page 32) must always be employed regardless of shape, and scraping that shape of grease must also be a consideration, we contemplate. We also contemplate that a main frame of reservoir body 40T be constructed of plastics, and metal, cold-conducting parts such as elements of element/wall 69T be glued/or adhered with epoxies or other conventional adhesives.

### Ends of Cylindrically Shaped Element/Wall 69T

When shell wall 80aT, shell wall 80bT, and element/wall 69T are incorporated together, they, generally, comprise reservoir body 40T (FIGS. 5 and 8). Note that wall 80aT is an exact copy of wall 80bT (only positioning on the embodiment itself being different).

We contemplate that shell wall 80aT and shell wall 80bT best be constructed of a material with poor thermal conductivity lest cold easily escapes out from reservoir body 40T therefrom. Standard steel is a viable option, however, there is a ‘dissimilar-metals’ problem with aluminum and steel used together. Otherwise, stainless steel plates approximately 6 centimeters thick (about 2.5 inches) vertically positioned at the two ends of element/wall 69T would be desirable. Aluminum would be inferior to stainless steel, especially while an aluminum element/wall 69T (inferior to copper) is being used. Stainless steel is desirable for wall 80aT and wall 80bT and is illustrated (FIGS. 4 and 5). Other materials for wall 80aT and wall 80bT are suitable, including plastics. Materials having low thermal conductivity ratings for wall 80aT and wall 80bT are desirable.

Shell wall 80aT and shell wall 80bT are constructed of ‘stainless,’ therefore, each part wall 80aT and wall 80bT is bolt-fastened onto wall end flange 88T seen in FIGS. 4 and 4a (one per end of element/wall 69T). Flange 88T is either welded to the two cylindrical ends of element/wall 69T or cast together with element/wall 69T (conventional bolts not illustrated). Otherwise, a preformed length of pipe with flanges on each end are conventional and can be used instead of constructing end flange 88T with element/wall 69T from scratch. For access and maintenance, we contemplate an access or an inspection hatch 80eT (FIGS. 4) positioned on shell wall 80aT and one on wall 80bT.

If element/wall 69T is not aluminum, but, for example, constructed of copper, attaching of flange 88T (whatever its material [including plastic]) would have to be according to conventional methods, practices, and procedures for joining metals or other materials as further described.

Joining stainless steel ends (wall 80aT and wall 80bT) to a relatively thin-wall copper tube (element/wall 69T) requires care. End flange 88T of copper or other compatible metal (such as standard steel or stainless steel) can be silver/tin-soldered onto each of the two ends of element/wall 69T to receive wall 80aT and wall 80bT that bear extreme weight and stresses. While all stainless steels are fairly easily soldered, titanium-stabilized grades can be problematic. Another precaution is that all solders have greatly inferior corrosion resistance and strength to the base metal. When a copper element/wall 69T is to be constructed, shell wall 80aT and wall 80bT can best be constructed of Type 304 stainless steel (for its poor thermal conductivity where less conductivity is preferred), then bolted to end flange 88T made of copper or solderable steel. Conventional adhesives can also be employed to join end flange 88T. Other methods of assembling a copper element/wall 69T to stainless steel shall be herein discussed.

Albeit, another contemplation or consideration is that common steel's weldability, weld dependability, strength, poor conductibility, and low-cost characteristics make plain steel a desirable candidate for wall 80aT and wall 80bT with either a copper or aluminum element/wall 69T. Wall 80aT and wall 80bT undergo severe stress loads. Moreover, that a rather large reservoir body 40T must not only rotate, but must be able to sustain sea-going turbulences and weight shifts while filled with fluid cryogen 70, demands careful attention.

Insofar as an aluminum reservoir body 40T goes (if not wholly cast as one part): Welding wall 80aT and wall 80bT (of aluminum) directly to element/wall 69T is a contemplated option (eliminating wall end flange 88T) when higher stresses and extreme weight shifts are not to be encountered [as on rough seas]. In the case of an all-aluminum cast reservoir body 40T (not illustrated), shell wall 80aT and wall 80bT are ready-incorporated, we contemplate, only demanding slight machining for bearing and drive accommodations explained later.

When reservoir body 40T is wholly and singly cast as one, single part, individual parts are thereby eliminated, namely, shell wall 80aT, wall 80bT, and element/wall 69T as individual, detached parts that demand contiguous joining. Instead, these three become one unit bearing the elemental features, though as one, contiguous part. The entire cast variation would closely resemble (visually) illustrations of 40T. Therefore, it is not illustrated.

Accommodating either Spindle or Axle Rotation

Also contemplated is that reservoir body 40T, via shell wall 80aT and wall 80bT, can accommodate either spindle or axle for rotation of reservoir body 40T. Either of these can be employed for back-up. Spindle and axle shall both be further discussed hereinafter.

When aluminum is employed as element/wall 69T and stainless steel for reservoir shell wall 80aT and reservoir shell wall 80bT, as illustrated, wall 80aT and wall 80bT are basically thick plates of stainless steel: Wall 80aT and wall 80bT have different designation numerals for reason of ease of the reader identifying their critical locations in relation to other parts, while the two are the same duplicated part.

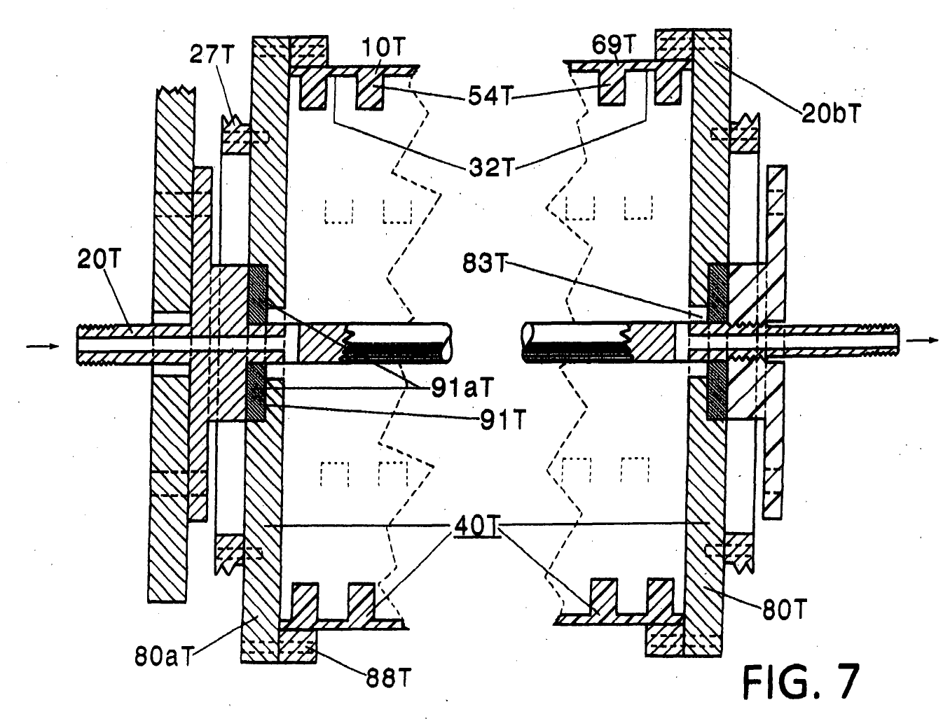

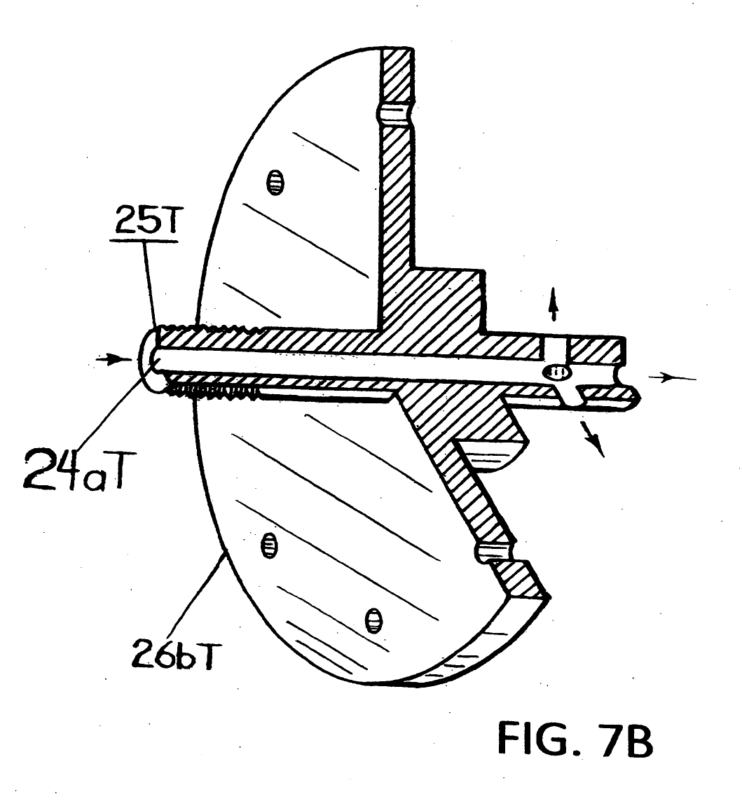

Machined of one solid piece of stainless steel is a spindle bolting flange 26bT (FIG. 4 and 4a) discussed later. A conventional bearing recess 91T seen in FIG. 7 (one each for each [of the two] shell wall 80aT and shell wall 80bT) is machined into wall 80aT and wall 80bT and centered to accommodate hollow spindle 25T or hollow axle 20T. A wall hole 83T (FIG. 7) is also machined for each shell wall 80aT and shell wall 80bT: One hole per each wall. The diameter of wall hole 83T is slightly larger (about one millimeter) than the outside diameter of either axle 20T or spindle 25T where the unthreaded end is accommodated (FIG. 7).

A conventional sealed bearing 91aT (FIGS. 4 and 7) is typically a marine-type or other industrial bearing that is waterproof and disallowing liquid from traveling about the bearing casing, or through the bearing assembly.

Bearing recess 91T (FIG. 7) press-accommodates conventional sealed bearing 91aT: When conventional bearing 91aT is pressed, its recess 91T is swathed with MIL-SPEC-83430 (not shown) that is a common, conventional, and typical fuel cell sealanvadhesive that can function in extreme temperatures, even well below (−40) sub-zero (Centigrade) temperatures and up to 182. degrees Celsius. Other such conventional sealant/adhesives whose adhesion/sealing properties are desirable are sufficient. Bearing recess 91T of bearing 91aT and wall hole 83T that receives hollow spindle 25T or hollow axle 20T should also receive a swathe of conventional sealant.

Characteristic Reactor Configuration and keeping it Cool

The inner portion (inside of reservoir body 40T) of element/wall 69T more accurately, internal cooling surface 32T (FIGS. 4 and 4a), has an augmented or larger surface area in relation to external grease/oil-contacting/extricating surface 10T that is positioned outside of reservoir body 40T. The basic, though notable and significant, configuration of reservoir body 40T is consistent in all embodiments, is not present within prior art (U.S. Pat. No. 4,024,057), and is referred to as Grease/Oil Cooler Configuration (see glossary on Page 32).

Fluid cryogen 70 (seen only in FIG. 3), as applies to the first embodiment also applies to this second embodiment, and is most typically comprised of a non-toxic antifreeze or other chemical compound such as an antifreeze mixed with H²O. Liquid nitrogen or other conventional coolants, whether gases or liquids are contemplated. Rapidly-expanded air may also be employed. Cryogen 70 is accommodated by reservoir body 40T that is comprised of element/wall 69T, shell wall 80aT and shell wall 80bT. Fluid cryogen 70 should always be assumed to be presence during operation, though not illustrated.

Expelling Extricated Grease/Oil from Element/Wall 69T

A doctor blade, identified herein as a grease/oil scraper blade 18T (FIG. 5), scrapes accumulated grease/oil that has reacted onto extricating surface 10T, thereby removing grease/oil from off extricating surface 10T.

The dashed line in FIG. 5 is approximate liquid level 100T. Reservoir body 40T in FIG. 5 also employs a conventional sprayer 101T that deluges liquid bearing grease onto reservoir body 40T for grease extrication and scraping (spray streams from sprayer 101T are identified in FIG. 5 as dashed lines).

Also contemplated: Longitudinally-attached to scraper blade 18T is a trough or gutter herein named, grease/oil scraper trough 16T (FIG. 5), to accumulate and gravitationally direct grease and oil scraped by scraper blade 18T from off extricating surface 10T. Moreover, as some greases/oil remain hard for longer durations than others, and when masses of those particular hardened greases accumulate in grease/oil scraper trough 16T, a conventional submersible heater (not shown) can be employed to revert the grease back to liquid to urge it down trough 16T.

Applicants prefer that blade 18T be made of neoprene for its hydrocarbon-resilient and pliability factors, although other oil-resistant materials would suffice.

As alternatives to scraper blade 18T, a pressure nozzle 18aT (FIG. 5a) or a vacuum nozzle 18bT (FIG. 5b) may be used to expel grease/oil that has been extricated unto wall 69. Nozzle 18aT is merely a linear-type nozzle that receives pressurized fluid that blasts fluid onto contacting/extricating surface 10T to expel attached greases and/or oils. FIG. 5a shows pressure nozzle 18aT in use with reservoir 40T [conventional compressor or pump not shown]; dashed lines indicate expelled fluid from pressure nozzle 18aT. Moreover, FIG. 5b shows vacuum nozzle 18bT in use with reservoir 40T. Nozzle 18bT is a linear-type vacuum nozzle that nearly contacts accumulated grease and oils, though close enough in order for a conventional vacuum pump (not shown) connected to nozzle 18bT to suck greases and or oils from off contacting/extricating surface 10T.

### Rotational Motion

We contemplate that reservoir body 40T rotates by way of transmitted power to a conventional rotational-motion belt/pulley, sprocket/chain, or gear drive (explained hereinafter). Direct drive or other common and conventional rotational modes are contemplated. Hydraulic motor, electric motor, air (pneumatic), or other conventional power sources can be provided to cause rotation. A conventional hydraulic motor illustrated in FIGS. 4, 4a, and other Figs as an “M” is desirable for reason of torque (as in the case of a common cement mixer truck rotating a drum of concrete). The conventional motor's conventional hydraulic pump, reservoir, return and pressure lines are not illustrated. Albeit, reservoir body 40T can be manually rotated.

Illustrated is a rotational force ring 27T (belt not illustrated) in FIGS. 4:and 4a (though seen in other Figs) that is a rudimentary transmission that receives power from a power source such a motor as illustrated (FIGS. 4, 4a, and 5). Various applications call for various modes of rotational force, one being, at times, more advantageous than another. For example: Due to a belt's needing no lubrication like a chain/sprocket or gear system that can possibly contaminate food stuffs, a V or other belt is preferred. In some applications, a chain/sprocket may be preferred. Therefore, ring 27T, we contemplate, is bolt-attached (bolts not shown) to shell wall 80aT or shell wall 80bT, and is a simple, conventional drive ring fabricated in the form of sprocket, gear, or pulley, or other conventional drives. Shell wall 80aT and wall 80bT (externally) have a round area specially machined to accommodate force ring 27T.

Reservoir body 40T rotates slowly. For some applications, to be clear, such as the embodiment being used at sea to extricate crude oil, a conventional chain and sprocket or gear-to-gear hydraulic motor system would be desirable.

### Lifting Embodiment

We contemplate that a conventional lifting device for lifting reservoir body 40T in and out from liquid to be treated can be hydraulically, electrically, pneumatic, or manually driven, all being conventional modes. Although variables for conventional lifting considerations are near endless, lifting stress points are at the area of spindle 25T (two each) and hollow axle 20T, whose individual sealed bearings 91aT receive intense pressures (as with a trucks or automobiles).

In the case of spindle usage (FIG. 4 and 4a): A conventional trunnion, namely, spindle/axle trunnion 26T (one at each end of reservoir body 40T) is bolt-fastened to the outside (away from reservoir body 40T) of spindle bolting flange 26bT (FIGS. 4, 7b). Bolting flange 26bT is machined from hollow spindle 25T (two each spindles), each spindle being stationary during use. Spindle bolting flange 26bT, has holes in order attach to spindle/axle trunnion 26T (two each, one for each end of body 40T), via conventional bolt fastening (not shown: holes shown).

Hollow spindle 25T (FIG. 7b) is comprised of stainless steel. However, it can be constructed of common, or other steels conventionally used for industrial spindles, we contemplate. Albeit, load factor and weight are significant considerations. The upper end of spindle/axle trunnion 26T has a trunnion pin hole 26aT (FIGS. 4 and 4a) for a fork-type lift to vertically maneuver reservoir body 40T that can be conventionally elevated, maneuvered, or manipulated hydraulically, electrically, pneumatically, manually, or via other common, conventional modes [block/tackle, pulley, as such]. A single trunnion cross member 28T (FIG. 4 and 4a) spans between each spindle/axle trunnion 26T to support them.

In the case of crude oil extrication when embodiment is attached to a floating vessel (FIG. 8) such as a boat or ship, the above embodiment can be attached to the bow, applicants contemplate. A simple, quick modification (hereinafter discussed) allows the embodiment to be used at port and starboard sides.

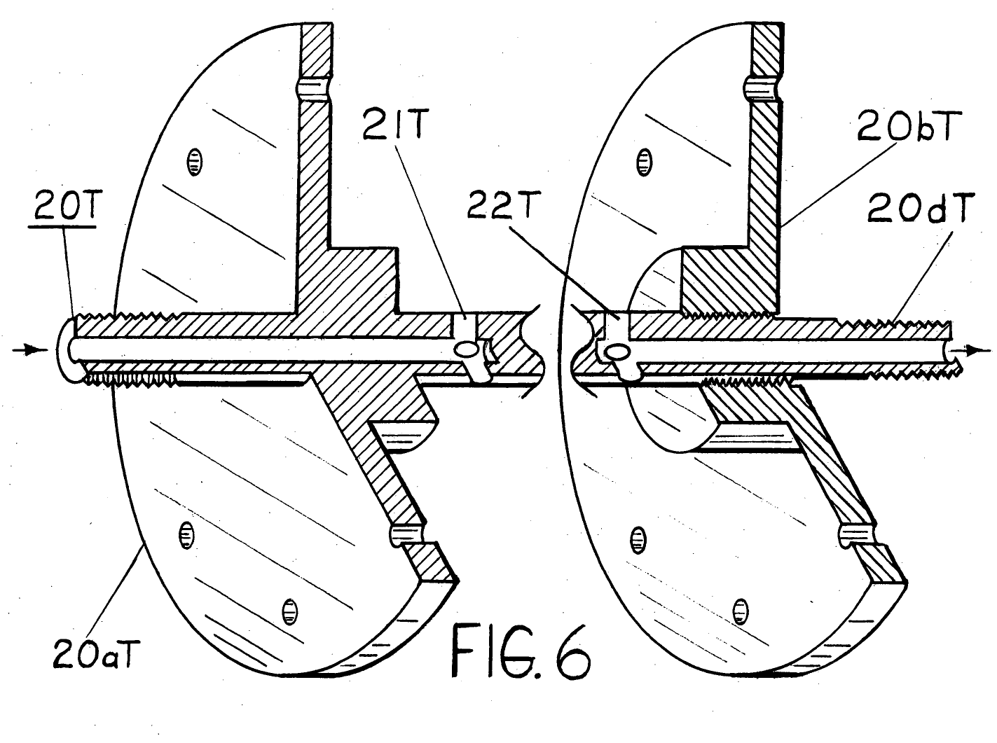

In some applications, for stationary permanence of reservoir body 40T (FIG. 5), either hollow axle 20T (FIG. 6), hollow spindle 25T (FIG. 7b), can be rested upon conventional fixed pedestal blocking, we contemplate, disallowing extensive free manipulating and maneuvering (where not necessary). However, some vertical adjustment should be allowed in order to adjust depth of reservoir body 40T into untreated liquids.

### Either Exterior-Refrigeration [of Embodiment] or Interior-Refrigeration of Cryogen 70 for Primary, Back-up, or Sole System use: Spindle or Axle for Primary, Back-up, or Sole System use

A conventional pump and hosing for pumping and re-circulating fluid cryogen 70 into and out from reservoir body 40T are not illustrated, though explained herein below. Either axle or spindle-rotation are related to cooling reservoir body 40T, as explained hereinafter.

Applicants contemplate using either axle/bearing rotation or axle-less/spindle-bearing rotation for the continuous rotation of reservoir body 40T while cryogen 70 is being pumped in and out from reservoir body 40T. Although rotating-drum mechanisms are quite common and conventional in numerous industries, applicants hereinafter explain what they contemplate.

To better explain the contemplated combination axle/spindle uses, some operational function must be elucidated. Use of hollow spindle 25T may be desirable in some circumstances and applications, however, in other applications the embodiment with a spindle may be quickly replaced with hollow axle 20T. As a sea-bound or land-based embodiment, either axle or spindle may be used as ‘a primary’ or a ‘secondary’ (auxiliary/back-up) system: Or, operations without a secondary or ‘back-up’ of either spindle or axle is suitable for normal use. Reservoir body 40T, applicants contemplate; can be rapidly converted to axle rotation from spindle rotation, or vise-versa, within an hour, by use of conventional mechanic's tools.

While reservoir body 40T employs hollow axle 20T (FIG. 7), only one each spindle/axle trunnion 26T is necessary as seen on port and starboard sides of the floating vessel seen in FIG. 8 (though two each trunnion 26T parts can be used, as explained), thereby minimizing space or for other reasons. In FIG. 8 the ship's bow (front) employs spindle 25T with two each trunnion 26T (further discussed herein), the starboard is using axle 20T (with one trunnion 26T).

The reader may take notice (FIG. 8) of the rotational direction (shown by arrows) of reservoir body 40T from port to starboard sides. Applicants contemplate that either end of reservoir body 40T, more specifically, shell wall 80aT and wall 80bT both have bolt holes to accommodate formerly-discussed rotational force ring 27T. Rotational force ring 27T [best seen in FIG. 4, and 4a] may be seen in use with conventional hydraulic motor illustrated as an “M” in FIG. 8. This means, a sprocket (not shown), pulley, or gear (not shown), can be interchangeably applied to either end of reservoir body 40T albeit force ring 27T is a transmission for rotational power.

Applicants contemplate that changing over from single-trunnion-use to double-trunnion-use should occupy the space of approximately an hour, or minutes, as well as changing drive mode (pulley, sprocket, or other) from one end of reservoir body 40T to its other end.

The spindled adaptation is readily interchangeable to be an axled, and vice-versa. Either of these may be for back-up/auxiliary or primary use.

A related consideration and contemplation is that fluid cryogen 70 be either exteriorly or interiorly refrigerated via conventional freezer (not illustrated). This option is yet another back-up feature. When exterior refrigeration is employed, cryogen 70 is first refrigerated, then pumped into one end of rotating reservoir body 40T (more accurately, into hollow axle 20T, hollow spindle 25T which protrudes from reservoir shell wall 80aT). A plumbing connect 20dT (FIGS. 4, 4a and other Figs) at end of spindle 25T spindle or axle 20T is threaded to accommodate typical, conventional plumbing. However, we contemplate that snap-on, flare, or other conventional plumbing connections can be adopted to either spindle or axle for plumbing accommodation.

Reservoir body 40T is cooled because fluid cryogen 70 is cold (whether refrigerated internal or reservoir body 40T or exteriorly). When the cold qualities of fluid cryogen 70 are exhausted (within reservoir body 40T) cryogen 70 is then pumped out from the opposing end (shell wall 80bT [via axle 20T, spindle 25T]), and cold cryogen 70 pumped in (through wall 80aT) to continuously maintain cooling and continuous grease-removal, reservoir body 40T being cooled upon demand.

### Hollow Axle 20T

Exteriorly refrigerated fluid cryogen 70 is fed into reservoir body 40T through hollow axle 20T encompassed by the inner portion of conventional sealed bearing 91aT (FIG. 7), one for each reservoir shell wall 80aT and reservoir shell wall 80bT. One trunnion 26T can be used as desired for use, two being optional. Trunnion 26T is joined to an axle flange 20aT (FIG. 6) as is normal with use of one or two each trunnion 26T parts. Axle flange 20aT bolts to trunnion 26T as otherwise spindle bolting flange 26bT is bolted, and is located at end of reservoir body 40T that bears 80aT. The opposing end of reservoir body 40T that can optionally be used absent of trunnion 26T (when applicable), uses a retainer nut/flange 20bT (seen in FIG. 6 [as well as other Figs]). The flange portion of nut/flange 20bT, when a second trunnion 26T is used, is bolted thereto. Otherwise, without trunnion 26T, nut/flange 20bT should be conventionally cotter-pinned (not shown) or safety-wired with aircraft-quality safety wire (not shown), we contemplate.

Either axle or spindle is used as primary or back-up alternative system, applicants contemplate, or either system is used without back-up. Albeit and obviously, hollow axle 20T allows for a single trunnion 26T as seen in FIG. 8, we contemplate.

### Hollow Axle Discharging and Sucking Fluid Cryogen 70

We contemplate that when hollow axle 20T (FIG. 6) is employed, axle 20T is hollow and round-tubular. In use, it is stationary (not a rotating axle). Cold, ultra-refrigerated fluid cryogen 70 commences its journey exteriorly (of reservoir body 40T) where it is refrigerated to approximately sub-freezing levels in a conventional freezer. Fluid cryogen 70, upon demand, is pumped conventionally (pump not illustrated) to, and enters the exterior (of reservoir body 40T) end of hollow axle 20T (FIG. 6 [note arrows indicating flow]). Axle 20T has discharge ports 21T (FIG. 6) on the side of reservoir body 40T bearing reservoir shell wall 80aT (though internal of reservoir body 40T).

Hollow axle 20T is but limitedly hollow (FIG. 6). An approximate 1/3 (one third) portion of hollow axle 20T located at about the center of the length of axle 20T (situated internal of reservoir body 40T), is not hollow, but solid. In other words, flow of fluid cryogen 70 ceases from linearly traveling through hollow axle 20T at about he point where axle 20T becomes solid. Frigid, fluid cryogen 70, reaching a ‘dead-end’ (within reservoir body 40T), pressure-exits from discharge ports 21T into reservoir body 40T that are holes or orifices generally perpendicular to the length of hollow axle 20T (FIG. 6). Fluid cryogen 70 is therefore, discharged into reservoir body 40T upon thermal demand (discussed later), we also contemplate. The two furthermost external ends of axle 20T may be smooth, threaded (as in FIG. 6), or otherwise constructed to conform to other conventional plumbing connection accommodations, we contemplate.

Further contemplated, therefore, is that the opposing end of hollow axle 20T, furthest distant from where fluid cryogen 70 enters, allows fluid cryogen 70 to exit for recirculation (to exterior conventional freezer for re-charge with cold). Temperature-spent (or warmer) fluid cryogen 70 that had been pumped into reservoir body 40T, upon demand and as determined by conventional temperature-controlling (not shown), egresses reservoir body 40T via hollow axle 20T. A conventional temperature sensing element (not shown) with sensor wiring (not shown) can allow for control, and can proceed though path of cryogen 70. However, external (of reservoir body 40T), conventional wireless thermal sensing such as infrared sensing of body 40T is contemplated (not shown), or other conventional wireless controlling availabilities.

Spent fluid cryogen 70 is sucked from reservoir body 40T through suction ports 22T (FIGS. 6) into hollow axle 20T, by conventional pumping. Suction ports 22T are larger than discharge ports 21T as with most conventional pumping systems, and are perpendicular to the length of hollow axle 20T. In other words, hollow axle 20T is used for ingress from and egress/‘return’ (to freezer) of fluid cryogen 70 whose cold, frigid qualities have been exhausted. Fluid cryogen 70 exits from axle 20T external of reservoir body 40T that is exterior of reservoir shell wall 80bT. Applicants also contemplate that discharge ports 21T can also double (or function interchangeably) as suction ports 22T, thereby eliminating suction ports 22T altogether (and/or their use), and expelling fluid cryogen 70 through wall 80bT at end of reservoir body 40T.

Applicants further contemplate that hollow axle 20T is best be made of stainless steel, however, costs may relegate comprisal to standard steel construction. Other materials may be employed.

### Two Hollow Spindles for Discharging and Sucking Fluid Cryogen 70

We contemplate that reservoir body 40T, having a spindled [instead of axled] rotational system in certain applications is more advantageous, as illustrated in FIG. 8 where both applications are employed. The axled system is significantly heavier. Employing the spindled system altogether eliminates hollow axle 20T (unless kept as a back-up or auxiliary), likely saving on cost in some cases, despite a greater space-occupation. However, because sea-going equipment often requires ‘back-ups’ (auxiliaries), the embodiment can be quickly backed-up for axle-use and various drives. Though such back-up may not be as critical on land. As seen in FIG. 8, taking advantage of the combinations of various parts suits various demands for grease/oil extrication applications.

FIGS. 4 and 4a (and other Figs) show hollow spindle 25T. For clarification, spindle 25T at the center of shell wall 80aT is used for fluid cryogen 70 discharge into reservoir body 40T via shaft hole 24T; spindle 25T and use discharge ports 21T (FIG. 7b) for discharge of fluid cryogen 70. Hollow spindle 25T positioned at the opposite end of reservoir body 40T, and center of shell wall 80bT, is used for fluid cryogen 70 suction from reservoir body 40T; hollow spindle 25T use suction ports 22T (not shown) for suction of fluid cryogen 70. Also contemplated is use of but one hollow spindle 25T to alternatively functioning (or doubling) for discharge and suction: This would eliminate additional plumbing and egress functions (of cryogen 70). This is not to indicate that two spindle 25T parts would not be used for rotation of the embodiment, but that simply conventionally capping-off one spindle 25T normally used for egress of cryogen 70 (providing plumbing and pumping are conventionally altered), can allow for one hollow spindle (capped spindle not shown) But for sake of simplifying explanation of functions and principles, we illustrate use of two spindle 25T functioning for ingress and egress of cryogen 70.

Also of contemplation is the use of non-sparking types of metals in the event of, for example, potential bearing failure when hydrocarbons (such as crude oil) are being extricated from bodies of liquids containing them. This is of consideration when, for example, the embodiment is situated on a boat or other floating vessel to extricate crude oil.

Yet another back-up feature shall be explained hereinafter.

### Special-use Consideration

A factor not readily noticed is that varying oils and greases react differently to cold. For example, lamb and beef grease easily harden (though at different rates) while vegetable oils may simply increase in viscosity. Absolutely, varying oils and greases shall harden or adhere to external grease/oil-contacting/extricating surface 10T at varying rates. Therefore, use of a special-use sleeve 10aT (FIG. 8) that conforms to the surface of external grease/oil-contacting/extricating surface 10T assists a possible potential for sloughing in certain conditions. Special-use sleeve 10aT (FIG. 8), applicants contemplate, is as a ‘jacket’ or ‘sock’ that can be zipped, buttoned, or stretched elastically. Sleeve 10aT can be constructed of fine mesh aluminum, copper, silver, or other cold-conducting material in the form of grease and/or oil-resistant mesh, screen, or fabric that can be easily wiped with grease/oil scraper blade 18T.

For example: Assuming a crude oil spill occurs, and the oil is extremely light, meaning, it possesses a high quantity of lighter, low-viscosity hydrocarbons such as gasoline (as opposed to heavier, tarry, longer-chained hydrocarbon). The lighter hydrocarbons act as a solvent to break down the heavier, blacker hydrocarbons, thereby potentially causing the crude oil to slough from off external grease/oil-contacting/extricating surface 10T due to splashing water or other causes. In such a case, special-use sleeve 10aT can be used. Also contemplated is a grease/oil on-flow guide (not shown) that aids to guide flow of oil onto extricating surface 10T.

### Internal Refrigeration: for Back-up or Primary use

Applicants contemplate that, as back-up or auxiliary systems are commercially demanded particularly at sea, with this embodiment, either pumping exteriorly refrigerated cryogen 70 to reservoir body 40T, as formerly described, or internally cooling cryogen 70 within reservoir body 40T, can be used as either a ‘back-up auxiliary’ or a ‘primary’ grease-removal variant. Otherwise, either interior-refrigeration or exterior-refrigeration, can be used individually, without back-up available. However, spindled rotation is employed for interior refrigeration mode.

Use of evaporator coil 55T (FIG. 4a) saves energy while effectively refrigerating cryogen 70. Instead of fluid cryogen 70 being externally refrigerated, then pumped into and out from reservoir body 40T (loosing frigid agencies and energies exerted for pumping thereby), cryogen 70 can be permanently housed within reservoir body 40T where it is refrigerated.

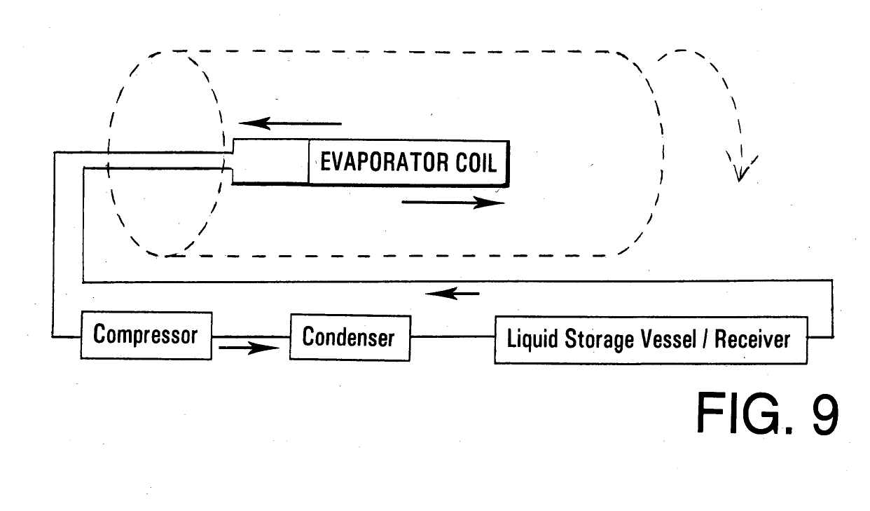

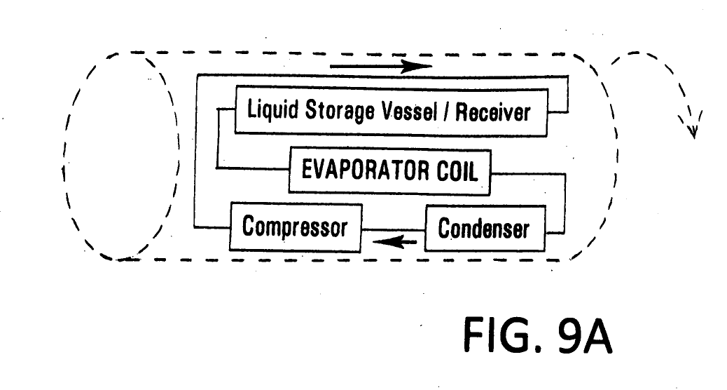

Any conventional freezer's (or air-conditioner's) “evaporator coil” is that part of common, conventional refrigeration systems that emits cold. It can be located totally separate and distant from other refrigeration system parts (illustrated in FIGS. 9 Schematic), as in the case with most conventional ‘forced-air’ home air conditioner systems. FIG. 9 schematically shows a common, conventional, vapor compression freezer's parts, excepting evaporator coil 55T being located internally of reservoir 40T. Such evaporator coil 55T, as contemplated, easily functions within reservoir body 40T while being immersed directly into fluid cryogen 70. Its surfaces are accounted as being an area augmentation and as an extension of internal cooling surface 32T in consideration of the medium's (fluid cryogen) making direct contact to cooling surface 32T, hence, to extricating surface 10T. Moreover, FIG. 9a illustrates a complete conventional refrigeration system harbored inside of reservoir 40T.

The embodiment can be easily, and near-instantly (within an estimated hour's time), ‘morphed’ from either interior-refrigeration-use or exterior-refrigeration-use to its ‘back-up.’ Either one can be employed primarily.

The embodiment in interior refrigeration mode (seen in FIG. 4a) is employing hollow spindle 25T (FIG. 7b) and quickly (within about an hour of simple mechanical manipulation) can easily lose evaporator coil 55T to exchange it for externally cooling cryogen 70. A valve 82aT (FIGS. 4 and 4a) is for filling reservoir body 40T with fluid cryogen 70 (though is only about ¾ full), and a bleed valve 82T (FIGS. 4 and 4a) is for bleeding air during filling. Bleed valve 82T is also used for evacuation of ambient atmosphere to create a vacuum where otherwise ‘air’ would occupy reservoir body 40T that is not completely filled with cryogen 70. Internal access is via internal inspection hatch 80eT, if necessary.

When evaporator coil 55T is used, cryogen 70 flow via hollow spindle 25T at wall 80bT is blocked conventionally (by valve in conventional plumbing; not shown), thereby disallowing cryogen 70 from leaking out of reservoir body 40T. Hollow spindle 25T at wall 80aT allows for conventional tubing of evaporator coil 55T situated inside of reservoir body 40T. Prevention of potential leakage of fluid cryogen 70 via hollow spindle 25T from reservoir body 40T is achieved with any various conventional, commercial sealants (not illustrated) employed for sealing out water or oil. Conventional sealant would be injected into hollow spindle 25T to enshroud or encapsulate coil 55T tubing.

The embodiment is not limited to employ but one hollow spindle 25T for routing of evaporator coil 55T tubing. Access for two or more evaporator coil 55T parts may be via hollow spindle 25T at both ends of reservoir 40T. Therefore, routing evaporator coil tubing through either one or both ends of hollow axle 20T (not shown) or two each hollow spindle 25T parts for routing purposes. Albeit, use of but one spindle 25T for entry/routing of evaporator coil 55T tubing is also possible.

### Operation—Second Embodiment—FIGS. 4, 4a, 5, 5a, 5b, 6, 7, 7b, 8, 8a, 9, and 9a

Under consideration and contemplation are the following: The herein illustrated second embodiment is not a hand-held embodiment, though illustrations are not to limit or rule out fabrication of smaller, domestic or commercial versions of the embodiment illustrated. Due to weight, bulk, and applications of the second embodiment illustrated, conceptualized and contemplated is its, primarily and generally, being for industrial, packing plant, crude-oil, or other usages where grease or oil demand extrication from liquids. Note: arrows on applicable figures reflect direction of movement.

This embodiment illustrated is contemplated as being for continuous (non-stopping/perpetual), and not continual (intermittent) usage. For example; in a case where meats are industrially cooked in plants using massive vats or pits from which grease and oil would demand ongoing extrication. In such cases, a significantly-sized, not hand-held, second embodiment would be necessary for continuous application. Another example would be in the case of a crude oil-spill in a bay, harbor, or other water body. Temporarily or permanently fixed to a floating vessel (such as a ship) the embodiment can be used for crude oil extrication.

Moreover, this embodiment does not always necessitate being submerged into a vessel, vat, or body of liquid, as it functions as well out of liquid providing liquid demanding grease extrication is applied to the embodiment, whether spray-applied (as may be seen in FIG. 5 with sprayer 101T), streamed upon, doused, deluged, or otherwise. The embodiment simply comes into contact with liquefied or plastic greases or oils to change their viscosities, or ‘harden’ them. Also, in some cases, grease or oil does not need or demand being extricated from liquids, but merely needs to be hardened for packing purposes, as in the case with lard. Therefore, the embodiment can double as simply a grease/oil hardener.

### Operational Size, Application, Refrigeration and Back-up, in General

Applicants contemplate that size of reservoir body 40T is governed and determined by particular basis-to-basis demand. Some determining factors are size of vat, vessel, or liquid body from which fats, oils, and/or greases demand removal, or other surrounding circumstances. Generally, embodiment size, therefore, demands conformity to applicable demand where continuous, not continual, usage operations are necessary. The embodiment at the bow of a ship to extricate millions of liters of crude oil is likely to be larger than the same embodiment employed in a small meat-processing plant. Illustrated in Figs showing reservoir body 40T is the embodiment having dimensions formerly specified (approximately 3.048 meters [approximately 10 feet] long and whose inside diameter would be approximately 1 meters (approximately 3 feet).

Generally, and given considerations and various contemplations, the embodiment of topic, is not only too massively large and heavy to practically hand-manipulate, but too large to refrigerate in a conventional freezer as the first embodiment illustrated (FIGS. 2 and 3). Intermittent refrigeration as used with the first embodiment would not suffice for the continuous-use embodiment. Therefore, continuous refrigeration (either internal of reservoir body 40T or exteriorly) is suitable for the continuous-acting embodiment discussed here.

The embodiment, being seafaring with various demanded back-up features in case of potential breakdown perhaps a thousand miles out at sea, for example, affords two modes of cooling, various rotational choices, various modes of rotation, and various choices for power drive (electric, hydraulic, pneumatic). Albeit, operation of the embodiment is rather straightforward and fundamental.

### Removing Grease and Oil: in General

In operation, reservoir body 40T (FIG. 8) is axially rotating and partially submersed when grease/oil elements are either floating or otherwise liquid-bound. A dashed line is approximate liquid level 100T in FIG. 8 (and other Figs). Reservoir body 40T is vertically adjustable, and though rotating, is generally fixed in direction, generally spinning in one direction (though it can spin in reverse).

Albeit, not limiting use, applicants intend and contemplate that untreated elements (grease/oil or liquid bearing grease/oil) can be applied to reservoir body 40T without reservoir body 40T being submersed. In other words, the embodiment can be employed while not being submersed so long as elements (grease/oil) to be hardened are applied to the embodiment.

External grease/oil-contacting/extricating surface 10T contacts grease/oil. Grease/oil reacts to extricating surface 10T because extricating surface 10T is cold. The reaction causes the viscosity of grease/oil to elevate, meaning, the grease significantly hardens and oils thicken to a degree whereby grease/oil is caused to adhere onto external grease/oil-contacting/extricating surface 10T (that is rotating in the liquid body). Grease/oil, by reaction, is thereby lifted out from the liquid body by the rotating extricating surface 10T that rotates out from the liquid. After reservoir body 40T has rotated oil and grease out from the liquid body, grease/oil is easily collected (wiped or ‘bladed’) from off extricating surface 10T. This operation is continuous, ongoing, not intermittent. Providing oil or grease are being directed onto extricating surface 10T that is rotating, grease oil shall be readily extricated. While external grease/oil-contacting/extricating surface 10T (FIGS. 5 and 8 [and other Figs]) is lifting grease and oil out from the liquid body, more grease/oil becomes immediately available and is thereby desirably reacted. A provided flow of oncoming grease/oil is continuously deposited onto extricating surface 10T as it rotates (as a rotating, drum on its linear axis), oil and grease being lifted up and out from the pit's, vat's or body's liquid. Therefore, extricating surface 10T, when its rotating face (facing the liquid flow direction) exits the liquid body, making an upward pass out from the liquid, reacts grease/oil for subsequent easy collection.

Some grease would also be reacted when external grease/oil-contacting/extricating surface 10T rotates in its downward motion at its backside (not facing the onward flow of untreated liquid). Because external grease/oil-contacting/extricating surface 10T is continuous-acting, presenting it with ample flow of undesirable elements (Oil/Grease) is of consideration. When 40T in used with a boat or ship (FIG. 8), either current or boat movement would provide an oncoming flow of oil, for example. Externally-situated extricating surface 10T is intended to spin in one direction in use in order to meet or face flow while extricating surface 10T is, by rotation, elevating out from the liquid being treated. Note flow-direction arrows seen in FIGS. 5 and 8.

Therefore, operationally; the undesirable, untreated, grease/oil born within a given liquid body is to be ‘continuously’ fed and directed towards reservoir body 40T (FIG. 8). External grease/oil-contacting/extricating surface 10T must be partially submerged, rotating, and exposed to flow of grease/oil when undesirable elements are not otherwise applied to reservoir body 40T [for example, spray-application as can be seen in Fig for with sprayer 101T]. In any case or given environment, while rotating, the submersed portion (or spray-applied portion) of external grease/oil-contacting/extricating surface 10T facing and encountering the oncoming flow of grease/oil, immediately reacts oncoming grease and oil to extricate grease/oil from the oncoming liquid it encounters.

### Technicalities

In all Figs of reservoir body 40T, external grease/oil-contacting/extricating surface 10T is generally not porous and of minimal or smaller surface area in relation to its converse-sided internal cooling surface 32T (both combined forming bifacial/multi-functioning interior/exterior element wall 69T). Therefore, not only is extricating surface 10T able to accommodate mass grease/oil removal aided by this configuration combined with other factors, but extricating surface 10T can be easily and immediately scraped of accumulated grease/oil it collects (being generally smooth [non-porous]).

### Cooling Reservoir Body 40T

As stated and contemplated, because this embodiment is seafaring, commercial markets usually demand back-ups and auxiliaries. As a cooling source, fluid cryogen 70 is either conventionally refrigerated in an exterior freezer (not illustrated), then pumped into and out from reservoir body 40T. Otherwise, cryogen 70 is refrigerated internal of reservoir body 40T (FIGS. 4a and 9) with evaporator coil 55T when cryogen 70 remains housed and is neither pumped in nor pumped out of reservoir body 40T during operation. Coil 55T is a conventional refrigeration coil with ample capacity to cool the volume of fluid cryogen 70 within reservoir body 40T upon thermal demand. Refrigeration is automatic. Other elements of a conventional freezer are positioned exterior of reservoir body 40T excepting, applicants contemplate, when conventional temperature sensing element and sensor wiring (not shown) can be internal: Applicants contemplate that temperature-sensing be performed external of reservoir body 40T via conventional sensing modes (such as infrared sensing).

Use of evaporator coil 55T (internal refrigeration) or pumping fluid cryogen 70 (external refrigeration), each is a ‘back-up’ or auxiliary to the other. Otherwise, either internal refrigeration or exterior refrigeration is employed without back-up, independently.

With external refrigeration use, further contemplated is that fluid cryogen 70 would be re-circulated upon demand. For example, as cold qualities of sub-freezing fluid cryogen 70 take on a predetermined amount of heat due to exterior reaction, cold being ‘spent’ within reservoir body 40T, spent fluid cryogen 70 exits reservoir body 40T, then is pumped back to the freezer for “recharging” or re-cooling prior to re-entering reservoir body 40T. Reservoir body 40T should continually maintain an approximate sub-freezing or cold temperature within itself.

### Heavy Lifting

During operation (when grease-oil is not spray-applied onto body 40T), the elevation of reservoir body 40T is vertically elevated or descended by a conventional hoist, hydraulic lift, or other common, conventional lifting mechanism while either rotating or static. Trunnion pin hole 26aT (FIGS. 4 and 4a) for a conventional pin (not shown) is situated at the upper end of spindle/axle trunnion 26T for lifting reservoir body 40T. This ability is particularly helpful if embodiment is used on a floating vessel. Regarding a floating vessel, due to a “drag factor” of reservoir body 40T being in the water, traveling quickly to a location of a crude oil spill, for example, would require that the embodiment be elevated out of the water during en route travel to or from the affected site. In operational use while collecting spilled crude oil, body 40T (FIG. 8) would be submerged with its grease/oil on-flow guide (not shown in Figs) guiding flow of oil onto extricating surface 10T. The conventional ways to lift reservoir body 40T allow for ready back-up or auxiliary change applications.

### Rotation of Reservoir Body 40T: Lifting Back-up

Further contemplated is that reservoir body 40T, being generally cylindrical in shape, would rotate axially and at a predetermined speed while generally positioned in such a manner seen in FIGS. 5 and 8. Rotational speed of reservoir body 40T would be determined by speed of on-flowing grease/oil or other factors such as the type or kind of grease/oil being extricated, ambient temperatures, or flow speed. Length of reservoir body 40T would be parallel to a given liquid's surface to be treated and demanding grease or oil removal. Reservoir body 40T would axially rotate by way of conventional electric, hydraulic, pneumatic, manual, or any other common source for providing rotational movement (reciprocating pumps, for example, can cause rotation of a hydraulic or pneumatic motor). Therefore, there are numerous conventional variations contemplated. Herein is another allowance for back-up or auxiliary system or systems insofar as power modes go. This auxiliary feature is besides the internal refrigeration or external refrigeration and various lifting alternatives;

Applicants contemplate desirability of a hydraulic motor with a conventional sprocket/chain drive (via rotational force ring 27T) for crude-oil extrication, although a conventional reduction gear, pulley (FIGS. 4, 4a and other Figs [belt not shown]), direct drive, or reduction-gearbox modes of transmitting axial rotation would function, depending on the given operation. For example, a conventional hydraulic system is desirable for rotation causation due to its non-sparking qualities, in particular, close encounters during extrication operations of hydrocarbons such as crude oil. Rotational force ring 27T, in the case of hydrocarbon removal, can be constructed of conventional non-sparking materials as are common in oil refinery and hydrocarbon work. A conventional “non-sparking” electric motor as such employed in oil refineries would also function as well as pneumatic motorization.

### Collecting Grease/Oil Accumulated Onto Extricating Surface 10T

Also contemplated in the second embodiment is use of grease/oil scraper blade 18T (FIG. 5) that is a type of ‘doctor’ or wiper blade, much like a long, stationary windshield-wiper blade. Applicants prefer that blade 18T be made of neoprene for its hydrbcarbon-resilient and pliability factors, although other oil-resistant materials would suffice. Blade 18T is juxtaposed to an accommodating gutter or trough called grease/oil scraper trough 16T (FIG. 5). Contemplated is that blade 18T and trough 16T combined be one part or assemblage. Both scraper blade 18T and its accommodating trough 16T span the length of external grease/oil-contacting/extricating surface 10T to scrape and accumulate reacted grease.

Certain greases, for gravity-flow or pumping (once accumulated and scraped), demand a slight heating with a conventional submersible heater (not shown) placed inside of trough 16T to thin the grease that it be gravitationally urged to a conventional grease sump and pump (not shown). Grease/oil scraper blade 18T and its attached grease/oil scraper trough 16T are positioned at the back side of the rotating drum that rotates downwardly into (not out from) the liquid to be treated, being that of reservoir body 40T that does not face on-flow of untreated, grease/oil-bearing liquid.

In other words, after a given, particular mass of grease/ oil has attached itself to rotating external grease/oil-contacting/extricating surface 10T, the reacted grease/oil, being adhered to extricating surface 10T, hastens upwards as extricating, surface 10T rotates. Almost immediately after that given, particular grease/oil mass reaches the highest point of body 40T, then commences its downward travel/sweep, the grease/oil is wiped, scraped or otherwise expelled from off the extricating surface 10T by grease/oil scraper blade 18T (FIGS. 5). Grease/oil is then forced into grease/oil scraper trough 16T (FIG. 5) positioned at a slight downward angle, causing gravity-fed grease/oil to enter a collection sump for further pumping or gravity-feed therefrom. This process and operation are continuous.

Also of contemplation: The fact that varying amounts of grease-loading due to varying vat, pit, or other liquid body contents (such as beef, pork, lamb, vegetable oils, crude oil, or others) would determine variable sizes of grease/oil scraper trough 16T. A greater grease loading onto extricating surface 10T would demand a broader, deeper grease/oil scraper trough 16T. Also of consideration is that varying thicknesses, hardnesses', widths, and materials of grease/oil scraper blade 18T be readily changeable upon demand. Ease and quickness of part changeability of scraper blade 18T and scraper trough 16T, corresponding to varying grease/oil loads, temperatures, and other factors, is a significant consideration, we contemplate.

As alternatives to scraper blade 18T, pressure nozzle 18aT (FIG. 5a) or vacuum nozzle 18bT (FIG. 5b) may be used to expel grease/oil that has been extricated unto wall 69.

FIG. 5a shows pressure nozzle 18aT in use with reservoir 40T; dashed lines indicate expelled fluid from pressure nozzle 18aT. Moreover, FIG. 5b shows vacuum nozzle 18bT in use with reservoir 40T.

### Internal Operations

The second embodiment's primary operational principles and concepts of bifacial/multi-functioning interior/exterior element/wall 69T and fluid cryogen 70 are the same as those embodied in the hand-held, continual-use, first embodiment seen in FIGS. 2 and 3. However, the first embodiment's (FIGS. 2 and 3) movements by hand (manual manipulation) are as a self-winding watch, in essence, fluid cryogen 70 continually imparting cold whereby hand manipulation aids to cool element/wall 69T. With the second embodiment (FIGS. 4 and 4a [and other Figs]), movement of fluid cryogen 70 is, generally, machine-manipulated continuously via axially rotation of reservoir body 40T and sometimes by pumping.

More Back-up that can also be for Primary-use

Moreover, to further support rigid marine-worthy demands, either axle or spindle rotation for reservoir body 40T is easily accommodated. Either hollow axle 20T or hollow spindle 25T can be used for auxiliary/back-up or for primary use without back-up.

### Special-use Sleeve on External Grease/Oil-Contacting/Extricating Surface 10T

Being that all greases and oils are not created equal, some being ‘thinner’ than others, some hardening more (and quicker) than others, some being more sticky, some whose viscosity is higher or lower than others, special-use sleeve 10aT facilitates extrication. Sleeve 10aT is a fabric or screen-type material able to conduct cold qualities transmitted from extricating surface 10T, and is easily scrapeable via grease/oil scraper blade 18T. Sleeve 10aT is quickly installed or removed, as is as a sock or jacket that covers extricating surface 10T.

Initial Filling with Fluid Cryogen 70

Also contemplated is that bleed valve 82T (FIGS. 4 and 4a) be positioned at the outer perimeter edge of wall 80aT and wall 80bT to release air while fluid cryogen 70 is initially being filled via valve 82aT prior to first-use, to bleed air being displaced by fluid cryogen 70 in any of its forms. A vacuum is formed via bleed valve 82T (created by a conventional vacuum pump not illustrated). Although creating a vacuum is not necessary for operation, the evacuation of air aids towards temperature maintenance, impeding conductance of heat via wall 80aT and wall 80bT.

### Other Operational Data

The embodiment can be employed indoors or out of doors as well.

### Drawings—Reference Numerals—Third Embodiment

10J external grease/oil-contacting/extricating surface
10CJ external grease/oil-contacting/extricating surface
18T grease/oil scraper blade
18aT pressure nozzle
18bT vacuum nozzle
25J hollow spindle
27T rotational force ring
32J internal cooling surface/jacket
32aJ copper sheathe
32CJ internal cooling surface/jacket
40J reservoir body
40CJ reservoir body
54J cooling pins
54CJ cooling pins
69J bifacial/multi-functioning interior/exterior element/wall
69CJ bifacial/multi-functioning interior/exterior element/wall
80J shell wall
80CJ shell wall
85J wall passages
85CJ wall passages
88CJ grooves
89J evacuation valve
91J bearing recess
91aT conventional sealed bearing
91CJ bearing recess

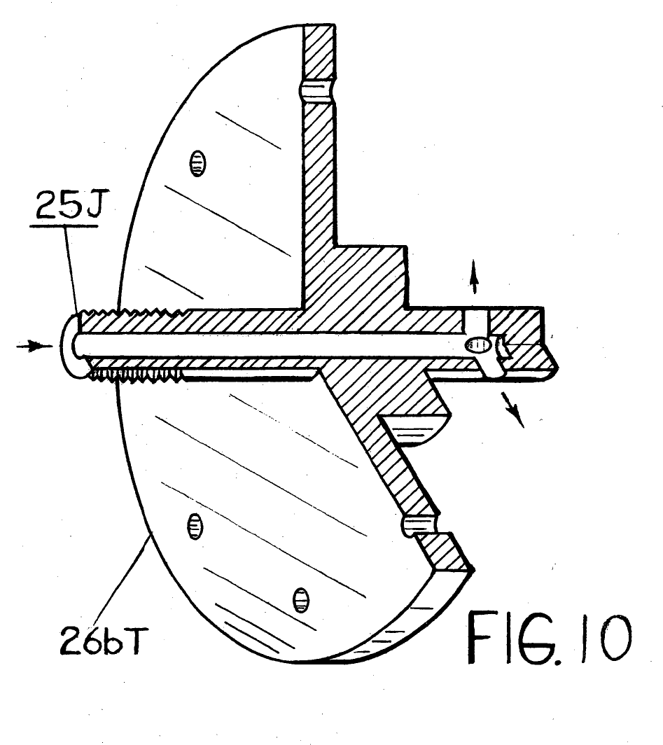

### Detailed Description—Third Embodiment—FIGS. 10, 11, 11a, 12, 12a, 12b, and 12c

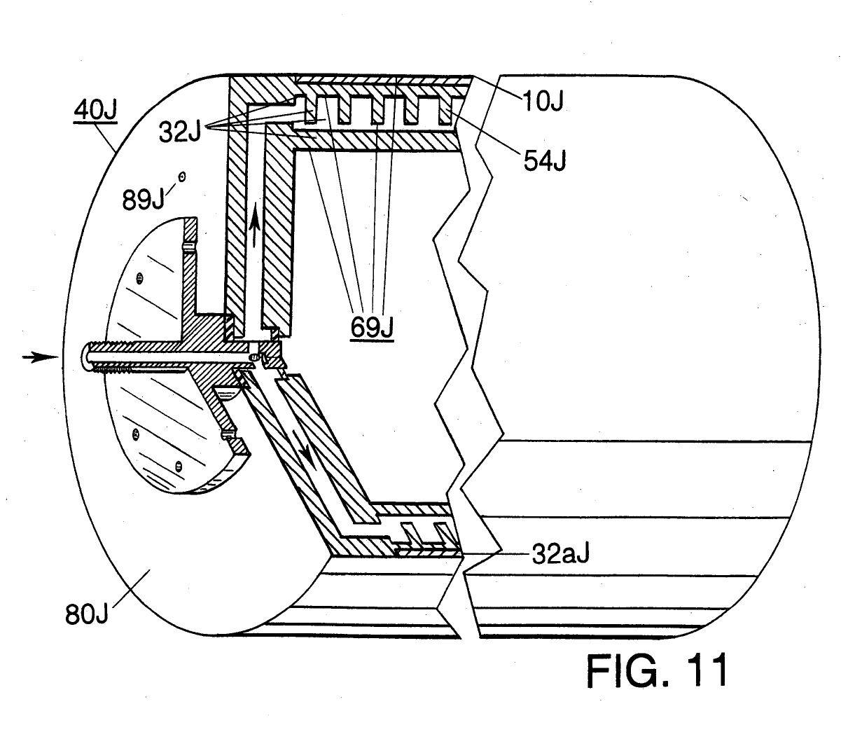

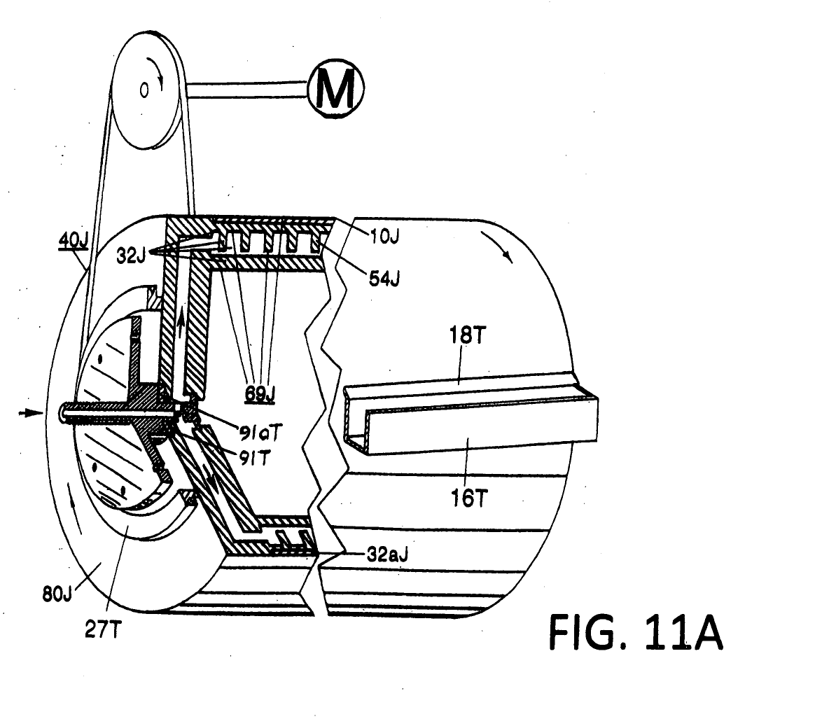

Referring to all Figs of the third embodiment, we illustrate another variation of the second embodiment contemplated and expressed: Although this third embodiment is strikingly similar to the second embodiment, differences are herein expressed. The embodiment's size is as the first continuous-use embodiment described (second embodiment), though sizes can vary according to demand, we contemplate. Illustrated in Figs of the third embodiment is a “jacketed” version, meaning, having a “cooling jacket” employed to augment cooling surface area to form a Grease/Oil Cooler Configuration (see glossary on Page 32). “Internal cooling surface 32T” of FIGS. 4 and 4a morphs in form into an internal cooling surface/jacket 32J in FIG. 11. Reservoir body 40T in FIGS. 4 and 4a morphs into a reservoir body 40J in FIG. 11.

We further contemplate use of internal-refrigeration of cryogen 70 for this embodiment (not shown), but, to simplify understanding, the embodiment employs external refrigeration of cryogen 70: With this continuous-use, jacketed variation, and whether using a spindle or axle (both discussed here), cryogen 70 is pumped into reservoir body 40J (flow arrows in applicable Figs). Reservoir body 40J rotates and is generally cylindrically-shaped. Cryogen 70 then travels through a jacketed area only (as most conventional cooling jackets used in auto engines or heat exchangers), instead of partially filling reservoir body 40J, as in the case of the second embodiment shown in FIGS. 4 and 4a. Fluid cryogen 70 exits through the opposing end of reservoir body 40J from which it entered. This configuration thereby, saves on costs of cooling, and can be employed when energy and weight are considerations.

Moreover contemplated: Whether reservoir body 40J is axled or spindled (FIG. 10), internal cooling surface/jacket 32J more than doubles its back-to-back, exterior area known as external grease/oil-contacting/extricating surface 10J (FIG. 11). Extricating surface 10J has morphed in shape from external grease/oil-contacting/extricating surface 10T in FIGS. 4 and 4a. Therefore, both external grease/oil-contacting/extricating surface 10J and internal cooling surface/jacket 32J, combined, form bifacial/multi-functioning interior/exterior element/wall 69J. Element/wall 69J (FIGS. 11 and 11a) is morphed in form from element/wall 69T in FIGS. 4 and 4a.

In addition to the area-augmenting jacket (internal cooling surface/jacket 32J), yet further surface augmentation in the form of cooling pins 54J (FIGS. 11). This embodiment (whether axled or spindled) resembles a cylinder within a cylinder to form a path (or jacket) through which fluid cryogen 70 travels. However, shapes of reservoir body 40J, hence element/wall 69J, can vary in form, and may be hexagonal, box, or other shapes so long as the Grease/Oil Cooler Configuration is employed (see glossary on Page 32). Modifying harmonic

Also contemplated: When reservoir body 40J is axled or spindled, cryogen 70 is either pumped on thermal demand, or continuously. Temperature of reservoir body 40J (more accurately, extricating surface 10J) is measured or judged by conventional methods (not illustrated) such as infra-red or temperature-sensor/s. Currently (to date), thermostatic temperatures can be automatically controlled by way of simply pointing or aiming now-conventional thermal-sensing equipment to sense temperature of reservoir body 40J. Internal conventional sensing can also be employed, whose wiring enters via the same path that cryogen 70 enters (herein explained).

We also contemplate: The embodiment may also be axially or spindle-rotated while reservoir body 40J is interchangeable with either hollow spindle 25T or hollow axle 20T, either being for ‘back-up,’ main use, or other purposes such as space or weight.

### Spindle and Rotation

As regards spindle rotation, we contemplate: Arrangement of two each hollow spindle 25T parts positioned at ends of reservoir body 40J. FIG. 11 shows reservoir body 40J accommodating hollow spindle 25J. Moreover each [of two] spindle 25J part remains stationary, each spindle 25J employing two each conventional sealed bearing 91aT (FIGS. 11a) which is accommodated by bearing recess 91J at each end of reservoir body 40J. Bearing 91aT (FIG. 11a) parts disallow cryogen 70 from leaking into the central portion of reservoir body 40J that is to remain dry and evacuated of atmospheric air [a vacuum] (embodiment can be used un-evacuated as well). Bearing 91aT parts also prevent cryogen 70 from leaking out from embodiment to atmosphere.

During construction of embodiment, each bearing 91aT assembly should, as is common in marine/water applications, bear a slight amount of conventional sealant (not shown) applied to its exterior casing and shaft hole area to prevent leakage of cryogen 70 (or entrance of atmosphere/ambient air into embodiment). In essence, reservoir body 40J while rotating, is limitedly similar to a truck's or automobile's wheel having a bearing assembly (caged bearings and ‘race’) on the inside and outside of the Wheel. Reservoir body 40J, limitedly resembling the rotating wheel (figuratively) by having conventional sealed bearing 92aT at both ends of reservoir body 40J.

In lieu of a second (or two) conventional sealed bearing 91aT parts for each end of reservoir body 40J (towards the inner part of reservoir body 40J) a conventional seal (not shown) can be used, thereby eliminating the additional bearing that is primarily used for sealing only. Another alternative way to eliminate the additional bearing and use that bearing acting as seal, shall be later, hereinafter discussed.

We also contemplate that: Bearing 91aT parts absorb rotational and thrust pressures, thereby eliminating need for individual thrust bearings. The flange of hollow spindle 25J is bolted to the inside (or closest to reservoir body 40J) of spindle/axle trunnion 26T (not shown). Thereby, normally expected rotational thrusts of reservoir body 40J shall be absorbed by spindle 25J, hence, by trunnion 26T. When spindle 25J is used (as opposed to axle 20T), bearing tension adjustment (common and conventional with rotational systems) may be performed by conventional shimming (not shown) either between the spindle flange and trunnion 26T, or between bearing 91aT and spindle 25J (conventional shims not shown).

The entire reservoir body 40J (FIG. 11) is cast aluminum, but other suitable thermal-conducting materials can perform as well. Reservoir body 40J bears a copper sheathe 32aJ forming external grease/oil-contacting/extricating surface 10J about which (internally) aluminum is cast (including surface/jacket 32J, cooling pins 54J, and two each shell wall 80J parts). Fluid cryogen 70 travels into a single shell wall 80J via either hollow spindle 25J or hollow axle 20T (optionally), then travels into shell wall 80J via wall passages 85J, travels into element/wall 69J, then into the second shell wall 80J, flow into spindle or axle (optionally), then out of reservoir 40J. In other words, extricating surface 10J is a copper tube, jacket, or cylinder inside of which the general remainder of reservoir body 40J is cast (excepting four each sealed bearing 91aT each whose bearing recess 91J features is machined). Albeit, reservoir body 40J does not need to have copper sheathe 32aJ about it, as detailed above, but functions without it, as one, single, entirely (generally) cast aluminum reservoir body 40J. Copper simply increases an efficiency factor, whose concept is presented here as a contemplated variation, not as a limitation.

Generally, reservoir body 40J is one, single cast part excepting conventional bearings 91aT, spindle 25J (or axle 20T), and conventional rotational accompaniment such as a V-belt pulley (generally). That ‘rotational accompaniment’ is rotational force ring 27T (FIG. 11a), that is bolt-fastened, though it may be otherwise attached by welding, or other conventional fastening, we contemplate. 27T is a transmission that transmits power from the motor to create rotational energy. Also contemplated is that force ring 27T has interchangeable variants such as various sprockets [for chain], or various gear types, and various belt types (or conventional rotational modes), all these not only being interchangeable to accommodate drive, but changeable from one end of reservoir body 40J to the other.

Rotational force ring 27T during use, is normally attached to one each shell wall 80J that is machined to accommodate rotational force ring 27T. Therefore, shell wall 80J is able to accommodate (by simple bolt-fastening to each wall 80J) rotational accompaniments such as sprocket, pulley, or gear in the form of force ring 27T. With the second embodiment, FIG. 8 illustrated how, at port and starboard sides of boat, rotational force is applied to opposite ends of the embodiment shown (left from right), as is the case with reservoir body 40J. Hence, the ability to accommodate a conventional sprocket, V-belt, or gear ring (force ring 27T) to either end of reservoir body 40J, thereby switching ends of applied rotational force to either end of the embodiment, is desirable, we contemplate.

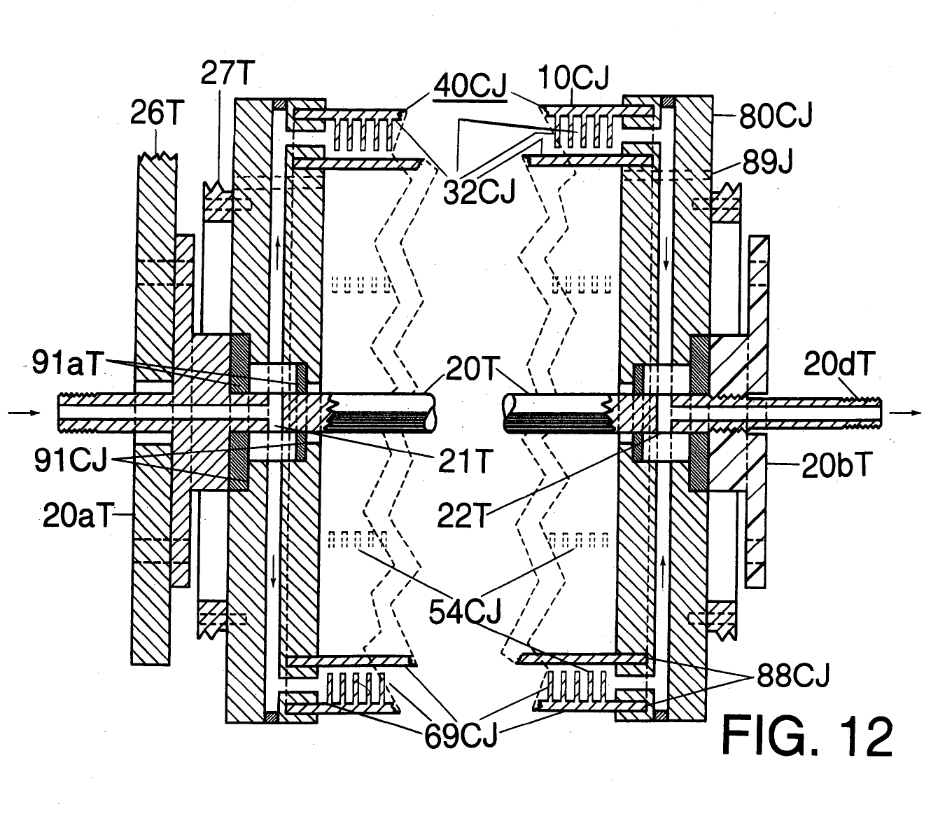

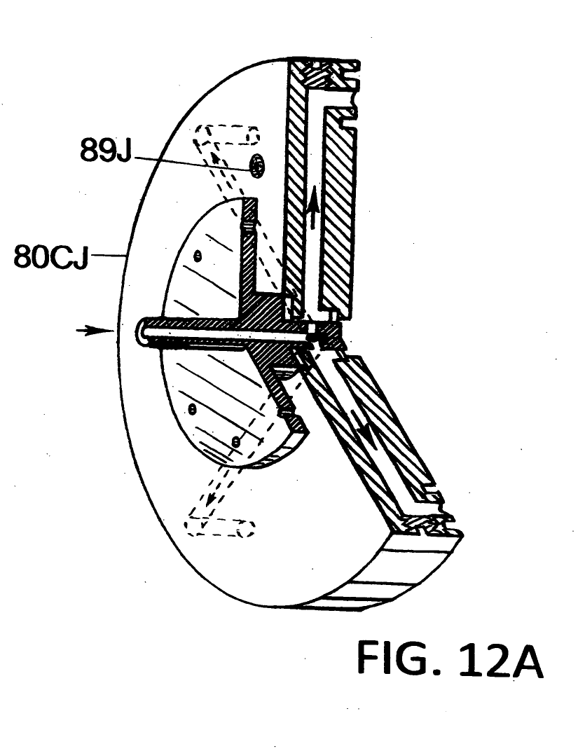

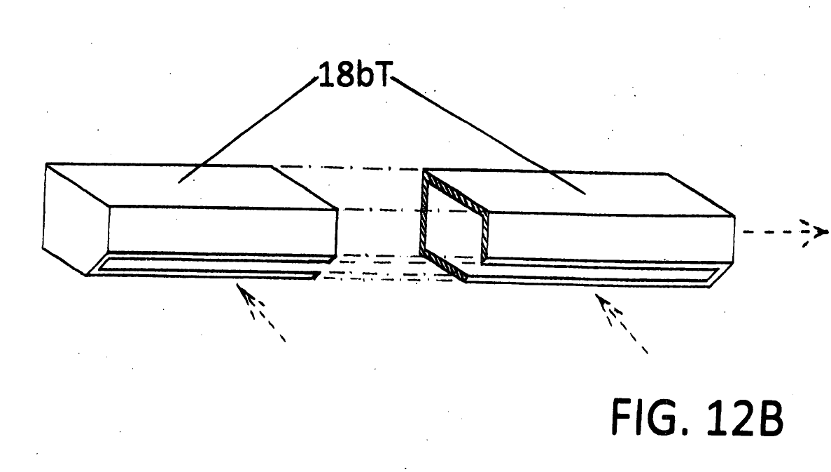

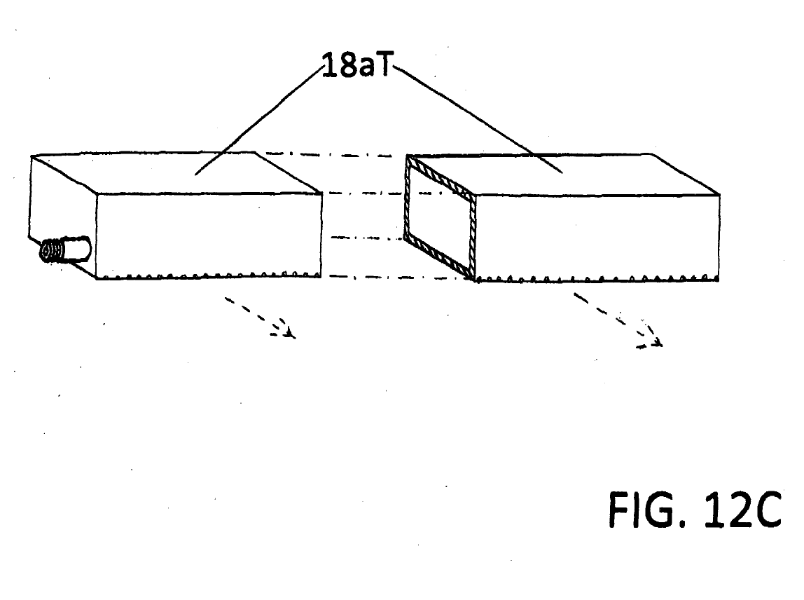

Viewing FIG. 11 la, scraper blade 18T is a basic doctor-type blade that expels greases and/or oils while reservoir 40J rotates, and runs the length of contacting/extricating surface 10J and 10CJ (as in FIG. 11a). As alternatives to scraper blade 18T, a pressure nozzle 18aT (FIG. 12c) or a vacuum nozzle 18bT (FIG. 12b) may be used to expel grease/oil that has been extricated unto wall 69. Nozzle 18aT is merely a linear-type nozzle that receives pressurized fluid [compressor or pump not shown] that blasts fluid onto contacting/extricating surface 10T to expel attached greases and/or oils. FIG. 12c shows pressure nozzle 18aT in use with reservoir 40T; dashed lines indicate expelled fluid from pressure nozzle 18aT. Moreover, FIG. 12b shows vacuum nozzle 18bT in use with reservoir 40T. Nozzle 18bT is a linear-type vacuum nozzle that nearly contacts accumulated grease and oils, though close enough in order for a conventional vacuum pump (not shown) connected to nozzle 18bT to suck greases and or oils from off contacting/extricating surface 10T.

Also, an evacuation valve 89J (FIG. 11) is drilled into each shell wall 80J in order to either evacuate reservoir body 40J of atmosphere (to remove ambient air, thereby creating negative internal pressure), and to re-occupy reservoir body 40J with ambient atmospheric pressure. Evacuation valve 89J also serves as a “weep” passage for any accumulated excess moisture evacuation.

Each (of two total) shell wall 80J is jacketed and cast with reservoir body 40J. However, other contemplations are that wall 80J can be a separate part and attached by welding or other fastening modes such as bolting (as in the case with the second embodiment), soldering, or use of adhesives.

Axled Rotation with Reservoir Body 40J

In some circumstances, axle (versus spindle) rotation is desirable (as seen in FIG. 8—second embodiment). Use of one spindle/axle trunnion 26T is afforded with use of axle 20T. We contemplate that hollow axle 20T (FIG. 12) be employed with reservoir body 40J, interchangeably, with other second or third embodiments for back-up or other reasons such as space or weight. Also contemplated are other hollow-type axles later discussed.

### Copper Jacket, Spindle or Axle

Also contemplated is that other or additional materials may be employed to fabricate a continuous-use reservoir body 40J. FIGS. 12 shows a reservoir body 40CJ that is jacketed, and primarily made of copper.

To fabricate bifacial/multi-functioning interior/exterior element/wall 69CJ (FIG. 12) two copper tubes of varying diameters are employed. Element/wall 69CJ is comprised of internal cooling surface/jacket 32CJ (FIG. 12) and external grease/oil-contacting/extricating surface 10CJ (FIG. 12) combined. The larger tube bears cooling pins 54CJ (FIG. 12) silver-soldered to its inside diameter to further increase surface area of internal cooling surface/jacket 32CJ. The inner tube's outside diameter increases surface area of surface/jacket 32CJ. Surface/jacket 32CJ is of increased area over, above, and beyond surface area of external grease/oil-contacting/extricating surface 10CJ, therefore, further surface augmentations (pins 54CJ) are optional. Other surface augmentations suffice, such as ridges, corrugations, fins, cones, rods, or other conventional surface augmentations conventionally employed in cooling applications. The outside diameter of the smaller tube and the inside diameter of the larger tube combined, form the inner jacket through which cryogen 70 travels. The bulk area of reservoir body 40CJ is evacuated of ambient air via evacuation valve 89J (FIG. 12), though system function without this feature that impedes conductance of warmer outside air from permeating into reservoir body 40CJ via shell wall 80CJ (two each) and other areas when warmer temperatures can infiltrate. Referring to FIG. 12a for a view of shell wall 80CJ: A fluid cryogen 70 travels into a single shell wall 80CJ via either hollow spindle 25J or hollow axle 20T (optionally), then travels into shell wall 80CJ via wall passages 85CJ, travels into element/wall 69CJ, then into the second shell wall 80CJ, flow into spindle or axle (optionally), then out of reservoir 40CJ.

Shell wall 80CJ (two each: one for each end of reservoir body 40CJ) is machined stainless steel and serves as a manifold to distribute cryogen 70 to element/wall 69CJ (FIG. 12). Shell wall 80CJ (two each, one for each end of reservoir body 40CJ) jackets are formed by drilling bi-directionally. The jacket allows cryogen 70 to enter directly into internal cooling surface/jacket 32CJ (FIG. 12). Shell wall 80CJ (two each) is round and generally flat: Bearing recess 91CJ (a total of four each) is machined into two each surface/jacket 32CJ parts from exterior of wall 80CJ (two recess 91CJ per each wall 80CJ) to accommodate conventional sealed bearing 91aT (four total) that shall be pressed (FIG. 12). Instead of two inner bearing 91aT, a marine-type seal also functions (not shown). Also, drilled and machined on (two each) shell wall 80CJ (exterior) are conventional bolt holes to accommodate rotational force ring 27T: Though conventional bolt holes accommodate V-belt rotational force ring 27T, gear, or sprocket rings are also contemplated for either backup/auxiliary or primary-use choices.

The interior side of shell wall 80CJ that is to contact element/wall 69CJ is machined flat to meet near-flush with ends of element/wall 69CJ (previously-mentioned copper tubes). Then, two each outer-perimeter or peripheral grooves 88CJ (FIG. 12) approximately 4 centimeters (1.6 inch) deep and about 12 centimeters (4.7 inches) from each other are circumferentially machined into the previously flat-machined interior face of each wall 80CJ (two each; meaning, two each grooves per each wall 80CJ). The outer, larger-diametered of grooves 88CJ is approximately 2 Centimeters (approximately 0.8 inch) inward from the edge of the outside perimeter edge of shell wall 80CJ. Grooves 88CJ (four total) whose widths are slightly wider than the copper cylinders/tubes are thick (approx 0.5 centimeter or 0.2 inch) to accommodate four conventional O-ring seals (not shown) and the copper tubes. For clarity, each shell wall 80CJ receives two grooves 88CJ and two conventional O-ring seals (not shown) in order to accommodate the ends of the formerly-mentioned copper tubes forming element/wall 69CJ (FIG. 12).

Grooves 88CJ bearing conventional O-rings are filled with MIL-SPEC-83430 (not shown) that is a common, conventional, and typical fuel cell sealant/adhesive that can function in extreme temperatures, even well below (−40) sub-zero (Centigrade) temperatures and up to 182. degrees Celsius. Other such conventional sealant/adhesives whose adhesion properties are desirable are sufficient. The ends of element/wall 69CJ (two copper tubes) and shell wall 80CJ are coupled contiguously while MIL-SPEC-83430 or other conventional sealant/adhesive is yet plastic. When mastic has cured, reservoir body 40CJ may be used.

Another contemplated option is silver/tin soldering wall 80CJ to the two copper tubes, however, a titanium-stabilized grades of stainless steel must not be used in such a case (of soldering) for common soldering problems linked to such metals. Otherwise, stainless steel are fairly easily soldered. Moreover, in the case of soldering, O-rings would be omitted. A consideration is that end-to-end pressures on reservoir body 40CJ are via other mechanical pressures herein detailed.

Scraper blade 18T and scraper trough 16T are employed with this embodiment as with other continuous-use embodiments. Moreover, as alternatives to scraper blade 18T, a pressure nozzle 18aT or a vacuum nozzle 18bT develop pressure or vacuum conventionally.

### Operation—Third Embodiment—FIGS. 10, 11, 11a, 12, 12a, 12b, and 12c

In use, operation of the third embodiment is quite similar to other continuous-use embodiments excepting a few subtleties explained here. The embodiment, as illustrated, is cooled via externally-refrigerated fluid cryogen 70 (though internal cooling [not shown] is optional). Because fluid cryogen 70 occupies significantly less space within the third embodiment in comparison to the previously-detailed second, continual-use embodiment, overall weight of reservoir body 40J is significantly less. This means less power is needed to rotate reservoir body 40J, and less power is needed to refrigerate bifacial/multi-functioning interior/exterior element/wall 69J.

Therefore, as the reader has thus far seen, several parts are interchangeable from embodiment to embodiment as may be demanded for maritime use or when various applications may change: For instance; when certain applications or conditions demand a lighter embodiment that operates somewhat comparative to the second embodiment while parts of other continuous-use embodiments are interchangeable as further described hereinafter.

Cryogen 70 is first exteriorly refrigerated (when not necessary [when cryogen is not a cold gas or when interior refrigeration is not employed]), then pumped in to hollow spindle 25J (FIG. 10) or axle 20T (FIG. 12) that are stationary and through which cryogen 70 travels. Cryogen 70 then enters one each (of two, total) shell wall 80J while reservoir body 40J rotates. Fluid cryogen 70 is then distributed through shell wall 80J that is jacketed (with at least one port), meaning, cryogen 70 travels through paths (five illustrated) or ports cast into shell wall 80J that, in essence, is an “intake manifold” for cryogen 70 to be introduced into element/wall 69J (more precisely, cooling surface/jacket 32J). Fluid cryogen 70 then enters element/wall 69J (which is a jacket), generally traveling (while being pumped) somewhat directionally to the other end (opposite from where cryogen 70 entered) of cylindrically-shaped reservoir body 40J while reservoir body 40J rotates. As cryogen 70 moves internal of element/wall 69J, it contacts cooling pins 54J (if present as illustrated) and/or other area-augmenting surfaces that, combined, far exceed doubling the surface area of external grease/oil-contacting/extricating surface 10J. A Grease/Oil Cooling Configuration is employed (see glossary on Page 32).

As with other continuous-use embodiments, reservoir body 40J is maneuvered into a liquid body demanding treatment (grease/oil extricated). Otherwise, grease/oil is spray-applied or deluges extricating surface 10J while rotating. As reservoir body 40J rotates, it accumulates grease/oil that is then scraped with grease/oil scraper blade 18T and grease/oil scraper trough 16T (FIG. 11a).

Power to rotate reservoir body 40J is transmitted to reservoir body 40J via rotational force ring 27T (FIG. 11a) that is a conventional-type ring that is bolted to reservoir body 40J (more precisely, to shell wall 80J). Rotational force ring 27T and other such rings can easily be accommodated, such as a sprocket force ring (not shown) and a gear force ring (not shown) in order to quickly change the mode of drive according to demand and for back-up, or auxiliary purposes. Various force rings are interchangeable.

### Copper Jacket, Spindle or Axle

In use, operation of the copper-jacketed variation is quite similar to other continuous-use embodiments excepting a few subtleties explained here. The embodiment is cooled via externally-refrigerated fluid cryogen 70. Because fluid cryogen 70 occupies significantly less space with the jacketed embodiment (in comparison to the second embodiment for continuous-use as specified), and as significantly less cryogen 70 is employed, the overall weight of reservoir body 40CJ is significantly less. This means less power is needed to rotate reservoir body 40CJ, and less power is needed to refrigerate bifacial/multi-functioning interior/exterior element/wall 69J.

Therefore, as the reader has thus far seen, many parts are interchangeable from embodiment to embodiment as can be necessary for maritime use or when various applications or circumstances change (various types of grease/oil being processed). For instance, certain applications can demand a lighter (in weight) or more efficient embodiment [due to specific metallic thermal-conductance rates or grease/oil qualities] that can generally operate in use as do the second and third embodiments. Generally, parts of other continuous-use embodiments are interchangeable (between embodiments) as described.

Cryogen 70 is first exteriorly refrigerated (when cryogen requires refrigeration), then pumped in to hollow axle 20T and/or partially-hollow spindle 25J (that is stationary) from which cryogen 70 enters one each (of two, total) shell wall 80CJ while reservoir body 40CJ rotates. Fluid cryogen 70 is then distributed through shell wall 80CJ that is jacketed, meaning, cryogen 70 travels through paths inside of shell wall 80CJ that, in essence, is an “intake manifold” for cryogen 70 to be introduced into element/wall 69CJ. Fluid cryogen 70, enters element/wall 69CJ, generally traveling (while being pumped) somewhat directionally to the other end (opposite from where cryogen 70 entered) of cylindrically shaped reservoir body 40CJ while reservoir body 40CJ rotates. As cryogen moves internal of element/wall 69CJ, it contacts cooling pins 54CJ and other augmenting surfaces that, combined, far exceed doubling the surface area of external grease/oil-contacting/extricating surface 10CJ. A Grease/Oil Cooling Configuration is employed (see glossary on Page 32).

As with other continuous-use embodiments, reservoir body 40CJ is maneuvered into a liquid body demanding treatment (grease/oil extricated). As body 40J rotates, it accumulates grease/oil that is then scraped with grease/oil scraper blade 18T and grease/oil scraper trough 16T (FIG. 11a). Instead of being dipped into a liquid body of untreated grease/oil, the untreated mass may be spray-applied or otherwise caused to be applied onto extricating surface 10CJ.

Power to rotate reservoir body 40CJ is transmitted to reservoir body 40CJ via rotational force ring 27T that is a conventional-type ring that is bolted to reservoir body 40CJ (more precisely, to shell wall 80CJ). Rotational force ring 27T and other such rings can easily be accommodated, such as a sprocket force ring (not shown) and a gear force ring (not shown) in order to quickly change the mode of drive according to demand and for back-up, or auxiliary purposes. Various force rings are interchangeable. For best results, reservoir body 40CJ should be evacuated of its atmospheric air by using a conventional vacuum pump (not shown) attached to evacuation valve 89J.

### Advantages

From the description above, a number of advantages of the embodiments of our frigid-reactance grease/oil removal system become evident. Although there are three total embodiments specified in this application, generally speaking, there are two kinds insofar as continual-use or continuous use:
1.) The continual-use embodiment would benefit any soul who is careful about her or his health, especially with regard to America's current number-one killer, heart disease, most often related directly to fat intake,
2.) Being that the continual-use embodiment can well serve as a preventive health care necessity in settings such as school cafeterias, military ‘chow halls,’ restaurants, and homes, it could, therefore, well yield in driving down health-care costs, promoting overall saving to taxpayers. The continuous-use version is not excluded from affording health-related advantages as well,
3.) The continual-use and continuous-use embodiments embody a unique configuration, wholly eliminates key claimed elements of former art (U.S. Pat. No. 4,024,057—Portable Cold Grease Remover),
4.) The embodiments perform solid-from-liquid extractions of grease and oil that are easier and more thorough than liquid-from-liquid extractions, causing no waste of food stocks common with liquid-liquid extractions,
5.) The embodiments are not currently available on the market to meet demand,

6.) The continual-use and continuous-use embodiments can supply commercial and domestic food preparers' high demands for not only a better-than-ancient type device and process, but for a device that actually extricates grease beyond what the Cold Metal Effect capabilities have to offer. This extrication is performed quicker and more efficiently than various ancient (over thirty years past) cold methods for grease extrication (namely; Cold Towel Method, Slushy Soda Method, and Freezer Method), while bearing substantial cold qualities that could not be otherwise provided,
7.) Embodiments can remove grease/oil either continually or continuously, according to demand,
8.) Embodiments are basically, one consolidated part comprised of a unique feature configuration for the purposes at hand,
9.) Embodiments are energy efficient; The continual-use embodiment can be cooled but once in a conventional freezer, after which time, it can be employed to effectively, thoroughly, and continually extract grease from several four-liter pots bearing hot, liquefied grease floating atop near-boiling water-based food stock (broth, soup, gravy stock, stew, bouillons), without needing re-cooling,
10.) Embodiments are easy to use,
11.) Embodiments and their applied processes are safe for kitchens,
12.) Embodiments, unlike prior art ((U.S. Pat. No. 4,024,057—Portable Cold Grease Remover) allow for liquid antifreeze or other ultra-cold cryogens such as gasses to be directly contacting and impinging upon an augmented area's medium whose back-to-back, converse-positioned, minimal surface serves as an external grease/oil extricating surface. Ergo, embodiments' cryogen can come in direct contact with, and impinge directly onto the internal cooling surface of the reservoir, whose surface is greater than the grease/oil contacting surface,
13.) In use, embodiments respond immediately, taking only seconds to effectively and thoroughly extract grease from stocks; With the continual-use embodiment, an average six liter pot with grease-bearing stock can be “treated,” meaning have its grease extracted, in mere seconds . . . less than fifteen seconds, in general,
14.) Embodiments are easy to manufacture,
15.) Embodiments are thorough and efficient, meaning that no visible remaining liquid grease remains after use (employing either the unaided or aided eye),
16.) Embodiments are easy to clean or remove insular grease; The continual-use embodiment can be instantly scraped of its insulating, attached grease in less than three seconds, then, reapplied to cooking stock for further grease extraction: The continuous-use embodiment is scraped continuously and easily,
17.) The continual-use embodiment can be turned upside-down during quick grease scraping, as can be necessary for quick cleaning of grease without dumping contents,
18.) Both kinds of embodiments function proportionately based on the amount of internal latent or ready-provided cold embodied within cryogen that can be sub-freezing; Meanwhile, ultra-limited functionality offered by but ice or cold water and latent cold within metal only cannot serve to effectuate normal grease removal operations.
19.) Both kinds of embodiments' use-times can be regulated: The colder the temperature at which the continual-use embodiment is stored, the longer it can function for use; Or the colder the cryogen pumped into the continual-use embodiment, or the lower degree to which cryogen is refrigerated, the better the embodiment's ability to react grease and/or oil,
20.) Continual and continuous embodiments both can employ a safe, non-toxic antifreeze liquid-as opposed to a solid source of cold energies; the antifreeze can desirably remain liquid and fluid down to a frigid −30 degrees Fahrenheit before solidifying, while such a fluid cryogen can impart ultra-exorbitant amounts of cold over and beyond a solid such as ice,
21.) Continual and continuous-use embodiments operate based on concepts and principles towards transmitting frigid agencies as a reactant to a second reactant, grease or oil,
22.) Continual and continuous-use embodiments intentionally function and are designed towards minimizing high-temperature heat conductance, to transmit frigid agencies, minimizing heat,
23.) Continual or continuous-use embodiments function to eliminate impedance that could slow or halt the desired reaction (grease/oil extrication),
24.) The continual and continuous-use embodiments altogether and completely eliminate the problem of Igloo Effect-related malfunctions, and related meltdowns,
25.) Continual and continuous embodiments both consistently employ and allow for a maximum of cold, frigid qualities that are a necessary reactant, by demanding an augmented cold-receiving area directly contiguous to the high-heat-contacting surface known as the external grease/oil-contacting/extricating surface that bears a smaller area (in relation to contacting/extricating surface),
26.) As the continual-use embodiment allows for immediate, fast, three-second expulsion of the insular grease attached to its external grease/oil extricating surface, continual grease extraction process proceeds unimpeded, continually: Meaning, little to no time is wasted removing insular grease,
27.) The continual and continuous-use embodiments are reliable: Excepting fluid cryogen moving about freely, both embodiments have no moving structural parts inside of their holding receptacle, but is, generally, one unit. The embodiments are manipulated into and about grease/oil by exterior sources,
28.) The continual-use embodiment is generally sealed shut, and child-tamper-proof,
29.) The continual-use embodiment illustrated is generally constructed of durable, all metal construction,
30.) The continual-use embodiment illustrated is of convenient size and can be easily stored in a conventional restaurant, cafeteria, or home freezer without taking more volume than a common ice-cube tray,
31.) The continual and continuous-use embodiments both solve several unrecognized, unforeseen, and ambiguous problems with prior art, namely, but not limited to, prior art's (U.S. Pat. No. 4,024,057): a.) minimal ability to transmit cold energies through hardened grease acting as an insulator, b.) requirement of having to heat the unit as a method of hardened grease expulsion, c.) employment of maximized high-temperature heat as a supposed reactant via maximized or augmented hot surface areas, only to destroy frigid-agencies that are the true reactants with grease causing it to harden, d.) an ultra-augmented area that contacts hot liquids (specifically, to conduct heat) and that is back-to-back with a minimized cooler area, hence, minimizing the desired reaction, e.) not recognizing or solving the Igloo Effect, and others herein specified,
32.) The continuous and continuous-use embodiments both remedy and solve an immense problem that the commercial and domestic worlds have long endured with regard to the troublesome nuisance of attempting to de-grease cooking stocks with antiquated methods, practices and procedures; De-greasing is no longer such a nuisance, but is fast, efficient, non-messy, safe, and healthy,
33.) The continuous and continual-use embodiments are absolutely not modifications of prior art, but are a “take-off” of the old cans of slushy-cold soda employed in circa 1960's,
34.) The continuous and continual-use embodiments both employ several herein-listed concepts and principles not seen, not suggested, but rather, ‘disallowed’ in former art's applicable reference (U.S. Pat. No. 4,034,057), by eliminating elements found in former art's claims (U.S. Pat. No. 4,034,057), such as, a.) an augmented surface area bearing a multiplicity of projections to maximize heat conductance from grease, b.) an axially extendable sidewall, c.) a minimized cold receptor, and while former art (U.S. Pat. No. 4,034,057) functions on complete opposing principles that cause extremely inferior results, the continual and continuous embodiments constitute a bona fide grease/oil extricator,
35.) Both continuous and continual-use embodiments offer advantages over prior art that have never heretofore been appreciated,
36.) Both continuous and continual-use embodiments solve and remedy inoperability of prior art, given the intent to extract grease/oil was born by both opposing continuous and continual-use embodiments,
37.) Both continuous and continual-use embodiments offer the successful implementation of an ancient (over thirty years) idea-the extraction of grease via frigid agencies—hilling grease and oil,
38.) Both continuous and continual-use embodiments not only employ concepts and principles not suggested in prior art (U.S. Pat. No. 4,034,057), but that diametrically oppose prior art's (U.S. Pat. No. 4,034,057) concepts and principles of function, despite the fact both can but seem to be working based on the same principles. Hence, our embodiments do not readily or easily lose their cold qualities that transcend the Cold Metal Effect latent in cold metal, only to commence operating as a heater; Instead, both embodiments function as a cooler thereafter, meaning the continuous-use embodiment can be employed for crude-oil-spills,
39.) Continuous-use embodiment can have back-up/auxiliary 1.) axle/spindle [either/or, or no back-up whatsoever with either/or variation], 2.) rotational sources such as hydraulic, electric, pneumatic, manual, 3.) interior or exterior refrigeration [either/or, or no back-up whatsoever with either/or variation],
40.) The embodiments' usages' save enormous amounts of monies,

These above are but some, though not all advantages: For example; the continual-use type embodiment can be employed to manually accumulate greases and or oils on a shoreline following an oil spill of crude oil. Both, continual or continuous embodiments can remove greases and or oils (as herein defined in glossary) from gasses or from off solids, as well as from liquids. The advantages are numerous, including uses as regards environmental issues.

### Conclusion, Ramifications, and Scope

Accordingly, the embodiments presented can be employed to collect greases and/or oils in, on, or about liquid, gaseous, or on solid media. They can accumulate floating grease or oil to isolate them, from liquid on which they float, causing them to adhere to themselves. Or, they can extricate greases and/or oils from gasses or from upon solid surfaces. Sometimes greases/oils are unwanted contaminants demanding expulsion: At other times, they are foods or other products that simply may demand separation and hardening for packing, as in the cases with creams and butters. The embodiments presented can be employed in various situations demanding the concepts and principles they embody. To meet those situations, the embodiments may be fabricated in various forms, sizes of varying materials, and weights.

Applicants provide here explanations of some of the various applications for use and varying embodiments. Albeit, for clarity, applicants redundantly stress that the first embodiment is predominantly for continuous usage, generally, while the second and third embodiments are generally for continual usage. Nonetheless, cumulatively, of and between the embodiments, principles and concepts embodied remain unchanged.

And while the applicants' above descriptions contain many specificities, these should not be construed as limitations on the scope of the invention, but rather, as exemplifications of preferred embodiments thereof. Many other variations are possible, some being specified herein.

### Continual-use Embodiment: in General

Generally, the continual-use embodiment is basically but a reservoir comprising its internal cooling surface, and a converse-situated, contiguous, back-to-back, external grease/oil-contacting extricating surface that contacts grease and oil. A Grease/Oil Cooling Configuration is always employed. A cold, fluid cryogen normally contacts the internal surface. Generally, the entire embodiment is refrigerated in a conventional freezer prior to use, providing the embodiment is so large that it cannot be accommodated therein, demanding another means for cooling the fluid cryogen. This embodiment is a rather simple, generally hand-manipulated embodiment for kitchen use, that can be cast into one, single part, excepting the fluid cryogen that is added. Albeit, larger, industrial-type versions can be interiorly-cooled and not hand-manipulated, we contemplate.

### Continuous-use Embodiments: in General

Generally, the continuous-use embodiments, employ the same fundamental principles as the continual-use embodiments. The-continuous-use embodiments are also basically a reservoir comprising an internal cooling surface, and a back-to-back, contiguous, converse-situated external grease/oil-contacting extricating surface that contacts grease and oil. A fluid cryogen inside the reservoir contacts the internal cooling surface. Generally, cryogen is either externally refrigerated, then pumped into and out from the reservoir; Or, and alternatively, cryogen is refrigerated internal of reservoir. Either of these variations can be used as ‘back-up’/auxiliary or primarily. While these embodiments (as illustrated throughout this application) are in the shape of a cylinder or drum-barrel that rotates on its axis, thereby allowing for continuous grease/oil collection, the embodiment can take on other shapes, and may not rotate, but may reciprocate, or move in other directions, such as zig-zag, we contemplate. A Grease/Oil Cooling Configuration is always employed.

Both continuous and continual-use embodiments possess the following:
1. A minimized external grease/oil extricating surface
2. A maximized internal cooling surface (in proportionate relationship to its converse-situated external grease/oil extricating surface)
3. A part configuration designed to be ‘a cooler,’ not a ‘heater,’ to fight destructive heat conduction that grossly impedes grease/oil extrication
4. Attributes that completely eliminate the substandard use of ice or cold water as cooling aids, thereby eliminating several problems connected to ice-usage
5. Concepts and principles that can be applied for either continual or continuous use (not seen in prior art [U.S. Pat. No. 4,024,057])
6. The ability to be readily and immediately ridded of accumulated grease/oil that acts as an insulator, blocking further grease extrication
7. The attribute of functioning not merely on latent cold imparted to metal structural parts, but depending on the ultra-potent absence of heat (cold) bound within fluid cryogen combined with unique structure
8. The ability for fluid cryogen to freely move about, directly contacting the very back side of external grease/oil exterior surface, because that back side (internal cooling surface) serves as an interior reservoir wall to contain fluid cryogen (within reservoir)
9. The ability to be moved about without spilling fluid cryogen
10. The ability to hold a vacuum through which thermal temperatures cannot easily permeate
11. The ability to not only retain a ready supply of frigid agencies (cold) within fluid cryogen, but the ability to exhaust and provide them (cold agencies) upon immediate demand
12. The attribute of easy-usage
13. The attribute of having no moving internal parts, besides fluid cryogen
14. The ability to be easily fabricated
15. The ability to be easily transported
16. The attribute of being easily adaptable to various situations
17. The ability to take on various shapes to accommodate specific needs

### Two General Variations: Continual/Continuous

Although the embodiments possess the same basic, general parts that are consistently configured from one embodiment to the next, embodiments' parts simply take slightly different form from embodiment to embodiment. And certain elements are either added or removed, accordingly. Below, applicants divide and identify the illustrated embodiments, categorized thusly:

First Embodiments—A.-Type—Continual-Use: Contemplated variations identified by lower-case letter ‘numbering’),

Second Embodiments—B-Type—Continuous-Use: Contemplated variations identified by lower-case letter ‘numbering’), as follows:
A.-Type Embodiment-Continual-Use: Generally; Self or manual-scraping, non-axially-rotated,
1.) Permanently-housed cryogen (illustrated)—embodiment (Including Cryogen) is refrigerated exteriorly, in conventional freezer—generally for domestic, restaurant, cafeteria use—manually scraped
2.) Continually-pumped cryogen (not illustrated)—cryogen exteriorly-refrigerated and pumped into reservoir upon demand
3.) Continuously-pumped cryogen (not illustrated)—cryogen exteriorly refrigerated
4.) Continuously-pumped or pressured cryogen (not illustrated)—cryogen needs no refrigeration
5.) Permanently housed cryogen (not illustrated)—cryogen internally refrigerated inside reservoir
B-Type Embodiment—Continuous-Use: Generally; Self-Scraping, axially-rotating, generally for Industrial-use such as meat packing, extrication of crude oil from oil spills, environmental, and other uses where continual use grease/oil is necessary—variations include, but are not limited to the following:
1.) Permanently-housed cryogen (illustrated)—cryogen interiorly-refrigerated in reservoir
2.) Continually pumped cryogen (illustrated)—cryogen exteriorly-refrigerated and pumped into reservoir upon thermal demand
3.) Continuously pumped cryogen(illustrated)—cryogen exteriorly-refrigerated and pumped continually
4.) Continuously pumped or pressured cryogen(illustrated)—cryogen needs no refrigeration (such as liquid nitrogen)
5.) Continually pumped or pressured cryogen (illustrated)—cryogen needs no refrigeration-pumped upon thermal demand

### Some Further Embodiment Contemplations:

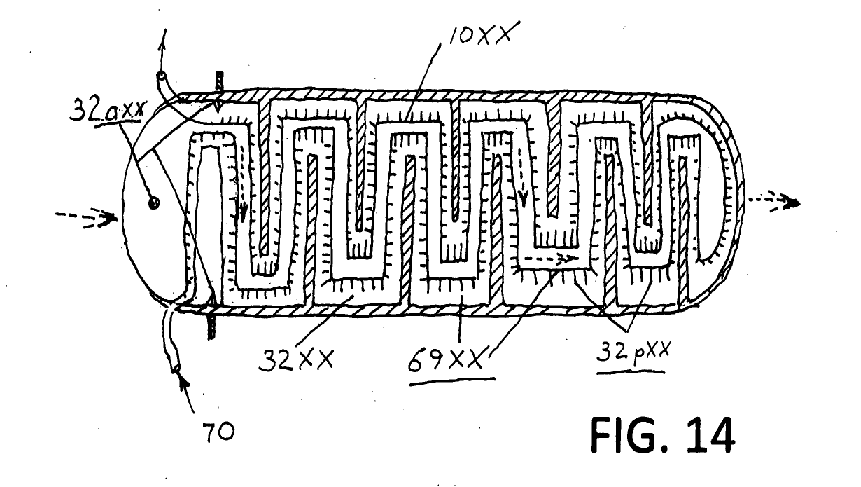

a.) Use of internal refrigeration with a continuous-use, rotating, jacketed version similar to the herein-specified third embodiment, further including interior-of-reservoir-refrigeration,
b.) Use of interior refrigeration with axle in any type of the three specified embodiments,
c.) Use of any of all three embodiments, continual or continuous-use, on a floating vessel such as a boat to accumulate contaminant such as crude oil,
d.) Use of the continuous-use embodiments wherein the rotating cylinder-like reservoir roll on a hard surface, such as a highway or ‘freeway,’ when the reservoir ‘doubles’ as a wheel that contact, or nearly contacts the road surface, similar to an asphalt roller, to accumulate environmental bulk spills such as crude oil,
e.) Use of the embodiment of a hand-held size, pancake-shaped embodiment, appropriate for, for example, oil-clean-up in small ponds or on sea-shores after oil-spills or following a pipe-line burst; whereby a human can hand-hold the embodiment connected to a small, conventional refrigerator source in order to maintain cryogen continuously or continually pumping into said embodiment, as a portable, continually-cold embodiment that can be hand-scraped of accumulated contaminants,
f.) Use of a contemplated embodiment in oil-bearing streams, brooks, or rivers following a crude-oil pipe leak, for example, whereby a linear-type embodiment in modular form can be straddled across from water-edge to water-edge, down-stream of pollutant source, to continually remove the pollutants; for scraping accumulated pollutants, a reciprocating (from bank-to-bank) collector can be manipulated,
g.) Use of continual embodiment, not rotating, but using movement of boat or floating vessel when embodiment, in particular, the reservoir, takes any applicable shape, such as a rectangular shape, that accumulates onto itself greases and/or oils contacting media demanding oil/grease removal,
h.) Use of first embodiment herein specified of a larger size whereby greases/oils are sprayed or otherwise thrown onto the external grease/oil-contacting extricating surface, thereby, no dipping of entire embodiment into a liquid body is required,
i.) Use of another embodiment whereby grease/oil-bearing media (whether gas, or liquid) is directed into a tube shaped element surface/flow director 69aXX that directs media flow onto an external grease/oil-contacting/extricating surface 10XX as illustrated in FIG. 14 (dashed arrows), whereby, the inside of flow director 69aXX accommodates untreated media; media flows through the inside of director 69aXX (shaped of any shape, square, round, triangle, or other). Surface 10XX accumulates onto itself, inside the tube, greases/oils that otherwise can be contaminants such as burned hydrocarbon residues, because, contacting/extricating surface 10XX, of any shape, forms a bifacial/multi-functioning interior/exterior element/wall 69XX that may take on any shape to allow the media to contact surface 10XX: Fluid cryogen 70 is pumped through (in and out) wall 69XX (slid arrows indicate flow). When grease/oil-bearing media passes through, grease/oil is thereby “knocked-out” or, otherwise, removed of greases/oils (or variants specified in glossary), then, accumulated onto the contacting/extricating surface 10XX. In the case where the media are gases, such as burned hydrocarbons often mingled with unburned hydrocarbons, then steam is injected into the gaseous media with an injector 32aXX whereby the untreated media mingles with steam prior to its contacting surface 10XX, causing a mingling of steam with burned hydrocarbons, further causing condensation (otherwise ‘knock-out’/precipitation) upon contact with the extricating surface, along with surface 10's tendency to accumulate greases and/oils. Formed condensation or precipitation in the form of steam mingled with the grease/oil (as herein defined), is then collected in an additional reservoir (not shown) or otherwise, ‘knock-out-pot,’ rather than being exhausted airborne. Contacting/extricating surface 10XX is a comprisal of an element/wall 69XX that further comprises an internal cooling surface 32XX bearing surface augmentations to augment cooling (pins 32pXX illustrated). Contacting/extricating surface 10XX physically encounters and contacts media containing greases and/or oils. Vaporized greases and/or oils (and non-vaporized) in gasses are treated by steam introduction via a steam nozzle 10aXX to combine vaporized H²O with gaseous media prior to contacting surface 10XX. Wall of cylinder shape may be jacketed as the herein third embodiment (not shown).
j.) Use of any of the herein-specified three embodiments where removal of accumulated grease or oil further includes use of a reciprocal or otherwise mechanical scraper such as a windshield wiper or side-to-side movement of the scraper,
k.) Use of the herein-specified second and/or third embodiment further including paddles, as of a paddle boat, accompanied onto the rotating reservoir to serve as a means of propulsion of a floating vessel, whereby the cylindrical-shaped reservoir comprises paddles: For example this embodiment can be employed on floating, unmanned, radio-controlled paddle vessels, directed to clean up oil spills, Use of an bagger employed,
l.) Use of a bagger employed with the above item ‘k.)’ whereby automatically scraped-off, accumulated grease/oil is automatically deposited and sealed into bags that are left to float to be easily picked up thereafter,
m.) Use of a single bearing on second herein embodiment when end, shell wall 80aT and 80bT are designed to disallow fluid into embodiment when spindles are employed, the end of spindle, in other words, would be capped by the end, shell wall,
n.) Use of a harmonic drive with second and third herein embodiments,

As the reader may see, numerous physical changes can be made in the three herein specified embodiments without altering the concepts and principles embodied therein as appended in the claims. Therefore, embodiments can take on various shapes and variations (various sizes, materials, and forms). Accordingly, the scope of the invention should be determined not by the embodiments illustrated or mentioned, but by the appended claims and their legal equivalents.

### Emphases on Impact of Demands Being Met—Health

Health and Grease Removal—Difficult to fathom is that America is now embroiled in a near endemic level of heart disease and obesity; Of the known culprits are excess fat, oil, and grease consumption. The field of chemistry dictates that the best way to isolate chemicals (such as grease/oil) from solution is by way of solidifying either the wanted, or unwanted, components, then, extricating solid from a liquid, not liquid from a liquid. To change the viscosity of unwanted grease/oil is a known, preferred method, yet, a simple device for removing grease and or oil from foods by hardening grease or thickening oil via a cold reaction is not readily available on the market, despite magnitude of demand. The herein-specified embodiments can quite simply help to remove harmful fats, oils, and greases from the American diet, whether removal is from a simple can of soup or a 10,000.-liter vat in a meat processing plant. The configuration revealed and embodied in the embodiments mentioned here make ease of extricating grease/oil either continually (successively), or continuously (perpetually, not stopping).

### Losses due to Poor Diet-Health-Care Costs

Impacts and ramifications due to fat-related, poor-to-deathly health are not only medically related and family traumatizing. Financially speaking, the related impact of eliminating even a fraction of fats from America's diet would eliminate, collectively, America paying fortunes in fat, grease, and oil-related health care. Market-available embodiments of a device to effectively, quickly, and easily remove grease and oil are absolute preventive-care necessities whose collective use would save collective dollars. Those embodiments, applicants hold, can be clearly envisioned in this specification.

Emphases on Impact of Demands being Met—Environment

Alaska's Prince William Sound experienced the infamous and calamitous Exxon Valdez oil spill. The date; 24 Mar. 1989. It was one of the most devastating human-caused environmental sea disasters of all time. However, that spill is low-ranking on the list of the world's largest oil spills in terms of oil volume released. About 40 million liters (10.8 million U.S. gallons) of crude oil spilled into the near pristine sea by the Valdez. ‘Crude’ eventually covered 11,000 square miles. Accessibility to the Valdez spill site was by helicopter and boat only.

On the topic, the continual-use embodiment can be conventionally mounted on sea-going vessels to extricate crude oil. After studying the Valdez case and other such incidents, applicants here imagine the following in hind-sight: Had the Valdez clean-up effort and crew not employed chemical ‘surfactants,’ ‘dispersants,’ and ‘solvents’ to thin and dissipate the oil, thereby spreading it, clean-up could have had different results. In any case, applicants imagine any oil-spill's oil-slick parameters first being isolated with buoyant barrier lines beyond which oil slick cannot spread. Then, several of the easily-transportable embodiments illustrated in this specification, are shipped to the spill sight and quickly affixed to smaller sea-going vessels that can transport oil. The armada commences a continuous oil extrication/collection campaign whereby much of the oil can be recovered and refined. Much of the “lighter-end hydrocarbons” naturally flee airborne (dissipating into the air), leaving heavier hydrocarbons than can be easily extricated with the embodiment in a continuous fashion. In the case of the Valdez, results and costs were abysmal.

### Oil Spills now and in the Future

Moreover, many Americans are near phobic of oil-drilling off our coastal waters, imagining only calamitous or disastrous catastrophes despite our world's-strictest environmental policies. The fact is, albeit, the threats of oil tanker wrecks or accidents such as the Valdez still loom largely. Drilling fears drive America to buy oil from other countries having little to no environmental drilling controls, thereby aiding, abetting, and promoting global environmental risks by these very procurements. Imported oil increases shipping demand, hence, greater chances of oil-spills. Nevertheless, the herein-specified embodiment (and variations) can help remedy this global environmental oil dilemma. Applicants are convinced that the embodiments illustrated here can help save not only our environment, but significant needless monies lost as well. Additionally: Each of the above embodiments differ in shape and use-applications, one from the other. Continuously removing oil from an oil spill threatening a coast line and millions of sea creatures (some being a food supply), or removing harmful fat from peoples' diets, are both endearingly critical to applicants. The effects or ramifications of both embodiments that embody the same principals and concepts shall be the removal of grease, fat, and oils to better the lives of all.

1. A grease and/or oil removal system/device for the bulk removal of greases and/or oils from liquid, gaseous, and from off solid media, primarily by the exchange of quantities of heat bound within and about said greases and/or oils, said exchange urged by a substantially cold exterior portion of a fluid-holding receptacle that, externally of said fluid-holding receptacle, accumulates onto itself depositions of said greases and/or oils extricated from said media, said holding receptacle receiving cold from fluid coolant accommodated within said fluid-holding receptacle, said system/device comprising:
A. a reservoir for, primarily, providing an absence of heat born by a substantially frigid, fluid cryogen internally accommodated by said reservoir comprising;
1.) an interior/exterior-type wall of said reservoir, one side, otherwise surface, of said wall positioned internally of said reservoir, the other side, otherwise surface, of said wall, positioned externally of said reservoir, said wall comprising;
a.) an internal cooling surface positioned inside of said reservoir, for contacting substantially frigid, said fluid cryogen accommodated inside of, and contained by, said reservoir, in order for the cryogen to impinge directly upon, and transfer substantial cold directly to, the cooling surface that further conducts cold to the exterior side of said wall, namely;
b.) an external grease/oil-contacting/extricating surface located exteriorly to said reservoir, connected contiguously to said internal cooling surface positioned relatively back-to-back with, and conversely to, said external grease/oil-contacting extricating surface, each of the two wall surfaces complementing the other in order for the wall's contacting/extricating surface to contact, extricate, remove,
c.) collect, accumulate onto itself, and be expulsed of said greases and/or oils;
said wall, in relation to the reservoir's entire structure, disposed where said wall can be subjected to direct contact-exposure to said greases and/or oils, in a predetermined location; said wall further comprising a configuration consisting of;
1.) said internal cooling surface bearing a greater overall surface area in direct proportional relationship to, and with,
2.) said external grease/oil-contacting/extricating surface bearing a lesser surface area that of the cooling surface,
the greater surface area comprising a plurality of area-augmenting, aberrational surface protuberancies and voids for qualitatively and quantitatively augmenting cold intensity and cold flow rate sufficient for substantially cooling the extricating surface, said configuration thereby augmenting cold conductance conducted from and by said fluid cryogen to said grease/oil-contacting/extricating surface via said cooling surface, hence, a conduction of cold to said greases and/or oils; said wall further comprising predetermined material having at least some thermal-conduction qualities to conduct cold, said wall being contiguous to the reservoir's remaining cryogen-containing structure constructed of either non-thermal-conducting or thermal-conducting material, said reservoir further comprising a predetermined size and shape;
whereby, said system/device, upon contact with said greases and/or oils, can commence accumulating said greases and/or oils, said system/device causing a reaction by which viscosities of said greases and/or oils become elevated by their heat exchange, further causing said greases and/or oils, within the time-span duration of less than one second, to commence being extricated and removed from said media, to adhere, to be collected, and accumulated onto the contacting/extricating surface, thereby affording direct grease/oil expulsion from off the contacting/extricating surface, which is easier than directly removing either liquid or more viscous said greases and/or oils from liquid or non-liquid media; and, moreover, the configuration of the larger-sized said internal cooling surface integral with the lesser-sized said external grease/oil-contacting/extricating surface is an applicable faculty allowing and providing for advantages that would not otherwise exist if said configuration were reversed, or if the sizes of the contacting surface and cooling surface were equal in area, some of which are;
a.) an otherwise quicker and longer-sustained reaction of viscosity-heightening of said greases and/or oils via frigid cold, due to the greater availability of frigid cold,
b.) an otherwise longer duration of time available for the attachment and accumulation of said greases and/or oils onto said contacting/extricating surface, thereby allowing for an otherwise facilitation of the removal and expulsion of said greases and/or oils accumulated onto said contacting/extricating surface, to promote further extrication,
c.) an otherwise expedition and facilitation of extricating said greases and/or oils from media,
d.) an otherwise allowance for continual or continuous usage of said system/device.

2. The system/device of claim 1 wherein said plurality of aberrational surface protuberancies are fins.

3. The system/device of claim 1 wherein said plurality of aberrational surface protuberancies are pins.

4. The system/device of claim 1 wherein said predetermined shape of said reservoir is cylindrical,.at least one end of said reservoir being flat and comprising said wall.

5. The system/device of claim 1 further including a vacuum within said reservoir, to displace volume otherwise occupied by atmospheric pressures of ambient air, the displacement not including the displacement of said fluid cryogen that remains present within said reservoir with said vacuum.

6. The system/device of claim 1 further including a handle to manipulate said reservoir into, onto, or about said media.

7. The system/device of claim 1 wherein said fluid cryogen comprises a non-toxic, propylene glycol/water combination.

8. The system/device of claim 1 wherein said predetermined material of said wall is a copper-based comprisal.

9. The system/device of claim 1 wherein said predetermined material of said wall is an aluminum-based comprisal.

10. The system/device of claim 1 wherein said remaining cryogen-containing structure is comprised of stainless steel.

11. The system/device of claim 1 wherein said reservoir is comprised entirely of one, single part.

12. The system/device of claim 1 wherein said reservoir further comprises an intermittent-contacting spatula for expulsion of thermal resistors that inhibit and impede said reaction, said resistors being said greases and/or oils, from off said external grease/oil-contacting/extricating surface, said spatula comprised of a material that cannot mar, gouge, or scratch the extricating surface upon contact.

13. The system/device of claim 1 wherein said fluid cryogen is a conventional-freezer-cooled-cryogen.

14. The system/device of claim 1 wherein the predetermined shape of said reservoir is cylindrical, for allowing axially-rotational motion of said reservoir into said media, said wall conforming to the cylindrical shape, therefore, a cylindrical said external grease/oil-contacting/extricating surface back-to-back with internal cooling surface being generally cylindrical, said cylindrical shape further shaped with end, shell walls that are generally perpendicular to the length of said reservoir.

15. The system/device of claim 14 wherein said reservoir is axially rotated by conventional motor power to cause said reservoir to be exposed to greases and/or oils in, on, or about said media.

16. The system/device of claim 15 further including a conventional transmission to transmit power from a conventional motor to rotate said reservoir.

17. The reservoir of claim 14 further including a hollow axle to allow for axially-rotational motion of said reservoir, said hollow axle being partially hollow to allow ingress and egress flow of said fluid cryogen into and out from said reservoir, and to allow for usage of a double or, optionally, a single trunnion as in the case of hanging said reservoir from starboard and port sides of a floating vessel, and for being a vertical lifting point of said reservoir.

18. The reservoir of claim 14 further including a set of hollow spindles to allow for axially-rotational motion of said reservoir, said hollow spindles being hollow to allow ingress and egress flow of said fluid cryogen, and for being vertical lifting points of said reservoir.

19. The system/device of claim 14 further including a vacuum within said reservoir, to displace volume otherwise occupied by atmospheric pressures of ambient air, the displacement not including the displacement of said fluid cryogen that remains present within confines of said reservoir.

20. The system/device of claim 14 wherein said fluid cryogen is cooled by conventional refrigeration elements internal of said reservoir.

21. The system/device of claim 14 wherein said reservoir is comprised entirely of one, single part.

22. The system/device of claim 14 further including a grease and/or oil scraper that is a doctor-type blade for scraping off said greases and/or oils that have been extricated and accumulated onto said extricating surface.

23. The system/device of claim 14 further including a pressurized-fluid nozzle for pressurizing off accumulated greases and/or oils from off said extricating surface by pressurized fluid acquired conventionally.

24. The system/device of claim 14 further including a vacuum nozzle for vacuuming or sucking up accumulated greases and/or oils from off said extricating surface by vacuum negative pressure acquired conventionally.

25. The system/device of claim 14 wherein said fluid cryogen is cooled by a conventional refrigeration evaporator coil internal of said reservoir.

26. The system/device of claim 14 wherein said fluid cryogen is externally cooled by standard, conventional refrigeration components, external of said reservoir, said fluid cryogen being pumped into and out from said reservoir to accommodate external cooling.

27. The system/device of claim 14 wherein said wall further comprises a cooling/surface jacket for conducting externally-cooled fluid cryogen through said cooling/surface jacket, from a jacketed end, shell wall of and through said reservoir, to another jacketed end, shell wall, of a jacketed end, shell wall pair, said cooling/surface jacket being further comprised of said external grease/oil-contacting/extricating surface, sandwiching said fluid cryogen within the jacket, and comprising said internal cooling surface, forming said wall.

28. The system/device of claim 27 wherein said jacketed end, shell wall pair comprise wall passages as conduits for said fluid cryogen to ingress and egress cooling/surface jacket of said reservoir via a set of hollow spindles or otherwise optional, a hollow axle.

29. The system/device of claim 27 wherein said reservoir is axially rotated by conventional motor power to cause said reservoir to be exposed to greases and/or oils in, on, or about said media.

30. The system/device of claim 27 further including a conventional transmission to transmit power from a conventional motor to rotate said reservoir.

31. The system/device of claim 27 further including a hollow axle to allow for axially-rotational motion of said reservoir, said hollow axle being partially hollow to allow ingress/egress flow of said fluid cryogen, and to allow for usage of a double or, optionally, a single trunnion as in the case of hanging said reservoir from starboard and port sides of a floating vessel, and for being a vertical lifting point of said reservoir.

32. The system/device of claim 27 further including a set of hollow spindles to allow for axially-rotational motion of said reservoir, said hollow spindles being hollow to allow ingress/egress flow of said fluid cryogen, and for being vertical lifting points of said reservoir.

33. The system/device of claim 27 further including a vacuum within said reservoir, to displace volume otherwise occupied by atmospheric pressures of ambient air, the displacement not including the displacement of said fluid cryogen that remains present within said reservoir, with said vacuum.

34. The system/device of claim 27 wherein said reservoir is comprised entirely of one, single part.

35. The system/device of claim 27 further including a grease and/or oil scraper that is a doctor-type blade for scraping off said greases and/or oils that have been extricated and accumulated onto said extricating surface.

36. The system/device of claim 27 further including a pressurized-fluid nozzle for pressurizing off, or blasting, accumulated greases and/or oils from off said extricating surface by pressurized fluid acquired conventionally.

37. The system/device of claim 27 further including a vacuum nozzle for vacuuming or sucking up accumulated greases and/or oils from off said extricating surface by negative pressure acquired conventionally.

38. The system/device of claim 27 wherein said fluid cryogen is externally cooled by standard, conventional refrigeration components, external of said reservoir, said fluid cryogen being pumped into and out from said reservoir to accommodate external cooling.

39. A grease and/or oil removal system/device for the removal of greases and/or oils from media, primarily by the exchange of quantities of heat bound within and about said greases and/or oils, said exchange primarily accomplished by a substantially cold exterior portion of a holding receptacle that, externally of said holding receptacle, accumulates onto itself depositions of said greases and/or oils from said media, said holding receptacle receiving cold from a fluid coolant accommodated within said holding receptacle, said system/device comprising:
A. a reservoir means internally accommodating a substantially cold fluid cryogen means, said reservoir means comprising;
1.) a wall means of said reservoir means comprising;
a.) an internal cooling surface means for contacting said substantially cold fluid cryogen means, in order for the cryogen means, impinging directly upon, and transferring substantial cold to the cooling surface means to further conduct cold to the exterior side of said wall means comprising;
b.) an external grease/oil-contacting/extricating surface means located exterior to said reservoir means, and connected contiguously to said internal cooling surface means, in order for said contacting/extricating surface means to contact, extricate, remove, collect, and accumulate onto itself said greases and/or oils;
said wall means, in relation to a remaining cryogen-containing structure means of said reservoir means, excluding said wall means, disposed about said reservoir means where said wall means can be subjected to direct contact-exposure to said greases and/or oils, in a predetermined location; said wall means further comprising a configuration consisting of;
1.) said internal cooling surface means, substantially augmented, and bearing a greater overall surface area in direct proportional relationship to, and with,
2.) said external grease/oil-contacting/extricating surface means that bears a lesser surface area;
the greater, and augmented surface area comprising a plurality of aberrational surface protuberancies and voids for qualitatively and quantitatively augmenting cold intensity and rate sufficient for cooling the extricating surface means, said configuration thereby augmenting conductance of cold conducted by said fluid cryogen means to said grease/oil-contacting/extricating surface means via said cooling surface means, hence, a conduction of cold to said greases and/or oils originating from said fluid cryogen means; said wall means comprising predetermined material having at least some thermal-conduction quality to conduct cold, said wall means being contiguous to the remaining cryogen-containing structure means of the reservoir means, the structure means constructed of either non-thermal-conducting or thermal-conducting material, said reservoir means further comprising a predetermined size and shape;
B. a contacting means for maneuvering said reservoir means into, onto, or about said media,
whereby, said reservoir means can accumulate said greases and/or oils when said reservoir means is physically located in, on, or about, and subjected to, grease/oil-bearing media, said reservoir means causing a reaction by which viscosities of said greases and/or oils become elevated by their heat exchange to become cooler, further causing said greases and/or oils, within the time-span duration of less than one second, to commence being extricated and removed from said media, to adhere, to be collected, and accumulated onto the contacting/extricating surface means, thereby affording direct grease/oil expulsion from off the contacting/extricating surface means, which is easier than directly removing either liquid or more viscous said greases and/or oils, from liquids or non-liquid media; and, moreover, the configuration of the larger-sized said internal cooling surface means integral with the lesser-sized said external grease/oil-contacting/extricating surface means is an applicable faculty allowing and providing for advantages that would not otherwise exist if said configuration were reversed, or if the sizes of the contacting/extricating surface means and cooling surface means were equal in area, some said advantages being;
a.) an otherwise quicker and longer-sustained reaction of viscosity-heightening of said greases and/or oils via frigid cold, due to the greater availability of frigid cold,
b.) an otherwise longer duration of time available for the attachment and accumulation of said greases and/or oils onto said contacting/extricating surface means, thereby allowing for an otherwise facilitation of the removal and expulsion of said greases and/or oils accumulated onto said contacting/extricating surface means, to promote further extrication,
c.) an otherwise expedition and facilitation of extricating said greases and/or oils from media,
d.) an otherwise allowance for continual or continuous usage of said system/device.

40. The system/device of claim 39 wherein said contacting means for manipulating said reservoir means comprises a handle for hand-manipulation of said reservoir means.

41. The system/device of claim 39 wherein said fluid cryogen means is a conventional-freezer-cooled-cryogen.

42. The system/device of claim 39 further including a spatula means for expelling said greases and/or oils from off said external grease/oil-contacting/extricating surface means, constructed of a material that will not gouge, mar, or otherwise scratch the extricating surface means.

43. The system/device of claim 39 wherein said reservoir means is generally cylindrically shaped, one of whose exterior ends is planar and circular shaped, the planar end comprising said wall means.

44. The system/device of claim 39 further including a vacuum means by which atmospheric pressure is evacuated from within said reservoir means in space otherwise occupied by ambient air, for preventing unwanted thermal qualities.

45. The system/device of claim 39 wherein said predetermined material of said reservoir means is a combination of stainless steel and copper, in order for said wall means being constructed of primarily copper-based metal, and said remaining cryogen-containing structure means of said reservoir means being constructed of stainless steel to thwart thermal conductivity.

46. The system/device of claim 39 wherein said reservoir means is entirely constructed as one, single part comprising said wall means and said remaining cryogen-containing structure means of said reservoir means.

47. The system/device of claim 39 wherein the predetermined shape of said reservoir means comprises a cylindrical shape, for allowing axially-rotational motion of said reservoir means, said wall means conforming to the cylindrical shape, hence, a cylindrical said wall means, said cylindrical shape further shaped with a pair of end, shell walls that are generally perpendicular to the length of said wall means.

48. The system/device of claim 47 wherein said reservoir means is axially rotated by a conventional power motor to cause said reservoir means to be exposed to greases and/or oils in, on, or about said media.

49. The system/device of claim 48 wherein said reservoir means further includes a conventional transmission to transmit power from a said conventional power motor to rotate said reservoir means.

50. The system/device of claim 47 wherein said reservoir means further includes a hollow axle to allow for axially-rotational motion of said reservoir means, said hollow axle being partially hollow to allow ingress/egress flow of said fluid cryogen means, and to allow for usage of a double or, optionally, a,single trunnion as in the case of hanging said reservoir means from starboard and port sides of a floating vessel, and for being a vertical lifting point of said reservoir means.

51. The system/device of claim 47 wherein said reservoir means further includes a set of hollow spindles to allow for axially-rotational motion of said reservoir means, said hollow spindles being hollow to allow ingress/egress flow of said fluid cryogen means, and for being vertical lifting points of said reservoir means.

52. The system/device of claim 47 wherein said reservoir means further includes a vacuum within said reservoir means, to displace volume otherwise occupied by atmospheric pressures of ambient air, the displacement not including the displacement of said fluid cryogen means that remains present within said reservoir means with said vacuum.

53. The system/device of claim 47 wherein said fluid cryogen means comprises a non-toxic, propylene glycol/water combination.

54. The system/device of claim 47 wherein said reservoir means is comprised entirely of one, single part.

55. The system/device of claim 47 wherein said expulsion means comprises a grease and/or oil scraper that is a doctor-type blade for scraping off said greases and/or oils that have been extricated and accumulated onto said extricating surface means.

56. The system/device of claim 47 wherein said expulsion means comprises a fluid-pressure nozzle for blasting accumulated greases and/or oils from off said extricating surface means by pressurized fluid acquired conventionally.

57. The system/device of claim 47 wherein said expulsion means comprises a vacuum-type nozzle to suck accumulated greases and/or oils from off said extricating surface means by negative pressure acquired conventionally.

58. The system/device of claim 47 wherein said fluid cryogen means is cooled by a conventional refrigeration evaporator coil internal of said reservoir means.

59. The system/device of claim 47 wherein said fluid cryogen means is externally cooled by standard, conventional refrigeration components, external of said reservoir means, said fluid cryogen means being pumped into and out from said reservoir means to accommodate external cooling.

60. The system/device of claim 47 wherein said wall means further comprises a cooling/surface jacket for conducting externally-cooled fluid cryogen means through said cooling/surface jacket, from one end of said wall means to the other, via a pair of jacketed end, shell walls, said wall means sandwiched between said jacketed end, shell walls, said cooling/surface jacket being further comprised of said external grease/oil-contacting/extricating surface means sandwiching said fluid cryogen means within said cooling/surface jacket further comprising said internal cooling surface.

61. The system/device of claim 60 wherein said jacketed end, shell walls comprise passages as conduits for fluid cryogen means, for ingress and egress of said fluid cryogen means into and out from said cooling/surface jacket of said wall means of said reservoir means.

62. The system/device of claim 60 wherein said contacting means for rotating said reservoir means comprises a conventional motor.

63. The system/device of claim 62 wherein said contacting means for rotating said reservoir means further comprises a conventional transmission to transmit power from a conventional motor to said reservoir means.

64. The system/device of claim 60 further including a hollow axle to allow for axially-rotational motion of said reservoir means, said hollow axle being partially hollow to allow ingressiegress flow of said fluid cryogen means, and to allow for usage of a double or, optionally, a single trunnion as in the case of hanging said reservoir means from starboard and port sides of a floating vessel, and for being a vertical lifting point of said reservoir means.

65. The system/device of claim 60 further including a set of hollow spindles to allow for axially-rotational motion of said reservoir means, said hollow spindles being hollow to allow ingress/egress flow of fluid cryogen means, and for being vertical lifting points of said reservoir means.

66. The system/device of claim 60 further including a vacuum within said reservoir means, to displace volume otherwise occupied by atmospheric pressures of ambient air, the displacement not including the displacement of said fluid cryogen means that remains present within said reservoir means, with said vacuum.

67. The system/device of claim 60 wherein said reservoir means is comprised entirely of one, single part.

68. The system/device of claim 60 wherein said expulsion means comprises a grease and/or oil scraper that is a doctor-type blade for scraping off said greases and/or oils that have been extricated and accumulated onto said extricating surface means.

69. The system/device of claim 60 wherein said expulsion means comprises a pressurized fluid nozzle for pressurizing off, with fluid, accumulated greases and/or oils from off said extricating surface means by pressure acquired conventionally.

70. The system/device of claim 60 wherein said expulsion means comprises a vacuum nozzle for vacuuming or sucking up accumulated greases and/or oils from off said extricating surface means by vacuum negative pressure acquired conventionally.

71. The system/device of claim 60 wherein said fluid cryogen means is externally cooled by standard, conventional refrigeration components, external of said reservoir means, said fluid cryogen means being pumped into and out from said reservoir means, to accommodate external cooling.

72. A method for removing greases and/or oils from media by the exchange of quantities of heat bound within and about said greases and/or oils, thereby causing a deposition of said greases and/or oils onto a frigid-cold exterior portion of a holding receptacle interiorly receiving its cold from a coolant accommodated within said holding receptacle comprising:
A. providing a reservoir containing said coolant, said reservoir comprising a multi-functioning, interior/exterior wall, one side of said wall functioning internally of said reservoir as an internal cooling surface receiving cold from said coolant, the other side of said wall functioning externally of said reservoir as an external grease/oil-contacting/extricating surface, the cooling surface consisting of a greater overall surface area in proportion to the overall surface area of the external grease/oil-contacting/extricating surface having a lesser area,
B. manipulating said reservoir into, onto, or about media where said reservoir is being directly subjected, by contact with, and to, said greases and/or oils, thereby causing said external grease/oil-contacting/extricating surface to accumulate said greases and/or oils from off which they may be further expelled,
whereby, contacting said greases and/or oils with the frigid-cold extricating surface causes the viscosities of said greases and/or oils to elevate, thereby causing said greases and/or oils to be extricated and removed from media, and to be adhered, collected, and accumulated onto the extricating surface, further allowing for the expulsion of said greases and/or oils from off said extricating surface, actions substantially less work-intensive, quicker, and less messy than otherwise removing liquid or semi-liquid greases and/or oils directly from liquids, gasses, or solids.

73. The method of claim 7? further including refrigerating said coolant in a conventional freezer by storing said reservoir, containing said coolant, in said conventional freezer.

74. The method of claim 72 wherein manipulating said reservoir is by a handle in order to contact said media.

75. The method of claim 72 further including expelling said greases and/or oils from off said external grease/oil-contacting/extricating surface by scraping said greases and/or oils with a spatula, thereby allowing for an intermittently cleaned extricating surface, further prohibiting excess grease and/or oil build-up upon the extricating surface, said build-up acting as thermal insulation that can impede and halt grease and oil collection and accumulation.

76. The method of claim 72 wherein said reservoir is of a cylindrical comprising at least one end generally planar and comprising said wall.

77. The method of claim 72 wherein said reservoir is of a cylindrical shape, the shape of said wall also being cylindrical conforming to said cylindrical shape, in order for said reservoir to axially rotate, thereby allowing said reservoir to be continuously subjected to said media.

78. The method of claim 77 further including a motor to power-rotate said reservoir.

79. The method of claim 78 further including a power-transmission to convey rotational-power from said motor to said reservoir.

80. The method of claim 77 further including a partially hollow axle for providing an axis around which said reservoir rotates, and to allow for ingress/egress of said coolant.

81. The method of claim 77 further including a set of hollow spindles for providing an axis around which said reservoir rotates, and to allow for ingress/egress of said frigid coolant.

82. The method of claim 77 further including a doctor-type blade for scraping accumulated said greases and/or oils from off said external grease/oil-contacting/extricating surface.

83. The method of claim 77 further including a pressure nozzle for pressuring off said greases and/or oils accumulated onto said external grease/oil-contacting/extricating surface, with pressure acquired conventionally.

84. The method of claim 77 further including a vacuum-nozzle for sucking accumulated said greases and/or oils from off said external grease/oil-contacting/extricating surface using negative pressure conventionally acquired.

85. The method of claim 77 further including refrigerating said frigid coolant by at least one conventional refrigeration component, including a conventional refrigeration evaporator positioned internally of said reservoir.

86. The method of claim 77 further including refrigerating said frigid coolant by a conventional refrigerator positioned externally of said reservoir.

87. The method of claim 77 wherein said reservoir is of a cylindrical shape, the shape of said wall also conforming to said cylindrical shape, said wall comprising a cooling-jacket surface maintaining a general cylindrical shape in order for said reservoir to axially rotate while frigid coolant passes through the wall's cooling-jacket surface, thereby, said external grease/oil-contacting/extricating surface sandwiches fluid cryogen with said internal cooling surface, said wall also comprising said cooling-jacket surface, therefore.

88. The method of claim 87 further including a motor to power-rotate said reservoir.

89. The method of claim 88 further including a power-transmission to convey rotational-power from said motor to said reservoir.

90. The method of claim 87 further including a partially hollow axle for providing an axis around which said reservoir rotates, and to allow for ingress/egress of said frigid coolant.

91. The method of claim 87 further including a set of hollow spindles for providing an axis around which said reservoir rotates, and to allow for ingress/egress of said frigid coolant.

92. The method of claim 87 further including a doctor-type blade for scraping accumulated said greases and/or oils from off said external grease/oil-contacting/extricating surface.

93. The method of claim 87 further including a fluid-pressure nozzle for pressuring off said greases and/or oils accumulated onto said external grease/oil-contacting/extricating surface, with pressure acquired conventionally.

94. The method of claim 87 further including a vacuum-nozzle for sucking accumulated said greases and/or oils from off said external grease/oil-contacting/extricating surface via negative pressure acquired conventionally.

95. The method of claim 87 further including refrigerating said frigid coolant by a conventional refrigerator positioned externally of said reservoir.
